(19) United States
(12) Patent Application Publication
(10) Pub. No.: US 2026/0186295 A1
(43) Pub. Date: Jul. 2, 2026

(54) SYSTEMS AND METHODS FOR WAVEGUIDES AND DISPLAY OPTICS

(71) Applicant: Meta Platforms Technologies, LLC, Menlo Park, CA (US)

(72) Inventors: Tyson Jacobs, Seattle, WA (US); Deming Zhang, Sammamish, WA (US); Wanli Chi, Sammamish, WA (US); Jianmin Zheng, Bothell, WA (US); Wai Sze Tiffany Lam, Lynnwood, WA (US); Nicholas John Diorio, JR., Duvall, WA (US); Sawyer Miller, Bellevue, WA (US); Junren Wang, Redmond, WA (US); Hsien-Hui Cheng, Woodinville, WA (US); Zhenye LI, Redmond, WA (US); Jilin Yang, Bellevue, WA (US); Nihar Ranjan Mohanty, Snoqualmie, WA (US); Gareth John Valentine, Kirkland, WA (US); Shermin Arab, East Pala Alto, CA (US); Lu Lu, Shanghai (CN); Andrew James Christian, Seattle, WA (US); Kieran Connor Kelly, Seattle, WA (US); Alejo Lifschits Arribio, Redmond, WA (US); Igor Abramson, Duvall, WA (US); Giuseppe Calafiore, Woodinville, WA (US); Richard Farrell, Seattle, WA (US); Mohamed Tarek Ahmed El-Haddad, Eugene, OR (US); Xiangtong Li, San Jose, CA (US); Cheonhong Kim, Mountain View, CA (US); Linghui Rao, Redmond, WA (US); Xinyu Zhu, San Jose, CA (US); Hsin-Ying Chiu, San Jose, CA (US); Rungrot Kitsomboonloha, Los Gatos, CA (US); Cagdas Varel, Bellevue, WA (US); Xinyu Zhu, San Jose, CA (US); Shenglin Ye, Palo Alto, CA (US); Yu-Jen Wang, Santa Clara, CA (US); Brian Wheelwright, Sammamish, WA (US); Siddharth Buddhiraju, San Matro, CA (US); Janne Hyyti, Redmond, WA (US); Renate Eva Klementine Landig, Kirkland, WA (US); Brian Schowengerdt, Seattle, WA (US)

(21) Appl. No.: 19/430,417

(22) Filed: Dec. 23, 2025

Related U.S. Application Data
(60) Provisional application No. 63/739,854, filed on Dec. 30, 2024.
(60) Provisional application No. 63/769,807, filed on Mar. 11, 2025.
(60) Provisional application No. 63/806,174, filed on May 15, 2025.
(60) Provisional application No. 63/840,208, filed on Jul. 8, 2025.
(60) Provisional application No. 63/840,246, filed on Jul. 8, 2025.
(60) Provisional application No. 63/844,995, filed on Jul. 16, 2025.

(51) Int. Cl. G02B 27/00; G02B 1/00; G02B 27/01

(52) U.S. Cl. CPC G02B 27/0012; G02B 1/005; G02B 27/0093; G02B 27/0172; G02B 2027/0114; G02B 2027/0178

(57) ABSTRACT

A method comprises simulating rays deterministically, monitoring the intensity of the rays as they undergo ray splitting, dynamically switching from deterministic simulation to stochastic simulation when the ray intensity declines to a specified threshold, continuing the stochastic simulation to model interference effects up to the specified threshold, and outputting a simulation result that provides an enhanced representation of light propagation within the waveguide that is based on both the deterministic simulation and the stochastic simulation. Systems and methods are disclosed.

### CROSS-REFERENCE TO RELATED APPLICATIONS

This application claims priority to U.S. Application No. 63/739,854 filed 30 Dec. 2024, U.S. Application No. 63/769,807 filed 11 Mar. 2025, U.S. Application No. 63/806,174, filed 15 May 2025, U.S. Application No. 63/840,208 filed 8 Jul. 2025, and U.S. Application No. 63/840,246 filed 8 Jul. 2025, and U.S. Application No. 63/844,995, filed 16 Jul. 2025.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a flow diagram of an exemplary method for hybrid ray tracing.

FIG. 2 illustrates a network architecture, according to some embodiments.

FIG. 3 is a block diagram illustrating details of a system, according to some embodiments.

FIG. 4 illustrates an example of headset-level off-axis color shift, according to some embodiments.

FIG. 5 shows an example of blue light scatter particles in quantum dot film, according to some embodiments.

FIG. 6 illustrates examples of potential technical benefits of using particles embedded in the quantum dot film, for different LED arrangements.

FIG. 7 illustrates experimental results for some embodiments using particles of different sizes.

FIG. 8 shows an example of blue light scattering particles in an adhesive layer.

FIG. 9 illustrates an example of using a narrower black matrix to reduce screen door visual effect, according to some embodiments.

FIG. 10 illustrates an example of using a high taper angle to achieve smaller photo spacers, according to some embodiments.

FIG. 11 illustrates an example of a photo spacer according to some embodiments.

FIG. 12 illustrates a process for making a photo spacer, according to some embodiments.

FIG. 13 is a block diagram illustrating an exemplary computer system with which aspects of the subject technology can be implemented, according to some embodiments.

FIG. 14 is a cross-sectional schematic diagram illustrating the phenomenon of forward leakage in a planar waveguide having a diffractive grating according to some embodiments.

FIG. 15 is a cross-sectional schematic diagram showing the propagation of light through a planar waveguide according to some embodiments.

FIG. 16 is a cross-sectional schematic diagram showing the propagation of light through a planar waveguide including a notch filter disposed over a world side face of the waveguide according to some embodiments.

FIG. 17 is a plot of transmission versus wavelength illustrating the operation of an exemplary notch filter according to certain embodiments.

FIG. 18 is a cross-sectional schematic diagram showing the propagation of light through a planar waveguide having a lens element with a dispersed layer of narrow-band absorptive particles disposed over a world side face of the waveguide according to some embodiments.

FIG. 19 is a plot of absorbance versus wavelength for a lens element including a dispersed layer of narrow-band absorptive particles according to certain embodiments.

FIG. 20 illustrates the output of a 2-primary cyan-amber light source according to some embodiments.

FIG. 21 is an illustration of an example artificial-reality system according to some embodiments of this disclosure.

FIG. 22 is an illustration of an example artificial-reality system with a handheld device according to some embodiments of this disclosure.

FIG. 23A is an illustration of example user interactions within an artificial-reality system according to some embodiments of this disclosure.

FIG. 23B is an illustration of example user interactions within an artificial-reality system according to some embodiments of this disclosure.

FIG. 24A is an illustration of example user interactions within an artificial-reality system according to some embodiments of this disclosure.

FIG. 24B is an illustration of example user interactions within an artificial-reality system according to some embodiments of this disclosure.

FIG. 25 is an illustration of an example wrist-wearable device of an artificial-reality system according to some embodiments of this disclosure.

FIG. 26 is an illustration of an example wearable artificial-reality system according to some embodiments of this disclosure.

FIG. 27 is an illustration of an example augmented-reality system according to some embodiments of this disclosure.

FIG. 28A is an illustration of an example virtual-reality system according to some embodiments of this disclosure.

FIG. 28B is an illustration of another perspective of the virtual-reality systems shown in FIG. 28A.

FIG. 29 is a block diagram showing system components of example artificial- and virtual-reality systems.

FIG. 30A is an illustration of an example intermediary processing device according to embodiments of this disclosure.

FIG. 30B is a perspective view of the intermediary processing device shown in FIG. 30A.

FIG. 31 is a block diagram showing example components of the intermediary processing device illustrated in FIGS. 30A and 30B.

FIG. 32A is front view of an example haptic feedback device according to embodiments of this disclosure.

FIG. 32B is a back view of the example haptic feedback device shown in FIG. 32A according to embodiments of this disclosure.

FIG. 33 is a block diagram of example components of a haptic feedback device according to embodiments of this disclosure.

FIG. 34 an illustration of an example system that incorporates an eye-tracking subsystem capable of tracking a user's eye(s).

FIG. 35 is a more detailed illustration of various aspects of the eye-tracking subsystem illustrated in FIG. 34.

FIG. 36 is an illustration of an example fluidic control system that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

Features from any of the embodiments described herein may be used in combination with one another in accordance with the general principles described herein. These and other embodiments, features, and advantages will be more fully understood upon reading the following detailed description in conjunction with the accompanying drawings and claims.

### DETAILED DESCRIPTION OF EXEMPLARY EMBODIMENTS

In the field of optical simulation, particularly for designing lenses in augmented reality (AR) devices, the process of ray tracing plays a significant role yet is computationally demanding. The challenge arises from the exponential increase in ray splitting, which significantly burdens computational resources. This complexity is evident even in large-scale operations, where thousands of machines may still fall short in adequately simulating certain designs. The primary methods for simulating light propagation in waveguides are deterministic ray tracing and Monte Carlo ray tracing. Each method, however, has limitations. Deterministic ray tracing struggles with energy conservation due to the requirement of discarding rays as their energy diminishes, leading to a lack of convergence. On the other hand, Monte Carlo ray tracing, while conserving energy and achieving convergence, fails to simulate interference within the waveguide. These limitations highlight the need for a more efficient and comprehensive approach to optical simulation in waveguides.

The existing methods' inability to balance energy conservation and interference simulation highlights the demand for a new solution. The current approaches either compromise on energy conservation or fail to account for interference, which are important factors in achieving accurate optical simulations. This gap in effective simulation techniques presents an opportunity for advancements that can enhance the design and functionality of AR devices. Embodiments of this disclosure address these shortcomings in a manner that is beneficial, not only in the realm of optical simulation but in other domains that rely on ray tracing technologies.

Aspects of this disclosure introduce a hybrid ray-tracing technique that combines the strengths of both deterministic and Monte Carlo approaches. At high ray energies, the rays are simulated deterministically, allowing for the capture of interference effects. As ray intensity declines to a specified threshold due to ray splitting, the method dynamically switches to Monte Carlo mode, ensuring energy conservation while simulating interference up to the threshold. This innovative approach has demonstrated a significant improvement in simulation efficiency, offering a 1-2 order of magnitude enhancement over traditional methods. This hybrid method not only optimizes computational resources but also provides a more accurate simulation of light propagation in waveguides, making it a useful tool for the design and development of AR devices.

The present disclosure is generally directed to a waveguide-based eye-tracking (WGET) system that employs liquid crystal polarization holograms (LCPHs) to improve tracking accuracy, reduce power consumption, and expand field-of-view (FOV) capabilities. The LCPHs may be used as an in-coupler grating of the waveguide, with unique capabilities such as switchable gratings and polarization selectivity. Conventional WGET systems may suffer from cross-talk between dual in-couplers, display artifacts, and limitations in the tracking FOV. Accordingly, the present disclosure may address these challenges by integrating switchable LCPHs, zonal illumination, and staggered frequencies to optimize eye-tracking performance.

In one example, the systems disclosed herein may include a waveguide optically coupled to an eye-tracking illumination source and a sensor. The illumination source may emit light, propagating through the waveguide and is out-coupled towards the user's eye via switchable LCPHs, acting as in-couplers. The reflected light from the eye may be guided back through the waveguide and captured by the sensor for eye-tracking processing. In some implementations, at a component level, the liquid crystal (LC) gratings may be positioned between two transparent substrates that include a transparent conductive coating (e.g., Indium Tin Oxide (ITO)) disposed onto them. The transparent conductive (TC) coating may be patterned or unpatterned to control multiple zones of LC switching. Alternate configurations of the LC switchable gratings may include vertically stacking the gratings by adding more layers of substrates and LCs. In some instances, when no electric potential is applied to the TC, the LC grating functions as originally patterned, known as the grating “on” state. However, when a voltage difference is present between the TCs on opposite sides of the LC, an electric field is generated across the LC grating, causing molecules of the LC to rotate and orient their position to align with the field's direction. This reorientation of the LC molecules may disrupt the grating structure, transitioning the LC gratings to an “off” state. In this state the LC grating may exhibit optical properties similar to the substrate, permitting light to propagate without diffraction.

In some examples, the switchable LCPHs may allow dynamic control over which in-coupler regions are active at any given time, thereby reducing optical cross-talk and enhancing the quality of the captured eye-tracking data. In some examples, the disclosed LCPHs may be configured to exhibit polarization states that correspond to different eye-tracking illumination zones. In some instances, the LCPHs may alternate between the polarization states under the control of an applied voltage, modulating the optical path and selectively directing light within predetermined eye-tracking zones. The disclosed systems may include zonal illumination strategies that may reduce overlap between adjacent in-couplers, mitigating interference effects and improving tracking accuracy. For example, to improve energy efficiency and minimize cross-talk, one embodiment may include zonal illumination systems that utilize liquid crystal (LC) technology where only half of the FOV is captured at a time. In a structural zonal illumination approach, two or more switchable LC gratings may be implemented, each designed to couple light to specified locations. Only one grating is activated at any given time, ensuring controlled light distribution, and reducing interference. Additionally, a glint-based zonal illumination system may employ two or more switchable LC diffusers to selectively illuminate different regions of interest (ROI). Each diffuser may be designed with a specific numerical aperture to optimize light distribution within its designated ROI, enhancing eye-tracking accuracy while maintaining energy efficiency.

In other examples, the system may operate in different modes to further minimize artifacts. In the first mode, the eye-tracking system remains active while the display is turned off. During this state, no voltage is applied to the in-coupler, allowing it to function as a grating. In the second mode, the display is on while the eye-tracking grating is deactivated. In this state, a voltage is applied to the in-coupler, converting the eye-tracking grating into an A-plate. Any retardance introduced in this mode can be compensated for using an additional polarization compensator. In further examples, to fit different user's eye, the active LCs may adjust an eye-tracking bias to enable an in-field eye-tracking signal for any user. Furthermore, the disclosed system may minimize power consumption while maintaining high eye-tracking accuracy. The adaptive nature of the switchable LCPHs may allow for efficient energy use by selectively engaging only the necessary eye-tracking regions, and thus extending battery life in immersive devices. Additionally, the integration of polarization-sensitive elements may enhance compatibility with users wearing their own glasses, ensuring reliable eye-tracking performance for a diverse user base. By addressing the limitations of conventional waveguide-based eye-tracking systems, the present disclosure may provide a solution for enhancing user experiences via immersive devices. The combination of the disclosed systems may result in a system that improves gaze tracking accuracy, reduces display artifacts, and optimizes power consumption in immersive devices.

The present disclosure is generally directed to integrating photonic and sensing components into display assemblies. As will be explained in greater detail below, certain implementations of the present disclosure may provide numerous features and benefits.

In some examples, eyewear devices like head-mounted displays (HMDs) have revolutionized the way people experience various kinds of digital media. For example, HMDs may allow users of artificial reality to experience realistic, immersive virtual and/or augmented environments. Artificial reality may provide users with opportunities to interact with virtual objects and/or environments in one way or another. In this context, artificial reality may constitute a form of reality that has been altered by virtual objects for presentation to a user. Such artificial reality may include and/or represent virtual reality (VR), augmented reality (AR), mixed reality, hybrid reality, or some combination and/or variation of one or more of the same.

Although artificial-reality systems are commonly implemented for gaming and other entertainment purposes, such systems are also implemented for purposes outside of recreation. For example, governments may use them for military training simulations, pilots may use them for flight simulations, doctors may use them to practice surgery, engineers may use them as visualization aids, and co-workers may use them to facilitate inter-personal interactions and collaboration from across the globe.

Some AR devices and/or smart glasses may house and/or enclose circuitry for AR functionality in an eyewear frame. For example, an eyewear frame may include and/or form cavities in which electronic components, circuit boards, and/or batteries are stored or housed to facilitate and/or support AR functionality. For a desirable aesthetic, the eyewear frame may need to maintain a small, tight, compact, and/or sleek design comparable to sunglasses and/or prescription glasses. Moreover, to achieve a comfortable fit that a user is willing to and/or wants to wear all day, the eyewear frame may need to remain and/or maintain a low weight. Unfortunately, such a design may limit the size, space, and/or real estate in which the eyewear frame is able to house and/or carry the circuitry (e.g., display and/or sensing components) as well as photonic components for the AR functionality.

One way to achieve all these objectives and/or goals for AR devices may be to implement a bright, sharp, uniform display on a transparent substrate (e.g., a lens) with diffractive gratings. In some examples, such a display may include and/or rely on a miniature light source and/or implement a low-resolution feature with dimming capabilities to accommodate tracking the user's eye movement. Traditionally, the individual sensing, display, and/or photonic components are often manufactured separately and then assembled modularly into AR devices. These traditional manufacturing and/or assembly processes may result in and/or lead to heavier and/or bulkier AR devices with relatively poor performance, reliability, and/or robustness.

To mitigate such undesirable features without compromising the desirable ones, AR-device manufacturers may manufacture and/or integrate the sensing and/or photonic components into the display waveguide via wafer-level, die-level, and/or panel-level processing. For example, AR-device manufacturers may implement a single continuous processing line in which all the photonic, electronic, and/or ophthalmic components are directly fabricated onto a high-index transparent plate, substrate, and/or waveguide at the wafer level. By doing so, such AR-device manufacturers may reduce the number of components and/or devices (e.g., adhesive layers, connection mechanisms, etc.) involved in the display and/or eye-tracking systems by eliminating certain components and/or devices rendered obsolete and/or superfluous. As a result, such AR devices may weigh less, maintain a sleeker and/or tighter design, and/or achieve improved performance, reliability, reliability, and/or robustness. In addition, because the integration of such sensing and/or photonic components into the display waveguide is performed at the wafer level via a single continuous processing line, AR-device manufacturers may be able to scale the manufacturing process much easier and/or to implement the same in-house, as opposed to outsourcing to third-party vendors and/or contractors.

In some examples, AR devices may include and/or represent an head-mounted display (HMD) equipped with various components, features, and/or circuitry that are integrated into a waveguide of the display assembly. For example, circuitry may include and/or represent one or more electrical and/or electronic circuits capable of processing, applying, modifying, transforming, displaying, transmitting, receiving, and/or executing data for the HMD. In one example, the circuitry may be electrically and/or communicatively coupled to optical element(s), light-emitting device(s), collimated light source(s), coherent light source(s), lasers, camera(s), and/or event sensor(s). In this example, the light-emitting device(s), coherent light source(s), camera(s), and/or event sensor(s) may each be integrated into and/or secured to the waveguide and/or display assembly included in and/or distributed across the eyewear frame and/or optical element(s).

In some examples, the HMD may include and/or apply a waveguide-imaging path used to image and/or map the pupil plane from the same angle as the visual display projected and/or presented for viewing by the user. In one example, the HMD may rely on the waveguide-imaging path to perform infield measurements by placing virtual cameras closer to the optimal position in the user's view. Additionally or alternatively, the HMD may implement spatial multiplexing for capturing multiple views of one of the user's eye with the same sensor.

In some examples, the HMD may use and/or rely on the display and/or waveguide for both illumination and sensing along the same optical plane and/or path. For example, the HMD may implement both display illumination and eye tracking at the same angle as one another. In one example, the HMD may include and/or represent waveguide cameras with central field-of-view (FOV) rays aimed at the center of the eye box. Additionally or alternatively, photodetectors and/or cameras may be integrated in the display of the HMD to image the user's retinas. In certain implementations, the HMD may implement and/or emit collimated light from a waveguide display via pupil replication.

In some examples, the HMD may implement and/or rely on a waveguide that carries both the visible light used to produce graphical imagery for viewing by the user and invisible light used to image and/or map the user's eye for eye-tracking purposes. In one example, the waveguide may carry visible light and invisible light that travel in different directions relative to one another. In this example, the waveguide may be optically coupled to a display device that emits the visible light for display purposes and a camera that receives the invisible light for eye-tracking purposes. In certain implementations, the display device and the camera may be positioned and/or disposed along the same optical plane and/or along conjugate optical planes relative to one another.

In some examples, the HMD may integrate a waveguide camera and a mini camera in the field. In one example, the waveguide camera may be configured to receive light from the center of the eye box for retinal imaging. In this example, the mini camera may be configured to track pupil position and/or sclera position. Additionally or alternatively, one or both of these cameras may be used by the HMD to perform gaze tracking.

In some examples, the HMD may track the state, position, orientation, and/or movement of the eye or its features based at least in part on changes in the images of the eye captured by the camera(s). For example, the HMD may compare the images of the eye captured at different moments in time to one another. In this example, the HMD may identify and/or determine changes in the state, position, and/or orientation of the eye based at least in part on differences in the light patterns illuminating the eye across the images.

In some examples, the HMD may include and/or represent circuitry that identifies changes and/or features depicted in the plurality of images. Additionally or alternatively, the circuitry may determine at least one attribute (e.g., the state, position, movement, and/or orientation) of the eye based at least in part on the changes and/or features. In certain implementations, the circuitry may use and/or rely on pupil dilation and/or contraction metrics to modulate display parameters (e.g., brightness, contrast, or content complexity) in real time.

In some examples, the circuitry may track the eye's movement based at least in part on the attribute of the eye. In one example, the circuitry may perform one or more actions in response to the attribute of the eye. Examples of such actions include, without limitation, generating virtual content presented via optical elements (e.g., lenses), modifying virtual content presented via optical elements, initiating a telephone call, sending a text message or other communication, executing a computing command and/or instruction, predicting future gaze changes, combinations of one or more of the same, and/or any other suitable actions.

In some examples, AR devices may include and/or represent an HMD that presents and/or displays virtual content and/or graphical imagery via a display assembly. In one example, the display assembly may include and/or represent a scanning display that rasterizes light emitted by the display device into graphical imagery for viewing by the user. Examples of the display assembly include, without limitation, a scanning display, a raster display, a retinal scan display, a virtual retinal display, a retinal projector, a display screen or panel, a liquid crystal display (LCD), a light-emitting diode (LED) display, an organic LED (OLED) display, a microLED display, a plasma display, a projector, a cathode ray tube, an optical mixer, combinations or variations of one or more of the same, and/or any other suitable type of display.

In some examples, the display assembly may include and/or represent one or more waveguides that carry and/or direct the light and/or illumination used to generate and/or produce the graphical imagery from the display device to the user's eye. In one example, the display assembly may include and/or represent one or more optical elements such as optical stacks, lenses, and/or films. Additionally or alternatively, the display device may include and/or represent a light source that emits and/or outputs the light and/or illumination used to generate and/or produce the graphical imagery.

In some examples, the circuitry and/or display assembly may provide, support, and/or project calibration targets (e.g., laser dots) through the waveguide's holographic gratings directly onto the retina. In one example, the circuitry and/or display assembly may correlate retinal reflection data and/or pupil position data with gaze direction to auto-calibrate the eye-tracking components and/or features of the HMD without manual user input. For example, the circuitry may execute and/or implement a multi-point calibration sequence by correlating retinal reflection data and/or pupil position data with gaze direction. In this example, such a calibration sequence may be performed as an in-factory pre-calibration using synthetic data and/or may be completed with fine-tuning once the user operates the HMD.

In some examples, the HMD may include and/or represent a scanning display that facilitates presenting videos, photos, and/or computer-generated imagery (CGI) to the user. In one example, the HMD may include and/or incorporate see-through lenses that enable the user to see the user's surroundings in addition to such CGI.

In some examples, the light source and/or display device may each include and/or represent any type or form of device capable of emitting, outputting, and/or producing light and/or electromagnetic radiation. In one example, the light source and/or display device may each emit, produce, and/or generate coherent and/or collimated light. In another example, the display device may emit, produce, and/or generate visible light for graphical imagery, and the light source may emit, produce, and/or generate for eye tracking. Additionally or alternatively, the light source and/or display device may emit, produce, and/or generate different colors (e.g., red, blue, green, etc.) and/or wavelengths of electromagnetic radiation relative to one another. Examples of such a light source and/or display device include, without limitation, light-emitting diodes, laser devices, vertical-cavity surface-emitting laser (VCSEL) devices, coherent or collimated light-emitting devices, fiber optics, waveguide-driven lasers, combinations or variations of one or more of the same, and/or any other suitable light sources.

In some examples, the light sensor may include and/or represent any type or form of device capable of sensing and/or detecting light. In one example, the light sensor may include and/or represent a camera capable of imaging and/or mapping the user's eye based at least in part on the light. Examples of such a light sensor include, without limitation, cameras, charge coupled devices (CCDs), photodiode arrays, complementary metal-oxide-semiconductor (CMOS) based sensor devices, combinations or variations of one or more of the same, and/or any other suitable type of light sensor.

In some examples, the HMD may provide diverse and/or distinctive user experiences. In one example, the HMD may provide virtual-reality experiences (i.e., they may display computer-generated or pre-recorded content). In another example, the HMD may provide real-world experiences (i.e., they may display live imagery from the physical world). Additionally or alternatively, the HMD may provide any mixture and/or combination of live and virtual content. For example, virtual content may be projected onto the physical world (e.g., via optical or video see-through lenses), thereby resulting in AR and/or mixed-reality experiences.

In some examples, the circuitry may include and/or represent one or more electrical and/or electronic circuits capable of processing, applying, modifying, transforming, displaying, transmitting, receiving, and/or executing data and/or signals for the HMD. In one example, the circuitry may launch, perform, and/or execute certain executable files, code snippets, and/or computer-readable instructions to facilitate and/or support artificial reality and/or eye tracking. In certain implementations, the circuitry may include and/or represent a collection of multiple processing units and/or electrical or electronic components that work and/or operate in conjunction with one another.

Examples of such circuitry include, without limitation, application-specific integrated circuits (ASICs), central processing units (CPUs), graphics processing units (GPUs), processing devices, microprocessors, microcontrollers, field-programmable gate arrays (FPGAs), systems on chips (SoCs), parallel accelerated processors, tensor cores, integrated circuits, chiplets, optical modules, receivers, transmitters, transceivers, optical modules, memory devices, transistors, antennas, resistors, capacitors, diodes, inductors, switches, registers, flipflops, digital logic, connections, traces, buses, semiconductor (e.g., silicon) devices and/or structures, storage devices, audio controllers, portions of one or more of the same, variations or combinations of one or more of the same, and/or any other suitable circuitry.

In some examples, the circuitry may include and/or represent one or more electrical and/or electronic circuits capable of processing, applying, modifying, transforming, displaying, transmitting, receiving, and/or executing data for the HMD. In one example, the circuitry may be electrically and/or communicatively coupled to the optical elements, collimated light source(s), coherent light source(s), lasers, camera(s), and/or optical sensor(s). In this example, the collimated light source and/or camera may each be integrated into and/or secured to the HMD and/or optical elements.

In some examples, the eye-tracking components that facilitate and/or support the eye tracking on the HMD may include and/or represent cameras, light sensors, light sources, optical modulators, phase shifters, optical switches, optical gates, light detection and ranging (LIDAR) devices, lasers, photodiodes, optical resonators, photonic crystals, light-emitting devices, combinations or variations of one or more of the same, and/or any other suitable components.

In some examples, the eye-tracking components that facilitate and/or support the eye tracking on the AR device may include and/or represent event sensors, cameras, light sensors, light sources, coherent light sources, LEDs, optical modulators, phase shifters, optical switches, optical gates, light detection and ranging (LIDAR) devices, lasers, photodiodes, optical resonators, photonic crystals, light-emitting devices, combinations or variations of one or more of the same, and/or any other suitable components.

Mixed Reality (MR) systems include a display and a lens that together form a virtual image in front of the user's eye. However, these virtual images often exhibit color shifts between the image center and the edges of the image. This phenomenon occurs because the edges of the image are formed by light entering the optical elements at larger angles of incidence to the surface. These oblique angles can introduce variations in the transmittance spectrum or polarization effects, leading to noticeable color discrepancies.

One approach to resolving the color shift involves tuning the Thin-Film Transistor (TFT) stack within the display to optimize the interference between on-axis (center) and off-axis (edge) light. The main advantage of this approach is that it only requires modifications to the coating process, making it relatively simple to implement. However, the downside is that the range of tuning correction for off-axis color shifts is limited.

Another approach tunes the compensation film within the optical path, such as the compensation layer in the polarizer film. The advantage of this method is that it leverages existing optical layers for compensation. However, this approach may affect the overall polarization design, and the availability of suitable compensation materials is limited.

In some products, the lens coating has an optical design that introduces strong (pinkish) off-axis color shifts between normal view and gaze view, which can negatively impact the overall visual experience at the headset level. This specialized coating is engineered to support the eye-tracking functionality, which relies on infrared (IR) light sources to monitor eye movement accurately, and the coating is hard to change because it is optimized for IR light. From a hardware perspective, these color shifts can potentially be mitigated if the Backlight Unit (BLU) of the display is designed to produce a color shift in the opposite direction. By intentionally introducing a reversed color shift through the BLU, the system can achieve a compensatory effect, thereby improving color consistency across the field of view. In other words, this approach attempts to pre-correct the off-axis output light with BLU angular color profile control.

Embodiments of the present disclosure address the above identified problems using doping particles in the layers that light pass through, to tune the angular color profile. The disclosed subject technology provides improvements to the technological field by providing a novel compensation method for the off-axis color shift, that reduces cost and improves the lens/display assembly form factor to better meet the requirements for MR headset design and user experience.

Some embodiments provide doping particles in the layers that light will pass through to tune the angular color profile. The particle size may be controlled by size (e.g., 2 micrometers or less) to scatter shorter wavelengths (i.e., blue light). The particles may be composed of silicon, TiO2, or other materials. Some embodiments scatter the light targeting a specific wavelength based on particle size.

In some embodiments, the blue-light-scattering particles may be doped in the quantum dot (QD) film while the QD film is fabricated. This enables the QD film to have a stronger blue light scattering feature.

In some embodiments, the blue-light-scattering particles may be doped in an adhesive layer, such as the adhesive layer in the rear polarizer in the liquid crystal display. This enables the rear polarizer to have a stronger blue light scattering feature.

In LCD displays, photo spacers are tiny structural elements created through photolithography that help maintain a consistent gap between the glass substrates, ensuring uniform liquid crystal alignment and image quality. The taper angle of a spacer, defined by the slope of its sidewalls, affects how much space it occupies; a higher taper angle allows for a more vertical profile, enabling tighter pixel layouts. Surrounding each pixel is the black matrix (BM), a light-blocking grid that prevents light leakage and enhances contrast. However, if the BM is too wide, it reduces the active area, which is the portion of the screen that actually displays content, and contributes to a “screen door” effect, which is a visual artifact where the viewer perceives a faint grid over the image. By optimizing spacer shape and minimizing BM width, manufacturers may increase the active area and reduce the screen door effect, resulting in sharper, more immersive visuals, especially in high-resolution and mixed reality displays.

High pixels-per-inch (PPI) liquid crystal display (LCD) pixel designs are desirable for mixed reality (MR) applications and devices. However, photo spacers with low taper angles require larger black matrix (BM) dimensions, which can lead to a visible “screen door” effect on MR headset displays. A high taper angle spacer is desirable to achieve a smaller black matrix (BM) dimension to cover the photo spacer and provide less screen door impact.

Some embodiments of the disclosed subject technology provide improvements to the technological field by utilizing thin-film transistor (TFT) planarization material as a contact hole filler, which fills the opening in the contact hole on the TFT layer. A high taper angle photo spacer is placed on top of this flattened surface. This configuration allows the bottom dimension of the photo spacer to be smaller than the top dimension of the contact hole. As a result, the required black matrix area to cover the photo spacer (or column spacer) can be reduced. A narrower black matrix leads to a diminished screen door effect, thereby enhancing visual quality in MR displays.

Virtual reality (VR) and augmented reality (AR) eyewear devices and headsets enable users to experience events, such as interactions with people in a computer-generated simulation of a three-dimensional world or viewing data superimposed on a real-world view. Superimposing information onto a field of view may be achieved through an optical head-mounted display (OHMD) or by using embedded wireless glasses with a transparent heads-up display (HUD) or augmented reality overlay. VR/AR eyewear devices and headsets may be used for a variety of purposes. Governments may use such devices for military training, medical professionals may use such devices to simulate surgery, and engineers may use such devices as design visualization aids.

Virtual reality and augmented reality devices and headsets typically include an optical system having a microdisplay and imaging optics. Display light may be generated and projected to the eyes of a user using a display system where the light is in-coupled into a waveguide, transported therethrough by total internal reflection (TIR), replicated to form an expanded field of view, and out-coupled when reaching the position of a viewer's eye.

Such display devices may include various diffraction grating architectures for in-coupling and out-coupling light, including volume Bragg gratings (VBG), polarization volume holographic (PVH) gratings, and surface relief gratings (SRG). Although exemplary binary gratings may provide advantages such as compactness, wavelength selectivity, and broadband operation, they may be prone, for example, to scattering losses due to surface roughness or imperfections in the grating structure. For instance, variations in the grating period, depth, or sidewall angle may introduce scattering that decreases coupling efficiency and increases optical losses.

Notwithstanding recent developments, it would be advantageous to provide improved forward leakage mitigation in grating-enabled display devices. In accordance with various embodiments, a waveguide may be configured to suppress forward leakage while maintaining efficiency, visible light transmission, and low reflectivity of world side illumination.

Forward leakage refers to the unintended transmission of light along or from a waveguide in directions other than a desired propagation path. Forward leakage may decrease the efficiency of a waveguide, as less energy is transmitted along the desired path. In particular examples, forward leakage refers to the unintended transmission of display light intended for a user to the world side of a display system.

In accordance with various embodiments, a display includes a waveguide having a waveguide body extending from an input end to an output end and configured to guide light by total internal reflection from the input end to the output end, an input coupling structure located at the input end for coupling light into the waveguide body, and an output coupling structure located at the output end for coupling light out of the waveguide body. The input coupling structure and the output coupling structure may be disposed over a first surface of the waveguide body.

In certain embodiments, the waveguide additionally includes a reflectance layer disposed over a second surface of the waveguide body opposite to the first surface. The reflectance layer is configured to reflect or absorb one or more selected bandwidths of light outcoupled from the waveguide body. In some embodiments, the reflectance layer may include a notch reflector. In some embodiments, the reflectance layer may include a dispersed layer of narrow-band absorptive particles.

In certain instantiations, a notch filter may be configured to reflect a relatively narrow band of primary channels. That is, a notch filter may be configured to transmit a relatively broad band of out-of-band wavelengths. A notch filter may be configured to reflect display wavelengths over the angle of incidence of the display field of view and accordingly direct a greater percentage of display light toward the eyes of a user while exhibiting comparatively low reflectivity for non-display light.

In particular implementations, image light propagating toward the world side of a display may be redirected toward a user's eyes. The forward leakage may be co-integrated with the display signal with the correct image parity. Such a configuration may improve both the efficiency and the optical quality of the display.

According to further embodiments, display light exiting a waveguide toward the world side of a display may be absorbed by a plurality of narrow-band particles dispersed throughout a world side lens of the display. The lens may be a VID lens, for example. Particles located within the lens body may be configured to selectively attenuate forward leakage to the exclusion of non-display light while having acceptably small impact on visible light transmission (VLT) and yellowness index.

Example narrow-band absorptive particles or dyes include various organic compounds that can be engineered to absorb specific wavelengths of light based on their molecular structure. Particular compounds include copper phthalocyanine (CuPc) dyes, nickel phthalocyanine (NiPc) dyes, perylene, and various perylene diimides, although further compounds are contemplated.

Various approaches to incorporating a reflectance layer into a waveguide-based display may be implemented independently or in combination. For example, when combined with a notch filter, an arrangement of narrow-band absorbing particles may block world side reflections from the notch filter and accordingly improve the visibility of the wearer's eyes to an external observer.

In accordance with various embodiments, a light source may be configured to project display light into the waveguide. A light source may include a red-green-blue (RGB) display source. By combining different intensities of red, green, and blue light, an RGB display can produce a wide range of colors and hues throughout the visible spectrum. In such embodiments, a notch reflector may include three independent band block regimes, i.e., one each for red light, green light, and blue light.

In addition to, or in lieu of, a red-green-blue light source, a light source may include a combination of cyan and amber sources, which may be implemented to create display light with desirable color rendering properties. With a 2-primary display, a notch reflector need be configured to block only two bands rather than three. Moreover, using a 2-color display may also improve visible light transmission due to the absence of a notch for green light.

Features from any of the embodiments described herein may be used in combination with one another in accordance with the general principles described herein. These and other embodiments, features, and advantages will be more fully understood upon reading the following detailed description in conjunction with the accompanying drawings and claims.

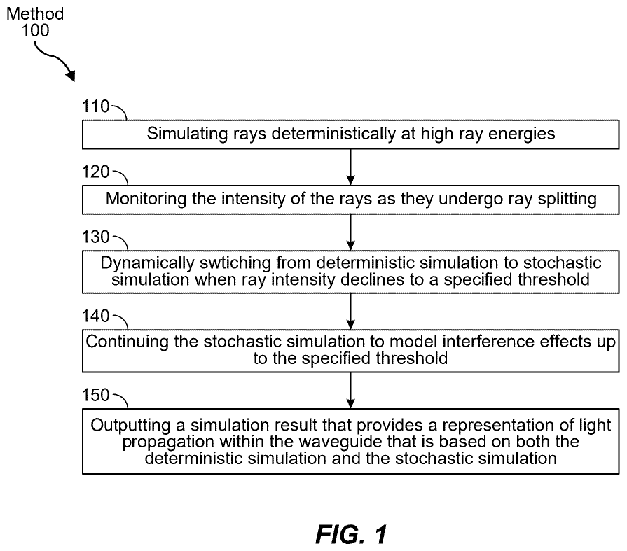

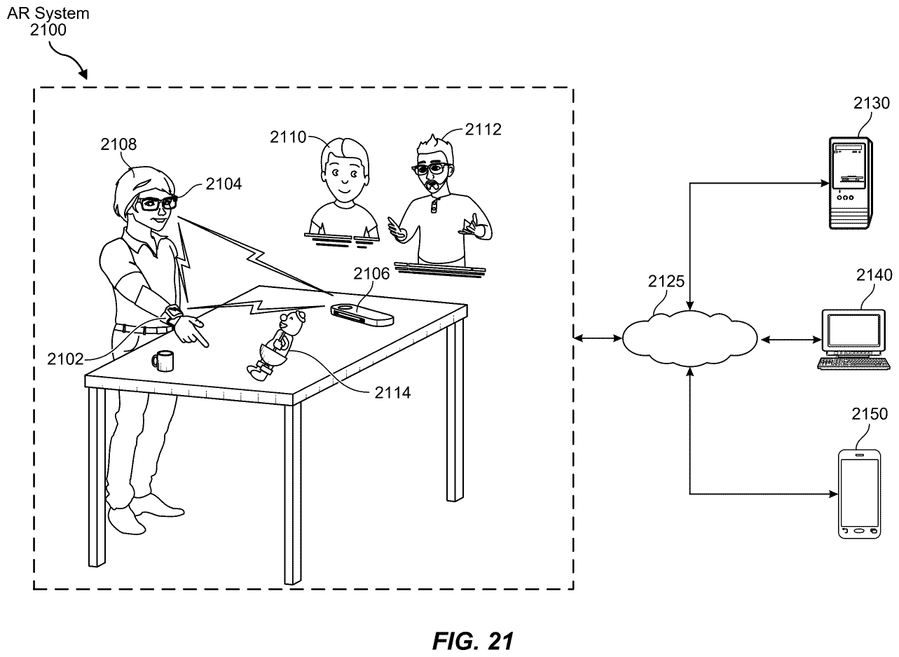

The following will provide, with reference to FIGS. 1-20, detailed descriptions of waveguide-based display systems, including their structure and operation. The discussion associated with FIGS. 21-36 relates to exemplary augmented reality and virtual reality devices that may include a waveguide-based display as disclosed herein.

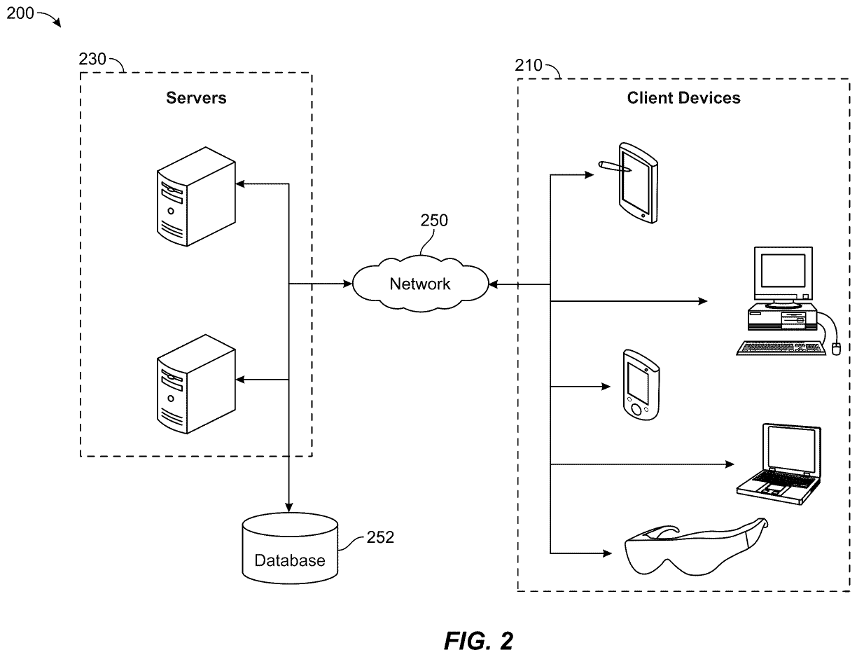

FIG. 1 is a flow diagram of an exemplary computer-implemented method 100 for hybrid ray tracing. The steps shown in FIG. 1 may be performed by any suitable computer-executable code and/or computing system, including the system(s) illustrated and described in FIGS. 2-10. As illustrated in FIG. 1 at step 110, one or more of the systems described herein may simulate rays deterministically at high ray energies to capture interference effects. In some embodiments, the term “deterministic simulation” may refer to a method of simulating light paths with fixed parameters.

Deterministic simulation or ray tracing is a rendering technique in which the path of each light ray is determined by a fixed, predictable algorithm, resulting in consistent and repeatable results for a given scene and camera setup. Unlike stochastic or path tracing methods that utilize random sampling, deterministic ray tracing follows a predefined path for each ray, ensuring that the same input consistently produces the same output. This method is often favored when precise and consistent results are required, such as in scientific simulations or applications where accuracy is paramount. An example of deterministic ray tracing is the classic Whitted-style ray tracing, which is frequently used for rendering static scenes. In contrast, stochastic ray tracing methods, such as path tracing, employ random sampling to simulate light interactions. While these methods can lead to faster rendering times, they may require more samples to achieve a similar level of accuracy as deterministic approaches.

As illustrated in FIG. 1 at step 120, one or more of the systems described herein may monitor the intensity of the rays as they undergo ray splitting. This step may involve continuously or periodically assessing the energy levels of the rays to determine the point at which their intensity falls below a specified threshold. For example, a monitoring module may utilize real-time data analytics to track changes in ray intensity, ensuring that the system can dynamically adjust the simulation approach as needed. In some embodiments, the term “ray intensity” may refer to the energy level of a light ray as it propagates through a medium.

As illustrated in FIG. 1 at step 130, one or more of the systems described herein may dynamically switch from deterministic simulation to stochastic simulation when the ray intensity declines to a specified threshold. This transition may help maintain energy conservation while continuing to model interference effects accurately. For example, a control module may detect when the ray intensity falls below the predetermined threshold and initiate the switch to a Monte Carlo simulation approach, which is better suited for handling lower energy levels.

In some embodiments, the term “specified threshold” may refer to a predefined energy level at which the simulation method transitions to ensure desired performance. Examples of thresholds include, without limitation, energy levels determined by the specific requirements of the simulation or the characteristics of the waveguide.

The systems described herein may perform step 130 in a variety of ways. In one example, the transition may be implemented through a gradual phase that smooths the switch, taking into account both ray intensity and angle of incidence to minimize disruptions in the simulation process.

As illustrated in FIG. 1 at step 140, one or more of the systems described herein may continue the stochastic simulation to model interference effects up to the specified threshold. This step ensures that the simulation accurately captures the behavior of light as it propagates through the waveguide, even at lower energy levels. For example, a simulation module may employ Monte Carlo techniques to maintain energy conservation while effectively modeling the interference patterns that occur within the waveguide.

The systems described herein may perform step 140 in a variety of ways. In one example, the stochastic simulation may incorporate variance reduction techniques to enhance the accuracy and efficiency of modeling interference effects, thereby providing a more detailed representation of light behavior within the waveguide.

As illustrated in FIG. 1 at step 150, one or more of the systems described herein may output a simulation result that provides an enhanced representation of light propagation within the waveguide. This step can involve compiling the data obtained from both deterministic and stochastic simulations to generate a comprehensive visualization of light behavior. For example, a rendering module may integrate the results to produce a detailed depiction of interference patterns and energy distribution within the waveguide. In some embodiments, the term “enhanced representation” may refer to a simulation output that offers improved accuracy and detail compared to traditional methods. Examples of enhancements include, without limitation, the ability to visualize complex interference effects and energy conservation across the waveguide.

In conclusion, the hybrid ray-tracing method for optical simulation in waveguides provides various improvements and advantages over traditional approaches, particularly for augmented reality devices. By integrating the strengths of both deterministic and stochastic simulations, this innovative approach addresses the limitations of traditional methods, such as energy conservation and interference modeling. The ability to dynamically switch between deterministic and Monte Carlo simulations based on ray intensity ensures both accuracy and computational efficiency. This method not only enhances the precision of light propagation simulations but also optimizes resource utilization, offering a one to two order of magnitude improvement over existing techniques. As a result, this hybrid approach holds great potential for improving the design and functionality of AR devices and could be extended to other domains reliant on ray-tracing technologies. The development of this method underscores the importance of continued innovation in simulation techniques to meet the growing demands of complex optical systems.

FIG. 2 illustrates a network architecture 200, according to some embodiments. The network architecture 200 may include one or more of client devices 210 and/or servers 430, communicatively coupled via a network 250 with each other and to at least one database, e.g., database 252. Database 252 may store data and files associated with the servers 430 and/or the client devices 210. In some embodiments, client devices 210 collect data, video, images, and the like, for upload to the servers 430 to store in the database 252.

The network 250 may include a wired network (e.g., fiber optics, copper wire, telephone lines, and the like) and/or a wireless network (e.g., a satellite network, a cellular network, a radiofrequency (RF) network, Wi-Fi, Bluetooth, and the like). The network 250 may further include one or more of a local area network (LAN), a wide area network (WAN), the Internet, and the like. Further, the network 250 may include, but is not limited to, any one or more of the following network topologies, including a bus network, a star network, a ring network, a mesh network, and the like.

Client devices 210 may include, but are not limited to, laptop computers, desktop computers, and mobile devices such as smart phones, tablets, televisions, wearable devices, head-mounted devices, display devices, and the like.

In some embodiments, the servers 430 may be a cloud server or a group of cloud servers. In other embodiments, some or all of the servers 430 may not be cloud-based servers (i.e., may be implemented outside of a cloud computing environment, including but not limited to an on-premises environment), or may be partially cloud-based. Some or all of the servers 430 may be part of a cloud computing server, including but not limited to rack-mounted computing devices and panels. Such panels may include but are not limited to processing boards, switchboards, routers, and other network devices. In some embodiments, the servers 430 may include the client devices 210 as well, such that they are peers.

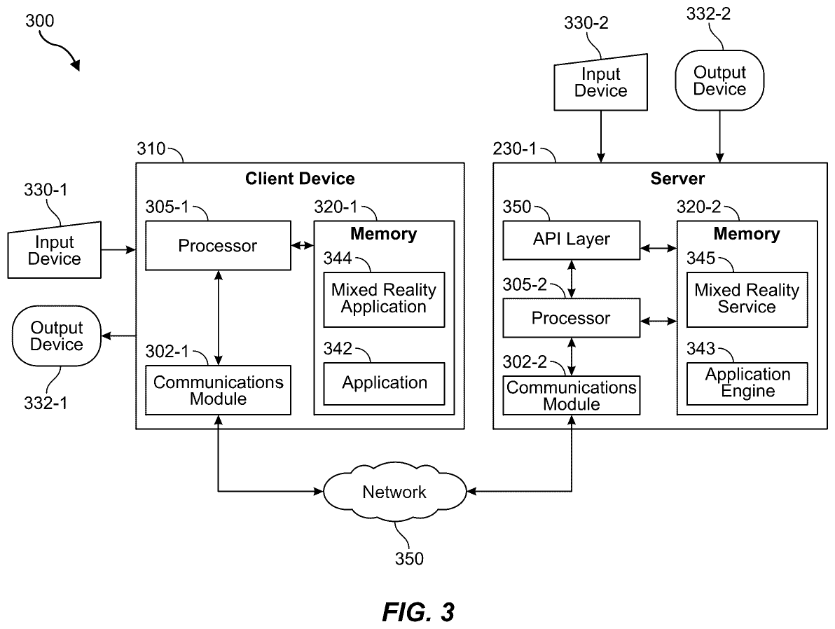

FIG. 3 is a block diagram illustrating details of a system 300, according to some embodiments. Specifically, the example of FIG. 3 illustrates an exemplary client device 210 (of the client devices 210) and an exemplary server 230-1 (of the servers 230) in the network architecture 200 of FIG. 2.

Client device 210 and server 230 are communicatively coupled over network 250 via respective communications modules 302-1 and 302-2 (hereinafter, collectively referred to as “communications modules 302”). Communications modules 302 are configured to interface with network 250 to send and receive information, such as requests, data, messages, commands, and the like, to other devices on the network 250. Communications modules 302 can be, for example, modems or Ethernet cards, and/or may include radio hardware and software for wireless communications (e.g., via electromagnetic radiation, such as radiofrequency (RF), near field communications (NFC), Wi-Fi, and Bluetooth radio technology).

The client device 210 and server 230 also include processors 305-1 and 305-2 and memories 320-1 and 320-2, respectively. Processors 305-1 and 305-2 and memories 320-1 and 320-2 will be collectively referred to, hereinafter, as “processors 305” and “memories 320.” Processors 305 may be configured to execute instructions stored in memories 320, to cause client device 210 and/or server 230 to perform methods and operations consistent with embodiments of the present disclosure.

The client device 210 and server 230 are each coupled to at least one input device 330-1 and input device 330-2, respectively (hereinafter, collectively referred to as “input devices 330”). The input devices 330 can include a mouse, a controller, a keyboard, a pointer, a stylus, a touchscreen, a microphone, voice recognition software, a joystick, a virtual joystick, a touch-screen display, and the like. In some embodiments, the input devices 430 may include cameras, microphones, sensors, and the like. In some embodiments, the sensors may include touch sensors, acoustic sensors, inertial motion units and the like.

The client device 210 and the server 230 are also coupled to at least one output device 332-1 and output device 332-2, respectively (hereinafter, collectively referred to as “output devices 332”). The output devices 332 may include a screen, a display (e.g., a same touchscreen display used as an input device), a speaker, an alarm, and the like. A user may interact with client device 210 and/or server 230 via the input devices 330 and the output devices 332.

Memory 320-1 may further include an application 342, configured to execute on client device 210 and couple with input device 330-1 and output device 332-1. The application 342 may be downloaded by the user from server 230, and/or may be hosted by server 230. The application 342 may include specific instructions which, when executed by processor 305-1, cause operations to be performed consistent with embodiments of the present disclosure. In some embodiments, the application 342 runs on an operating system (OS) installed in client device 210. In some embodiments, application 342 may run within a web browser. In some embodiments, the processor 305-1 is configured to control a graphical user interface (GUI) (e.g., spanning at least a portion of input devices 330 and output devices 332) for the user of client device 210 to access the server 230.

In some embodiments, memory 320-2 includes an application engine 343. The application engine 343 may be configured to perform methods and operations consistent with embodiments of the present disclosure. The application engine 343 may share or provide features and resources with the client device 210, including data, libraries, and/or applications retrieved with application engine 343 (e.g., application 342). The user may access the application engine 343 through the application 342. The application 342 may be installed in client device 210 by the application engine 343 and/or may execute scripts, routines, programs, applications, and the like provided by the application engine 343.

Memory 320-1 may further include a mixed reality application 344, configured to execute in client device 210. The mixed reality application 344 may communicate with a mixed reality service 345 in memory 320-2 to provide a mixed reality environment or experience to a user of client device 310. The mixed reality application 344 may communicate with mixed reality service 345 through API layer 350, for example.

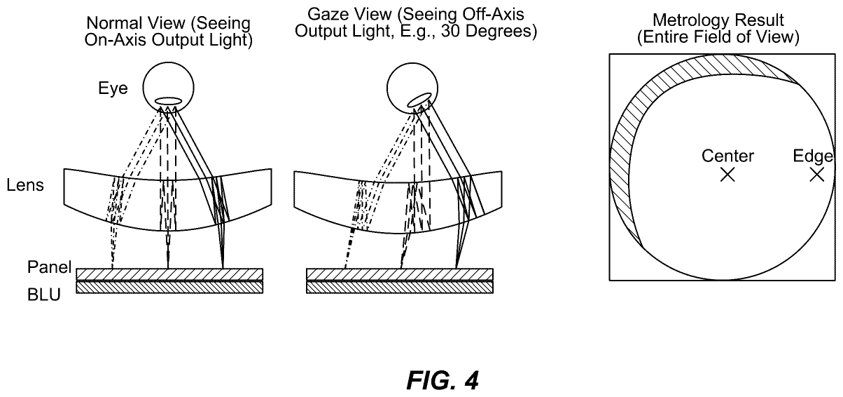

FIG. 4 illustrates an example of headset-level off-axis color shift, according to some embodiments. A strong color shift (pinkish) is observed between the normal view (center, on-axis) and gaze (edge, off-axis) view. In the example shown, the gaze view is 30 degrees. In this example, the cause of the color shift is a thin film coated on the lens, which is optimized for IR light for eye tracking functionality. Since the film is optimized for IR light, it is difficult to modify.

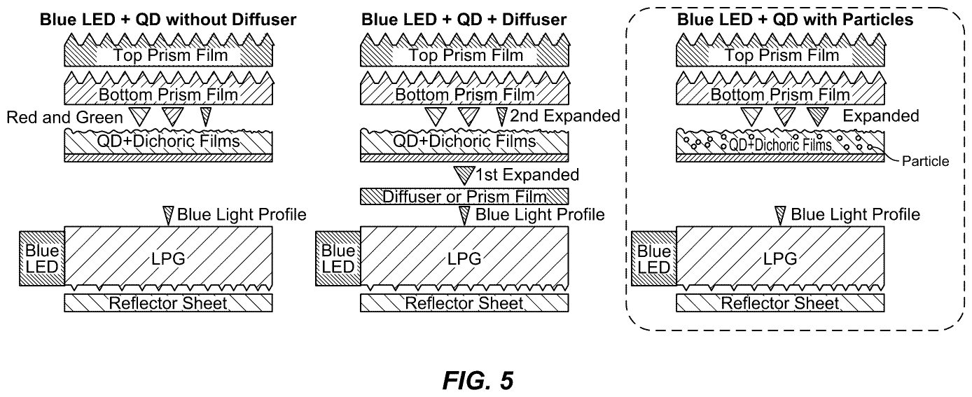

FIG. 5 shows an example of blue light scatter particles in quantum dot film, according to some embodiments. In this example, the blue LED is arranged in an edge-lit configuration to the light guide plate (LGP). For a blue light LED and QD film without a diffuser (left diagram), the blue light from the LGP has a certain angular profile, which is different from the profile of red and green light excited by the QD film. For a blue light LED and QD film with a diffuser or prism (middle diagram), the blue light intensity profile from the LGP is pre-adjusted, so the output light after QD is more uniform. For a blue light LED plus a QD film with particles embedded in the QD (right diagram), the profile of blue light is expanded in the QD film. No extra diffuser or prism is needed, leading to a cost and form factor reduction.

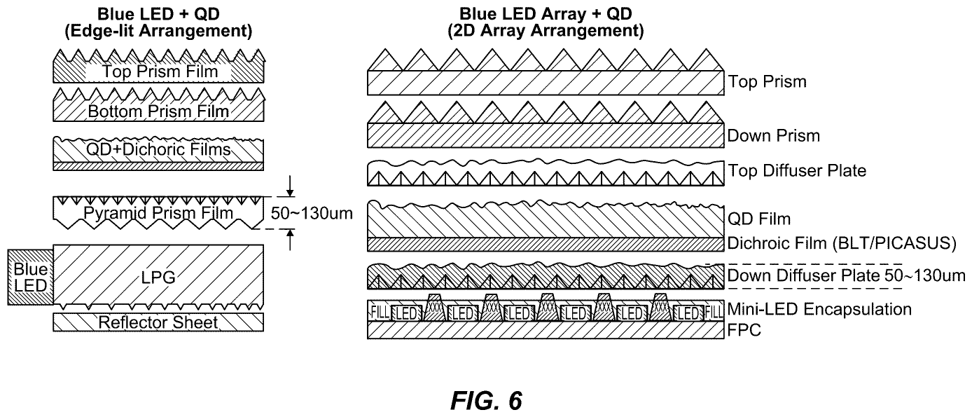

FIG. 6 illustrates examples of potential technical benefits of using particles embedded in the QD film, for different LED arrangements. The left diagram shows a blue LED and QD film in an edge-lit arrangement, with a pyramid prism film of 50-130 micrometer thickness that could be removed if the QD film has embedded particles. The right diagram shows a blue LED array and QD film in a 2D array arrangement, with a down diffuser plate of 50-130 micrometer thickness that could be removed if the QD film has embedded particles. As illustrated by these examples, the total thickness of the BLU could be reduced by 50-130 micrometers in some embodiments, for not needing a diffuser or prism film, resulting in a total BLU thickness decrease of 3% to 10%. The cost of the diffuser film or prism film could also be saved accordingly.

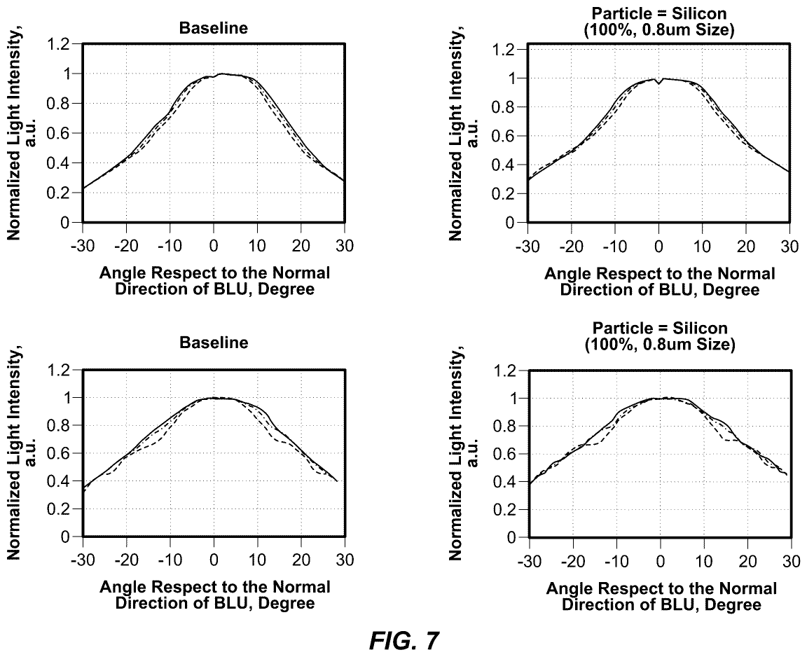

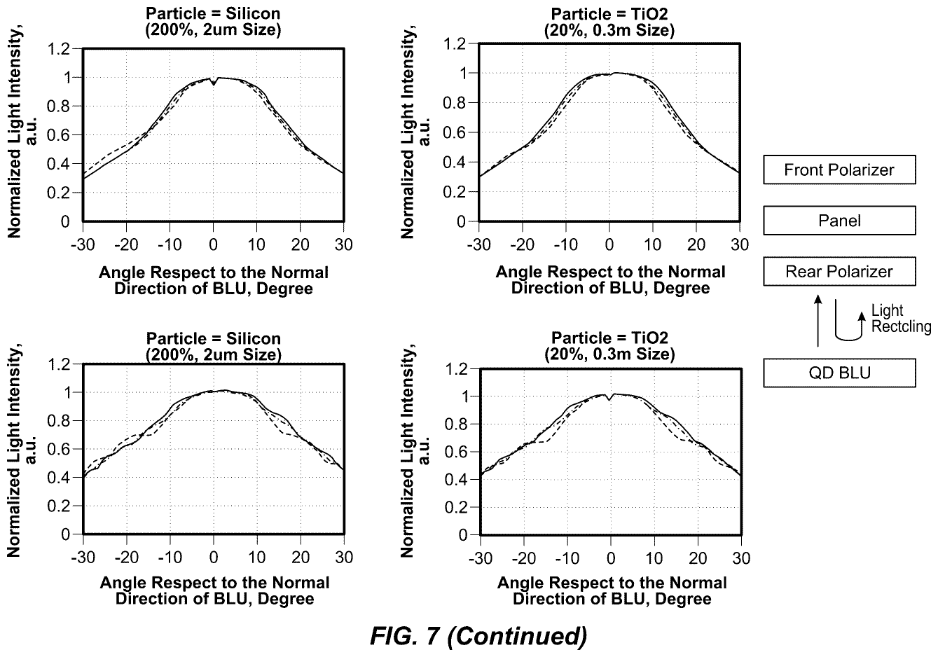

FIG. 7 illustrates experimental results for some embodiments using particles of different sizes. In this example, the particles are silicon, TiO2, or other materials, and the particle size is varied for two different arrangements (QD BLU and QD BLU plus a rear polarizer). The results indicate that when using silicon particles with 0.8 μm in size, the red, green, and blue light angular profile is more overlapped compared to the baseline with particle doping. When the concentration and size of the particle are properly selected, the blue light profile may be even larger, when the angle is greater than 20 degrees (and less than minus 20 degrees), than green and red light for off-axis color compensation.

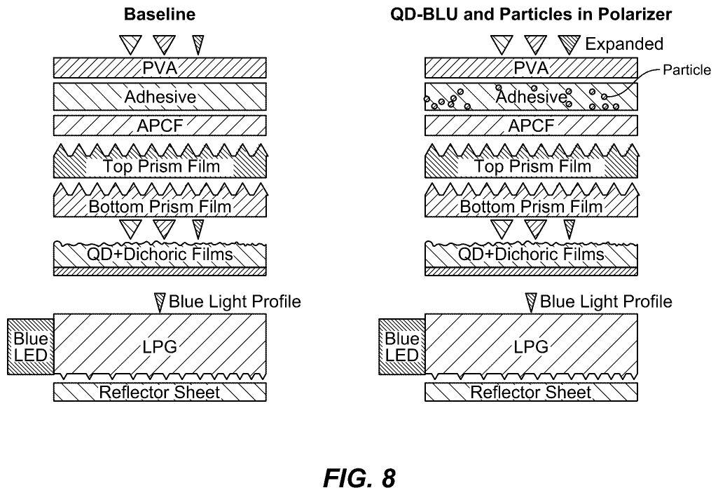

FIG. 8 shows an example of blue light scattering particles in an adhesive layer. In this example, particles are doped in the adhesive layer in a rear polarizer in the LCD.

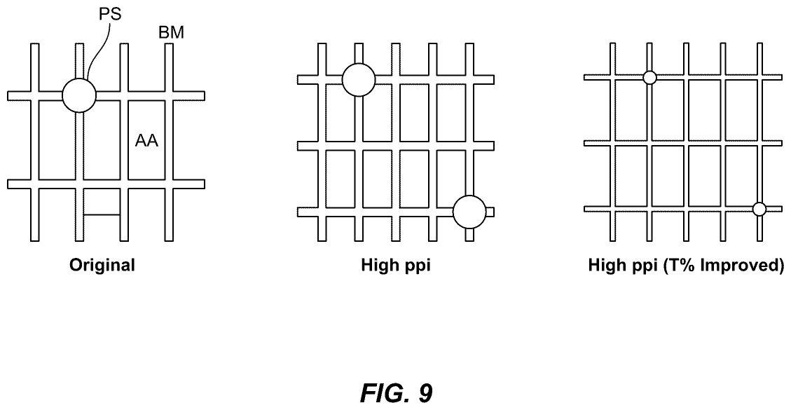

FIG. 9 illustrates an example of using a narrower black matrix (BM) width to reduce screen door visual effect, according to some embodiments. The thinner BM allows for improvement in active area (AA).

FIG. 10 illustrates an example of using a high taper angle to achieve smaller photo spacers, according to some embodiments. With a smaller photo spacer (PS), less BM cover width is needed. In some embodiments, the choice of material is important to achieve a high taper angle PS.

In some embodiments, positive photoresist may be used for TFT backplane planarization, but with lower taper angle. In some embodiments, negative photoresist may be used to provide a higher taper angle, but with this material, it is more difficult to open a micron level contact hole.

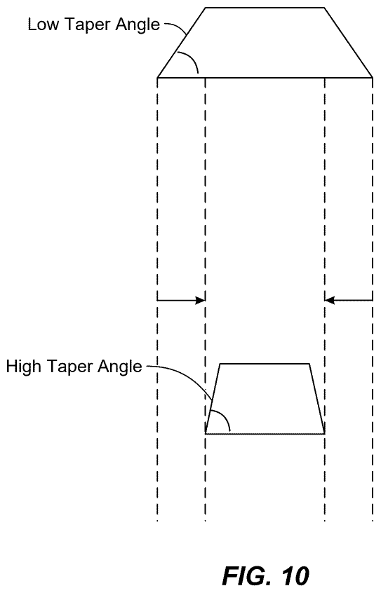

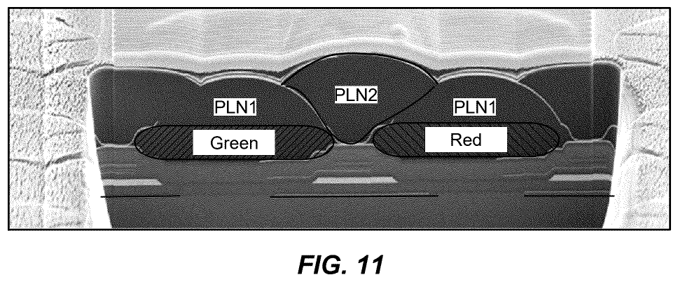

FIG. 11 illustrates an example of a photo spacer according to some embodiments. In this example, PLN1 is the material used for TFT planarization, and PLN2 is the material that fills the electric contact hole and provides display cell gap support. A thin ITO conductive layer is deposited in between PLN1 & PLN2. The photo spacer is formed by the portion of PLN2 that rises above the PLN1 top surface. The taper angle in this example is about ˜15°

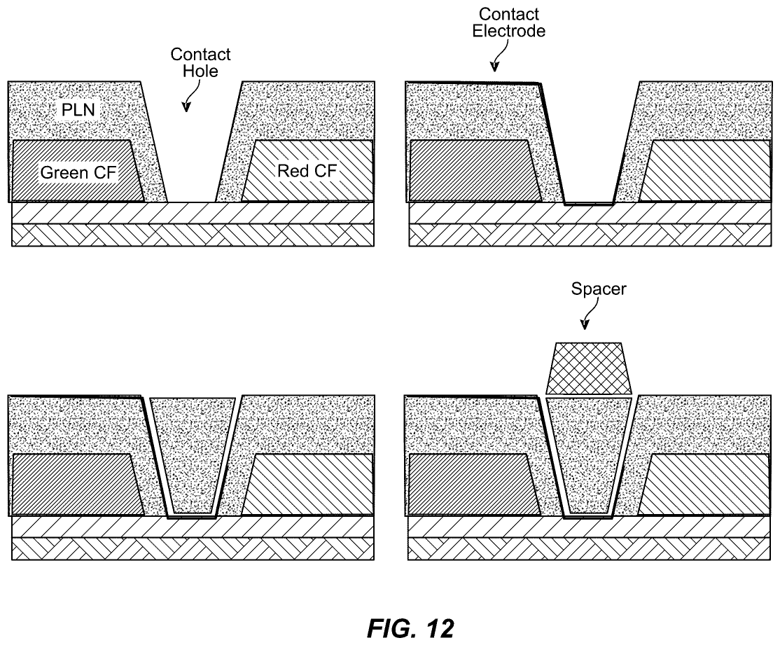

FIG. 12 illustrates a process for making a photo spacer, according to some embodiments. In this example, contact hole filler (CHF) is used to fill the contact hole opening. This process enables a high taper angle spacer on top of the flat surface above the contact hole after it is filled. In this example, the photo spacer bottom dimension may be smaller than the contact hole top dimension. Accordingly, a smaller BM dimension is needed to cover the photo spacer or column spacer area, and the narrower BM provides less screen door impact.

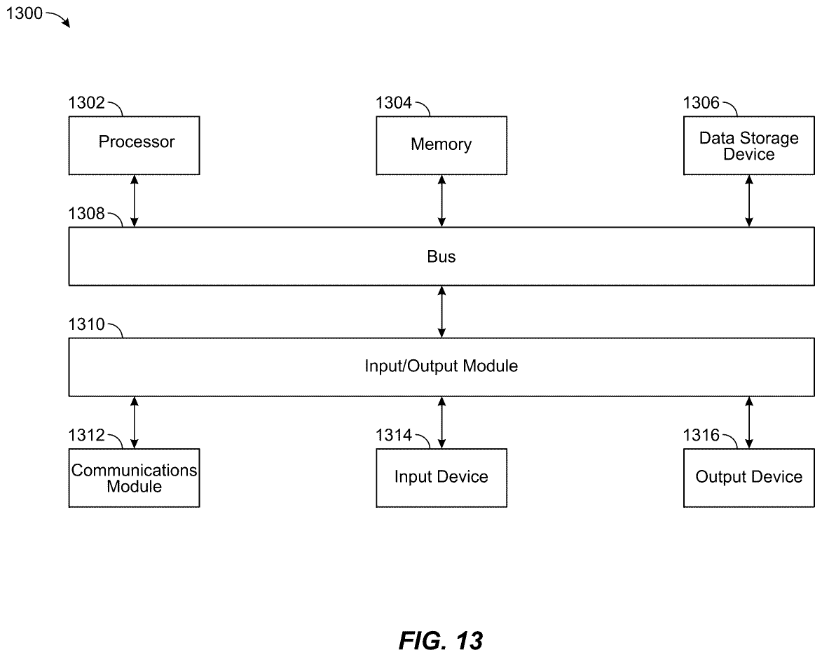

FIG. 13 is a block diagram illustrating an exemplary computer system 1300 with which aspects of the subject technology can be implemented. In certain aspects, the computer system 1300 may be implemented using hardware or a combination of software and hardware, either in a dedicated server, integrated into another entity, or distributed across multiple entities. As a non-limiting example, the computer system 1300 may be one or more of the servers 230 and/or the client devices 210.

Computer system 1300 includes a bus 1308 or other communication mechanism for communicating information, and a processor 1302 coupled with bus 1308 for processing information. By way of example, the computer system 1300 may be implemented with one or more processors 1302. Processor 1302 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 1300 can include, in addition to hardware, code that creates an execution environment for the computer program in question, e.g., code that constitutes processor firmware, a protocol stack, a database management system, an operating system, or a combination of one or more of them stored in an included memory 1304, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 1308 for storing information and instructions to be executed by processor 1302. The processor 1302 and the memory 1304 can be supplemented by, or incorporated in, special purpose logic circuitry.

The instructions may be stored in the memory 1304 and implemented in one or more computer program products, i.e., one or more modules of computer program instructions encoded on a computer-readable medium for execution by, or to control the operation of, the computer system 1300, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, Wirth languages, and xml-based languages. Memory 1304 may also be used for storing temporary variable or other intermediate information during execution of instructions to be executed by processor 1302.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 1300 further includes a data storage device 1306 such as a magnetic disk or optical disk, coupled to bus 1308 for storing information and instructions. Computer system 1300 may be coupled via input/output module 1310 to various devices. The input/output module 1310 can be any input/output module. Exemplary input/output modules 1310 include data ports such as USB ports. The input/output module 1310 is configured to connect to a communications module 1312. Exemplary communications modules 1312 include networking interface cards, such as Ethernet cards and modems. In certain aspects, the input/output module 1310 is configured to connect to a plurality of devices, such as an input device 1314 and/or an output device 1316. Exemplary input devices 1314 include a keyboard and a pointing device, e.g., a mouse or a trackball, by which a user can provide input to the computer system 1300. Other kinds of input devices 1314 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 1316 include display devices such as an LCD (liquid crystal display) monitor, for displaying information to the user.

According to one aspect of the present disclosure, the above-described embodiments may be implemented using a computer system 1300 in response to processor 1302 executing one or more sequences of one or more instructions contained in memory 1304. Such instructions may be read into memory 1304 from another machine-readable medium, such as data storage device 1306. Execution of the sequences of instructions contained in the main memory 1304 causes processor 1302 to perform the process steps described herein. One or more processors in a multi-processing arrangement may also be employed to execute the sequences of instructions contained in memory 1304. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 1300 can include clients and servers. A client and server are generally remote from each other and typically interact through a communication network. The relationship of client and server arises by virtue of computer programs running on the respective computers and having a client-server relationship to each other. Computer system 1300 can be, for example, and without limitation, a desktop computer, laptop computer, or tablet computer. Computer system 1300 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 1302 for execution. Such a medium may take many forms, including, but not limited to, non-volatile media, volatile media, and transmission media. Non-volatile media include, for example, optical or magnetic disks, such as data storage device 1306. Volatile media include dynamic memory, such as memory 1304. Transmission media include coaxial cables, copper wire, and fiber optics, including the wires that comprise bus 1308. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 1300 reads application data and provides an application, information may be read from the application data and stored in a memory device, such as the memory 1304. Additionally, data from the memory 1304 servers accessed via a network, the bus 1308, or the data storage 1306 may be read and loaded into the memory 1304. Although data is described as being found in the memory 1304, it will be understood that data does not have to be stored in the memory 1304 and may be stored in other memory accessible to the processor 1302 or distributed among several media, such as the data storage 1306.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more embodiments, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In some embodiments, the computer-readable media is non-transitory computer-readable media, or non-transitory computer-readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

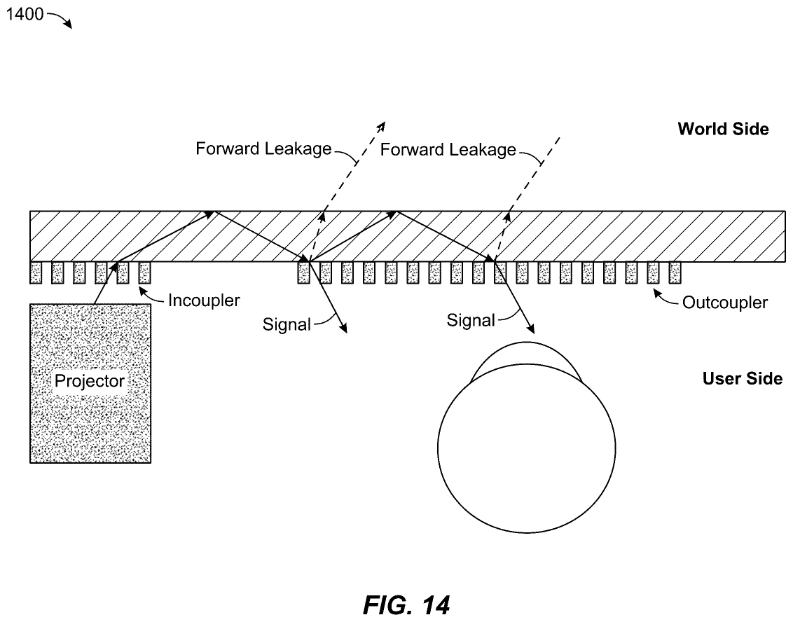

Referring to FIG. 14, shown is a cross-sectional view of an example waveguide and the propagation therethrough of display light provided by a projector. As illustrated, a one-sided diffractive grating structure (e.g., a 2D binary surface relief grating) is formed over a user-side surface of a waveguide body and light outcoupled from the waveguide body is directed both toward the eye of the user and toward the world side of the display 1400. Absent any correction, the intensity of the forward leakage light may be comparable to or even exceed the intensity of the signal light. As will be appreciated, the methods disclosed herein may be extended to 2-sided diffractive gratings, non-binary gratings, slanted gratings, and combinations of 1D and 2D gratings, including chirped gratings and metasurface gratings.

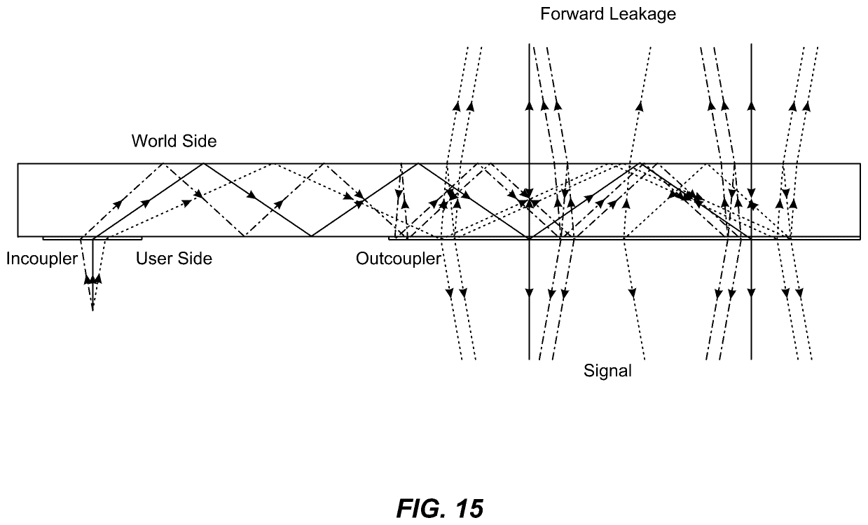

A more detailed view showing the propagation of display light through a planar waveguide is shown in FIG. 15, including the outcoupling of both signal light (light directed to a user) and unintended forward leakage (light directed to a world side of the waveguide).

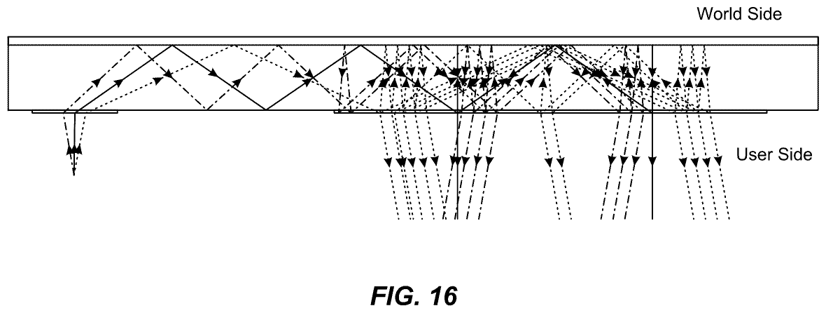

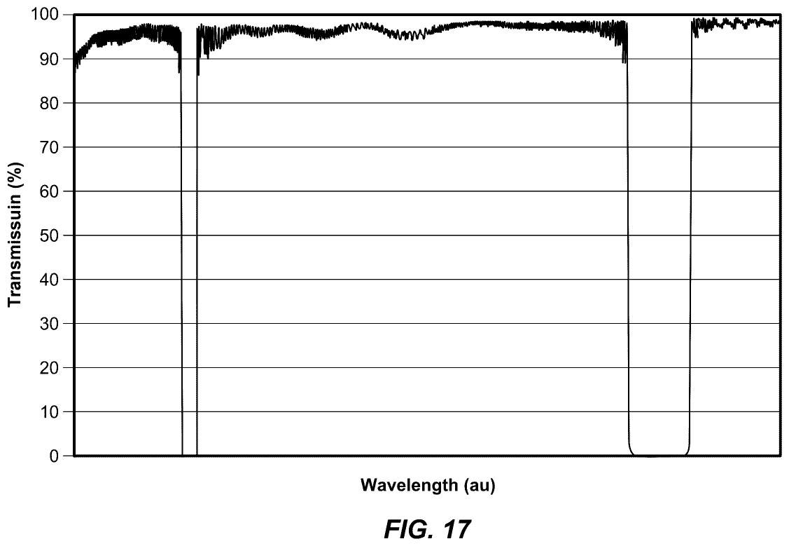

Referring to FIG. 16, a notch reflector may be formed over a world side of a waveguide body and configured to reflect display light initially outcoupled toward the world side and redirect the display light toward the user side of the display. Such redirected display light may increase waveguide efficiency and decrease pupil replication artifacts. The performance characteristics of an example dual notch reflector are shown in the plot of FIG. 17.

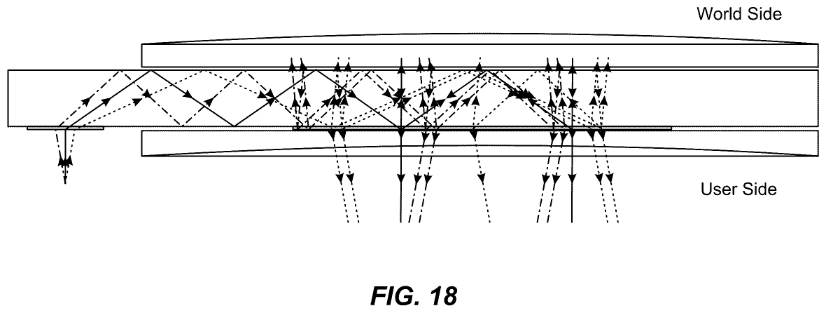

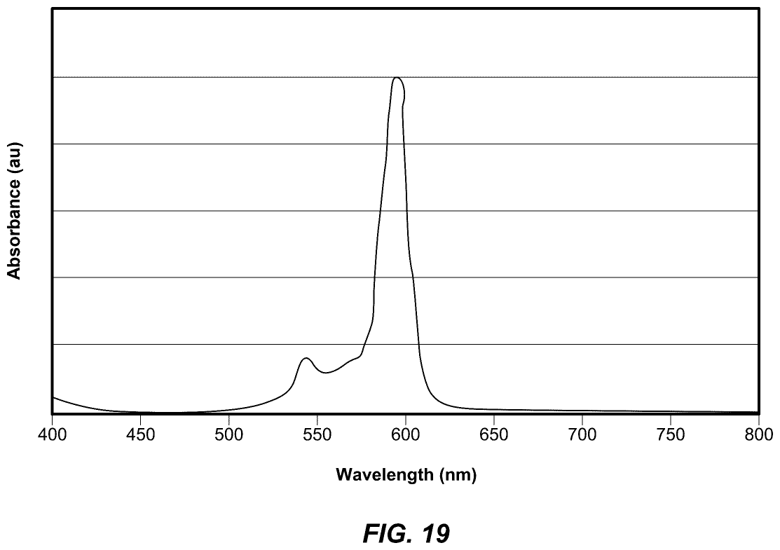

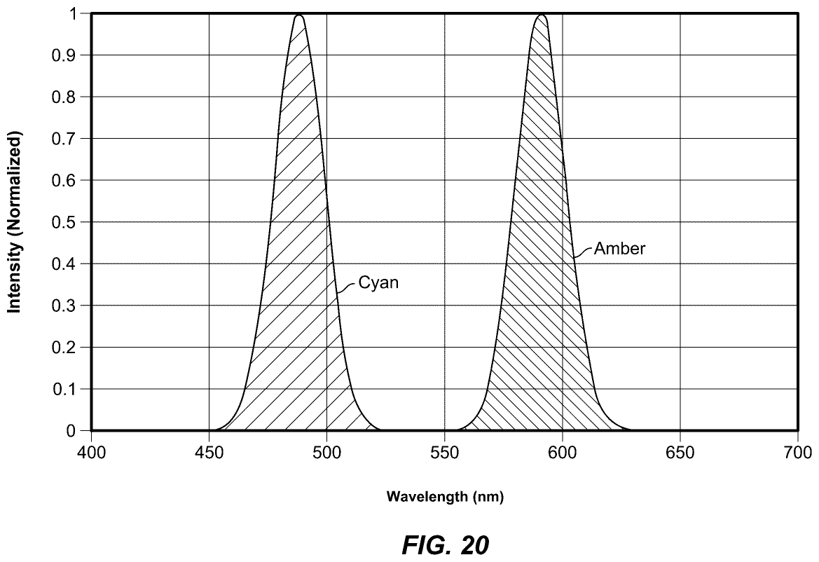

Turning to FIG. 18, a further example display system includes a planar waveguide with a VID lens disposed over a world side of the waveguide body. The VID lens may be infiltrated with particles of a narrow-band absorptive compound. As shown schematically, the narrow-band absorptive particles are configured to absorb display light initially outcoupled toward the world side of the display. A plot of absorbance versus wavelength for example narrow-band absorptive particles is shown in FIG. 19. The spectral output of an example 2-primary cyan-amber light source is shown in FIG. 20.

### EXAMPLE EMBODIMENTS

Example 1: A computer-implemented method for simulating light propagation in waveguides, comprising (i) simulating rays deterministically, (ii) monitoring an intensity of the rays as they undergo ray splitting, (iii) dynamically switching from deterministic simulation to stochastic simulation when the ray intensity declines to a specified threshold, (iv) continuing the stochastic simulation to model interference effects up to the specified threshold, and (v) outputting a simulation result that provides an enhanced representation of light propagation within the waveguide that is based on both the deterministic simulation and the stochastic simulation.

Example 2: The computer-implemented method of Example 1, where the deterministic simulation employs adaptive algorithms that adjust based on initial ray energy levels.

Example 3: The computer-implemented method of any of Examples 1-2, further comprising a use of real-time data analytics to monitor ray intensity and predict switching points between deterministic and stochastic simulations.

Example 4: The computer-implemented method of any of Examples 1-3, where a transition from deterministic simulation to stochastic simulation includes a gradual phase to smooth out the switch, based on a hybrid threshold comprising both ray intensity and angle of incidence.

Example 5: The computer-implemented method of any of Examples 1-4, where the stochastic simulation comprises a variance reduction technique.

Example 6: An eyewear device comprising a display assembly that is configured to generate graphical imagery for viewing by a user, and includes a waveguide fabricated into a wafer, an eye-tracking device at least partially fabricated into the waveguide of the display assembly, and circuitry communicatively coupled to the eye-tracking device and configured to track an eye of the user based at least in part on light detected by the eye-tracking device.

Example 7: The eyewear device of Example 6, further comprising at least one optical element configured to selectively direct light within the waveguide, the optical element being adjustable between at least a first state and a second state.

Example 8: The eyewear device of any of Examples 6-7, where the display assembly further comprises a quantum dot film, wherein the quantum dot film comprises a plurality of embedded particles configured to scatter light in a range of wavelengths.

Example 9: The eyewear device of any of Examples 6-8, wherein the embedded particles are comprised of one or more of silicon or TiO2.

Example 10: The eyewear device of any of Examples 6-9, where the embedded particles range in size from 0.3 to 2.0 micrometers.

Example 11: The eyewear device of any of Examples 6-10, where the embedded particles range in size from 0.3 to 0.8 micrometers.

Example 12: The eyewear device of any of Examples 6-11, where the display assembly further comprises a light source, an input coupling structure, an output coupling structure, and a reflectance layer.

Example 13: The eyewear device of any of Examples 6-12, where the input coupling structure comprises a 2D binary surface relief grating.

Example 14: The eyewear device of any of Examples 6-13, where the output coupling structure comprises a 2D binary surface relief grating.

Example 15: The eyewear device of any of Examples 6-14, where the reflectance layer is disposed over a second surface of the waveguide opposite to a first surface of the waveguide.

Example 16: The eyewear device of any of Examples 6-15, where the reflectance layer comprises a notch reflector.

Example 17: The eyewear device of any of Examples 6-16, where the reflectance layer comprises a plurality of narrow-band absorptive particles.

Example 18: A method for manufacturing a high-PPI LCD display, comprising (i) opening a contact hole in a planarization layer, (ii) providing a contact electrode within the contact hole, (iii) filling the contact hole with a contact hole filler material, and (iv) providing a photo spacer above the contact hole, upon a flat surface formed by the contact hole filler material.

Example 19: The method for manufacturing a high-PPI LCD display of Example 18, where the photo spacer is comprised of a negative photoresist material.

Example 20: The method for manufacturing a high-PPI LCD display of any of Examples 18-19, where the planarization material is comprised of a positive photoresist material.

Embodiments of the present disclosure may include or be implemented in conjunction with various types of Artificial-Reality (AR) systems. AR may be any superimposed functionality and/or sensory-detectable content presented by an artificial-reality system within a user's physical surroundings. In other words, AR is a form of reality that has been adjusted in some manner before presentation to a user. AR can include and/or represent virtual reality (VR), augmented reality, mixed AR (MAR), or some combination and/or variation of these types of realities. Similarly, AR environments may include VR environments (including non-immersive, semi-immersive, and fully immersive VR environments), augmented-reality environments (including marker-based augmented-reality environments, markerless augmented-reality environments, location-based augmented-reality environments, and projection-based augmented-reality environments), hybrid-reality environments, and/or any other type or form of mixed- or alternative-reality environments.

AR content may include completely computer-generated content or computer-generated content combined with captured (e.g., real-world) content. Such AR content may include video, audio, haptic feedback, or some combination thereof, any of which may be presented in a single channel or in multiple channels (such as stereo video that produces a three-dimensional (3D) effect to the viewer). Additionally, in some embodiments, AR may also be associated with applications, products, accessories, services, or some combination thereof, that are used to, for example, create content in an artificial reality and/or are otherwise used in (e.g., to perform activities in) an artificial reality.

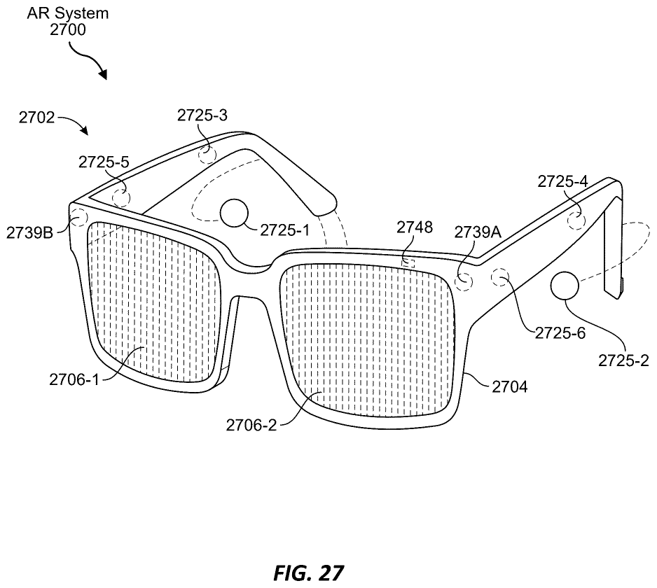

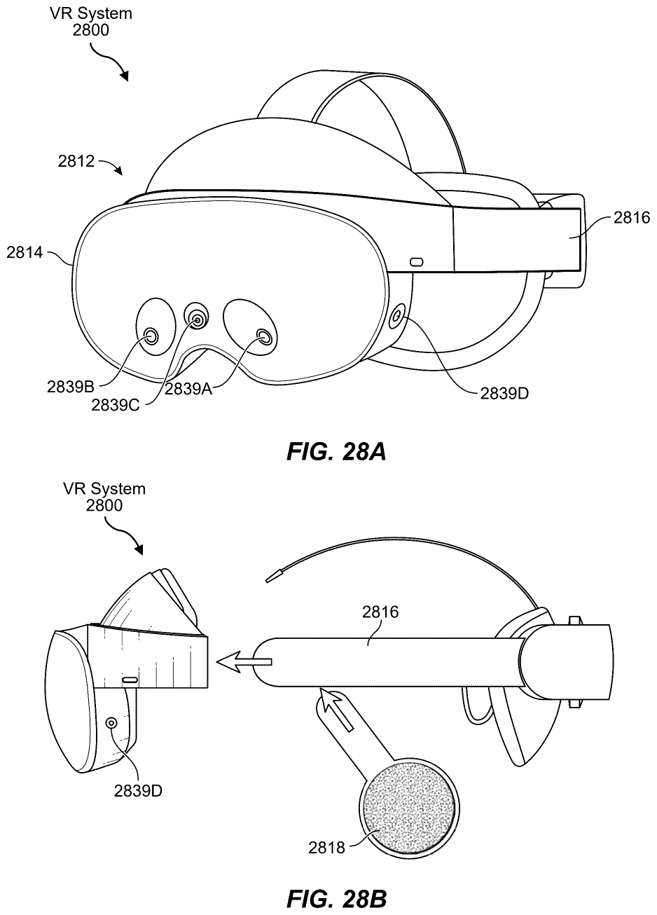

AR systems may be implemented in a variety of different form factors and configurations. Some AR systems may be designed to work without near-eye displays (NEDs). Other AR systems may include a NED that also provides visibility into the real world (such as, e.g., augmented-reality system 2700 in FIG. 27) or that visually immerses a user in an artificial reality (such as, e.g., virtual-reality system 2800 in FIGS. 28A and 28B). While some AR devices may be self-contained systems, other AR devices may communicate and/or coordinate with external devices to provide an AR experience to a user. Examples of such external devices include handheld controllers, mobile devices, desktop computers, devices worn by a user, devices worn by one or more other users, and/or any other suitable external system.

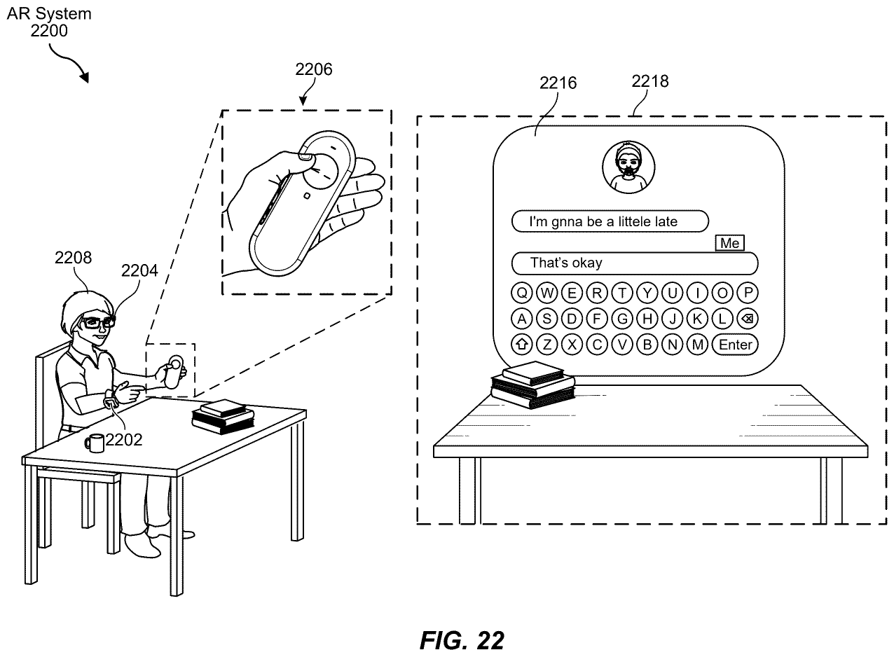

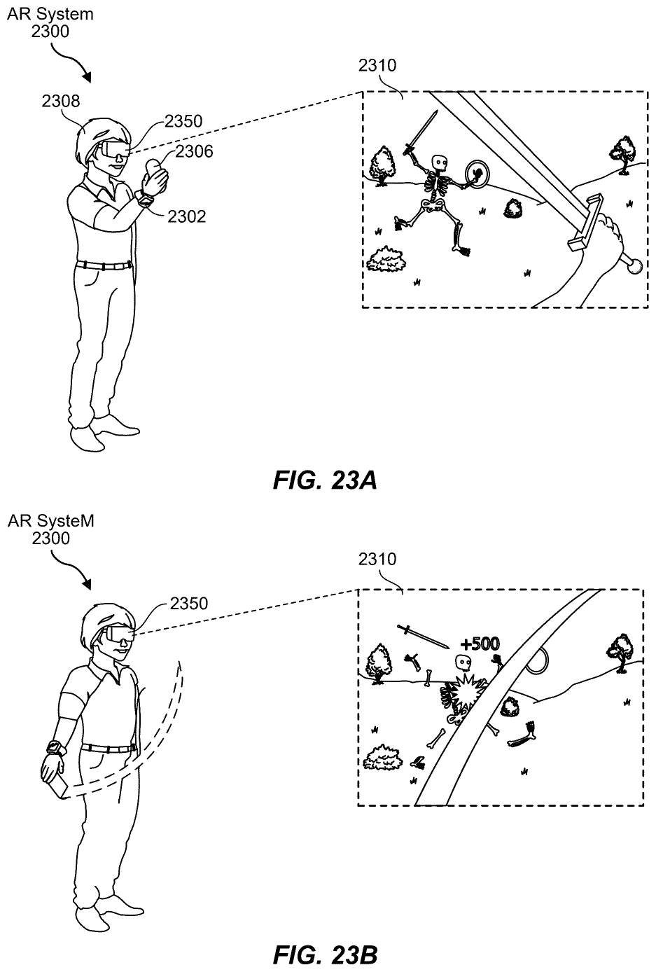

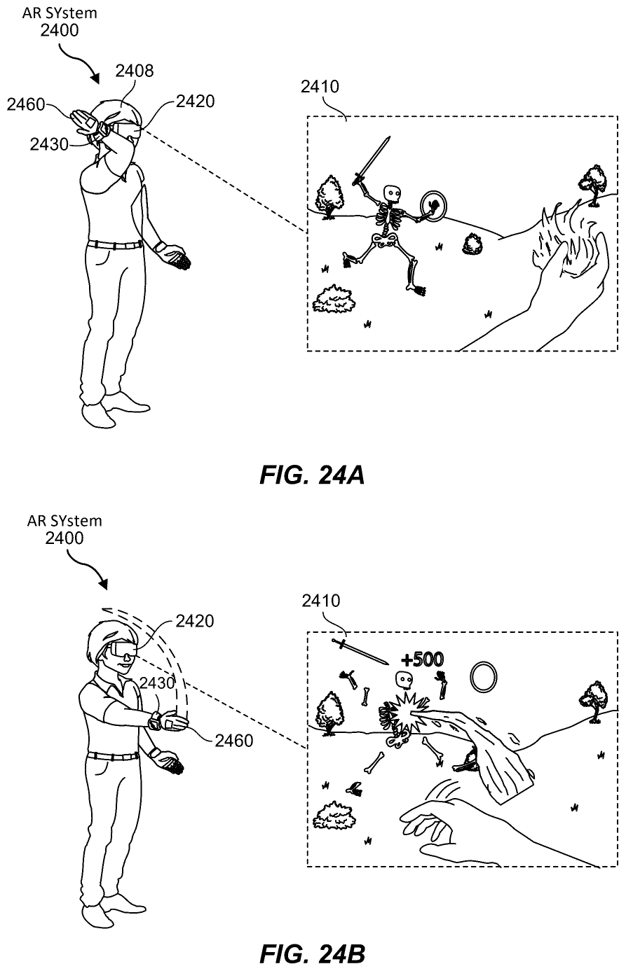

FIGS. 21-24B illustrate example artificial-reality (AR) systems in accordance with some embodiments. FIG. 21 shows a first AR system 2100 and first example user interactions using a wrist-wearable device 2102, a head-wearable device (e.g., AR glasses 2700), and/or a handheld intermediary processing device (HIPD) 2106. FIG. 22 shows a second AR system 2200 and second example user interactions using a wrist-wearable device 2202, AR glasses 2204, and/or an HIPD 2206. FIGS. 23A and 23B show a third AR system 2300 and third example user 2308 interactions using a wrist-wearable device 2302, a head-wearable device (e.g., VR headset 2350), and/or an HIPD 2306. FIGS. 24A and 24B show a fourth AR system 2400 and fourth example user 2408 interactions using a wrist-wearable device 2430, VR headset 2420, and/or a haptic device 2460 (e.g., wearable gloves).

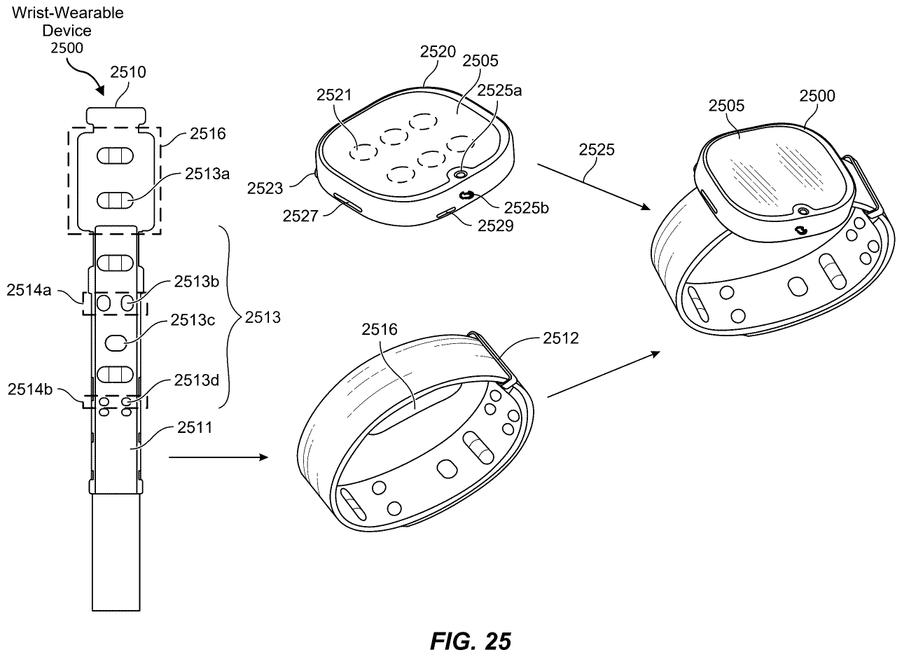

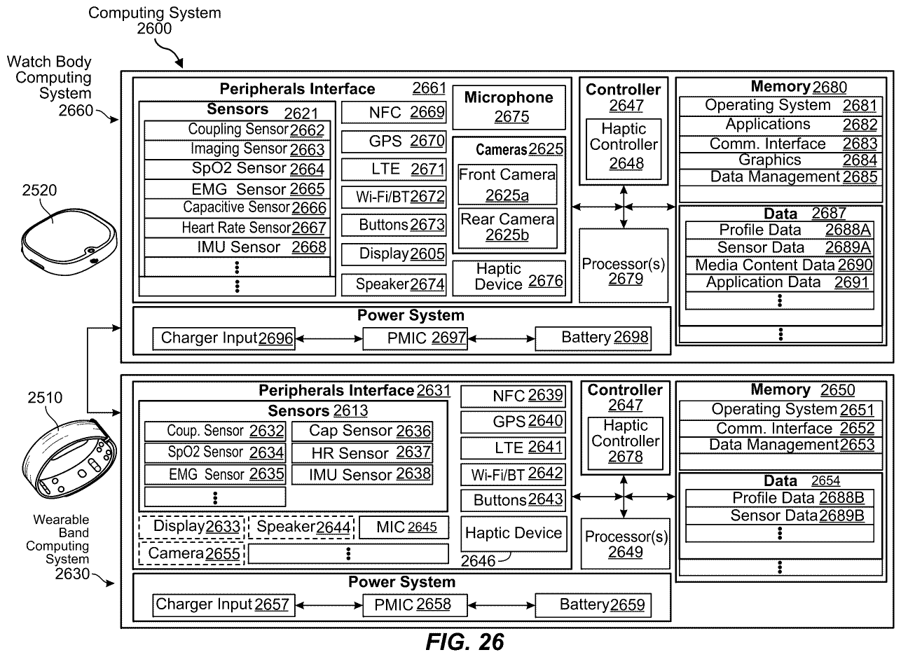

A wrist-wearable device 2500, which can be used for wrist-wearable device 2102, 2202, 2302, 2430, and one or more of its components, are described below in reference to FIGS. 25 and 26; head-wearable devices 2700 and 2800, which can respectively be used for AR glasses 2104, 2204 or VR headset 2350, 2420, and their one or more components are described below in reference to FIGS. 27-29.

Referring to FIG. 21, wrist-wearable device 2102, AR glasses 2104, and/or HIPD 2106 can communicatively couple via a network 2125 (e.g., cellular, near field, Wi-Fi, personal area network, wireless LAN, etc.). Additionally, wrist-wearable device 2102, AR glasses 2104, and/or HIPD 2106 can also communicatively couple with one or more servers 2130, computers 2140 (e.g., laptops, computers, etc.), mobile devices 2150 (e.g., smartphones, tablets, etc.), and/or other electronic devices via network 2125 (e.g., cellular, near field, Wi-Fi, personal area network, wireless LAN, etc.).

In FIG. 21, a user 2108 is shown wearing wrist-wearable device 2102 and AR glasses 2104 and having HIPD 2106 on their desk. The wrist-wearable device 2102, AR glasses 2104, and HIPD 2106 facilitate user interaction with an AR environment. In particular, as shown by first AR system 2100, wrist-wearable device 2102, AR glasses 2104, and/or HIPD 2106 cause presentation of one or more avatars 2110, digital representations of contacts 2112, and virtual objects 2114. As discussed below, user 2108 can interact with one or more avatars 2110, digital representations of contacts 2112, and virtual objects 2114 via wrist-wearable device 2102, AR glasses 2104, and/or HIPD 2106.

User 2108 can use any of wrist-wearable device 2102, AR glasses 2104, and/or HIPD 2106 to provide user inputs. For example, user 2108 can perform one or more hand gestures that are detected by wrist-wearable device 2102 (e.g., using one or more EMG sensors and/or IMUs, described below in reference to FIGS. 25 and 26) and/or AR glasses 2104 (e.g., using one or more image sensor or camera, described below in reference to FIGS. 27-10) to provide a user input. Alternatively, or additionally, user 2108 can provide a user input via one or more touch surfaces of wrist-wearable device 2102, AR glasses 2104, HIPD 2106, and/or voice commands captured by a microphone of wrist-wearable device 2102, AR glasses 2104, and/or HIPD 2106. In some embodiments, wrist-wearable device 2102, AR glasses 2104, and/or HIPD 2106 include a digital assistant to help user 2108 in providing a user input (e.g., completing a sequence of operations, suggesting different operations or commands, providing reminders, confirming a command, etc.). In some embodiments, user 2108 can provide a user input via one or more facial gestures and/or facial expressions. For example, cameras of wrist-wearable device 2102, AR glasses 2104, and/or HIPD 2106 can track eyes of user 2108 for navigating a user interface.

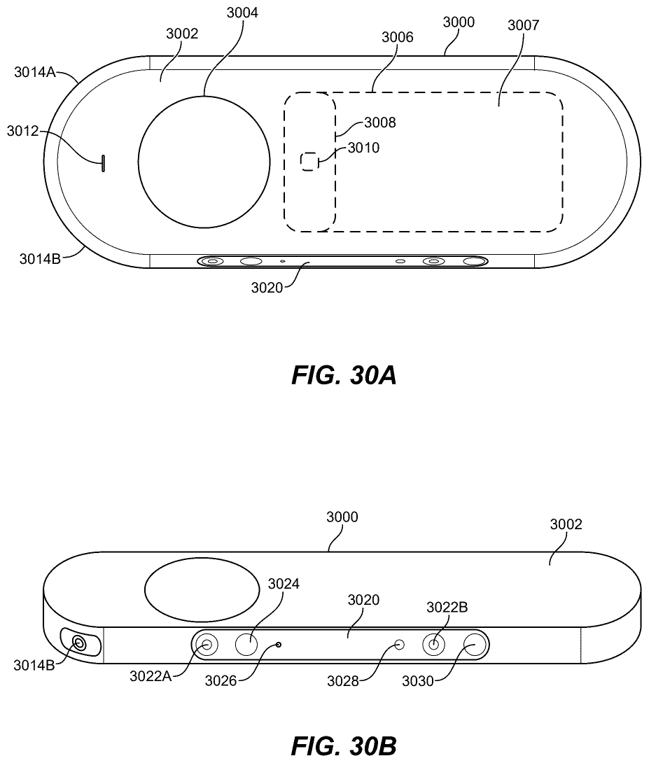

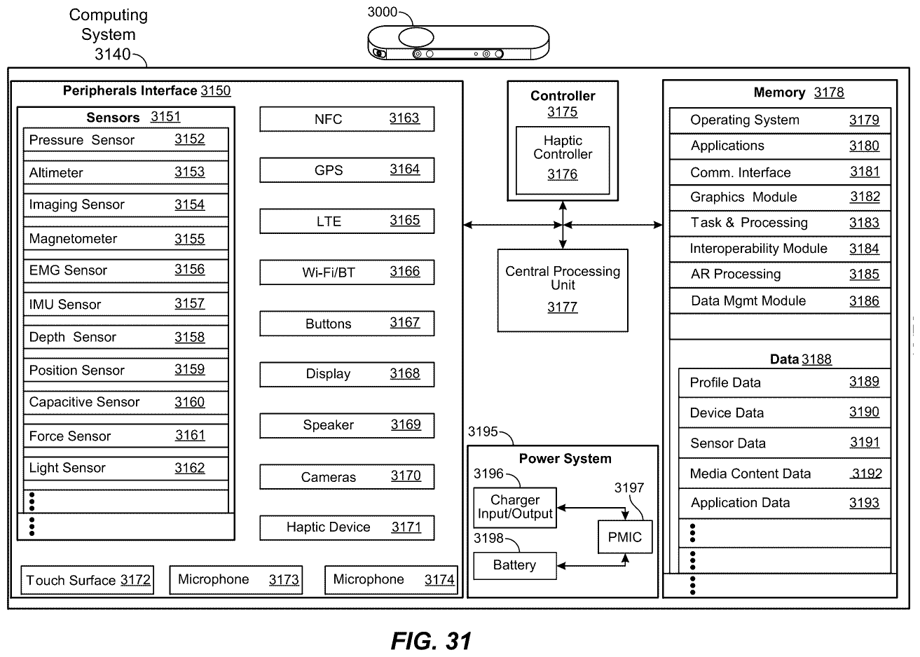

Wrist-wearable device 2102, AR glasses 2104, and/or HIPD 2106 can operate alone or in conjunction to allow user 2108 to interact with the AR environment. In some embodiments, HIPD 2106 is configured to operate as a central hub or control center for the wrist-wearable device 2102, AR glasses 2104, and/or another communicatively coupled device. For example, user 2108 can provide an input to interact with the AR environment at any of wrist-wearable device 2102, AR glasses 2104, and/or HIPD 2106, and HIPD 2106 can identify one or more back-end and front-end tasks to cause the performance of the requested interaction and distribute instructions to cause the performance of the one or more back-end and front-end tasks at wrist-wearable device 2102, AR glasses 2104, and/or HIPD 2106. In some embodiments, a back-end task is a background processing task that is not perceptible by the user (e.g., rendering content, decompression, compression, etc.), and a front-end task is a user-facing task that is perceptible to the user (e.g., presenting information to the user, providing feedback to the user, etc.). As described below in reference to FIGS. 30-31, HIPD 2106 can perform the back-end tasks and provide wrist-wearable device 2102 and/or AR glasses 2104 operational data corresponding to the performed back-end tasks such that wrist-wearable device 2102 and/or AR glasses 2104 can perform the front-end tasks. In this way, HIPD 2106, which has more computational resources and greater thermal headroom than wrist-wearable device 2102 and/or AR glasses 2104, performs computationally intensive tasks and reduces the computer resource utilization and/or power usage of wrist-wearable device 2102 and/or AR glasses 2104.

In the example shown by first AR system 2100, HIPD 2106 identifies one or more back-end tasks and front-end tasks associated with a user request to initiate an AR video call with one or more other users (represented by avatar 2110 and the digital representation of contact 2112) and distributes instructions to cause the performance of the one or more back-end tasks and front-end tasks. In particular, HIPD 2106 performs back-end tasks for processing and/or rendering image data (and other data) associated with the AR video call and provides operational data associated with the performed back-end tasks to AR glasses 2104 such that the AR glasses 2104 perform front-end tasks for presenting the AR video call (e.g., presenting avatar 2110 and digital representation of contact 2112).

In some embodiments, HIPD 2106 can operate as a focal or anchor point for causing the presentation of information. This allows user 2108 to be generally aware of where information is presented. For example, as shown in first AR system 2100, avatar 2110 and the digital representation of contact 2112 are presented above HIPD 2106. In particular, HIPD 2106 and AR glasses 2104 operate in conjunction to determine a location for presenting avatar 2110 and the digital representation of contact 2112. In some embodiments, information can be presented a predetermined distance from HIPD 2106 (e.g., within 5 meters). For example, as shown in first AR system 2100, virtual object 2114 is presented on the desk some distance from HIPD 2106. Similar to the above example, HIPD 2106 and AR glasses 2104 can operate in conjunction to determine a location for presenting virtual object 2114. Alternatively, in some embodiments, presentation of information is not bound by HIPD 2106. More specifically, avatar 2110, digital representation of contact 2112, and virtual object 2114 do not have to be presented within a predetermined distance of HIPD 2106.

User inputs provided at wrist-wearable device 2102, AR glasses 2104, and/or HIPD 2106 are coordinated such that the user can use any device to initiate, continue, and/or complete an operation. For example, user 2108 can provide a user input to AR glasses 2104 to cause AR glasses 2104 to present virtual object 2114 and, while virtual object 2114 is presented by AR glasses 2104, user 2108 can provide one or more hand gestures via wrist-wearable device 2102 to interact and/or manipulate virtual object 2114.

FIG. 22 shows a user 2208 wearing a wrist-wearable device 2202 and AR glasses 2204, and holding an HIPD 2206. In second AR system 2200, the wrist-wearable device 2202, AR glasses 2204, and/or HIPD 2206 are used to receive and/or provide one or more messages to a contact of user 2208. In particular, wrist-wearable device 2202, AR glasses 2204, and/or HIPD 2206 detect and coordinate one or more user inputs to initiate a messaging application and prepare a response to a received message via the messaging application.

In some embodiments, user 2208 initiates, via a user input, an application on wrist-wearable device 2202, AR glasses 2204, and/or HIPD 2206 that causes the application to initiate on at least one device. For example, in second AR system 2200, user 2208 performs a hand gesture associated with a command for initiating a messaging application (represented by messaging user interface 2216), wrist-wearable device 2202 detects the hand gesture and, based on a determination that user 2208 is wearing AR glasses 2204, causes AR glasses 2204 to present a messaging user interface 2216 of the messaging application. AR glasses 2204 can present messaging user interface 2216 to user 2208 via its display (e.g., as shown by a field of view 2218 of user 2208). In some embodiments, the application is initiated and executed on the device (e.g., wrist-wearable device 2202, AR glasses 2204, and/or HIPD 2206) that detects the user input to initiate the application, and the device provides another device operational data to cause the presentation of the messaging application. For example, wrist-wearable device 2202 can detect the user input to initiate a messaging application, initiate and run the messaging application, and provide operational data to AR glasses 2204 and/or HIPD 2206 to cause presentation of the messaging application. Alternatively, the application can be initiated and executed at a device other than the device that detected the user input. For example, wrist-wearable device 2202 can detect the hand gesture associated with initiating the messaging application and cause HIPD 2206 to run the messaging application and coordinate the presentation of the messaging application.

Further, user 2208 can provide a user input provided at wrist-wearable device 2202, AR glasses 2204, and/or HIPD 2206 to continue and/or complete an operation initiated at another device. For example, after initiating the messaging application via wrist-wearable device 2202 and while AR glasses 2204 present messaging user interface 2216, user 2208 can provide an input at HIPD 2206 to prepare a response (e.g., shown by the swipe gesture performed on HIPD 2206). Gestures performed by user 2208 on HIPD 2206 can be provided and/or displayed on another device. For example, a swipe gestured performed on HIPD 2206 is displayed on a virtual keyboard of messaging user interface 2216 displayed by AR glasses 2204.

In some embodiments, wrist-wearable device 2202, AR glasses 2204, HIPD 2206, and/or any other communicatively coupled device can present one or more notifications to user 2208. The notification can be an indication of a new message, an incoming call, an application update, a status update, etc. User 2208 can select the notification via wrist-wearable device 2202, AR glasses 2204, and/or HIPD 2206 and can cause presentation of an application or operation associated with the notification on at least one device. For example, user 2208 can receive a notification that a message was received at wrist-wearable device 2202, AR glasses 2204, HIPD 2206, and/or any other communicatively coupled device and can then provide a user input at wrist-wearable device 2202, AR glasses 2204, and/or HIPD 2206 to review the notification, and the device detecting the user input can cause an application associated with the notification to be initiated and/or presented at wrist-wearable device 2202, AR glasses 2204, and/or HIPD 2206.

While the above example describes coordinated inputs used to interact with a messaging application, user inputs can be coordinated to interact with any number of applications including, but not limited to, gaming applications, social media applications, camera applications, web-based applications, financial applications, etc. For example, AR glasses 2204 can present to user 2208 game application data, and HIPD 2206 can be used as a controller to provide inputs to the game. Similarly, user 2208 can use wrist-wearable device 2202 to initiate a camera of AR glasses 2204, and user 308 can use wrist-wearable device 2202, AR glasses 2204, and/or HIPD 2206 to manipulate the image capture (e.g., zoom in or out, apply filters, etc.) and capture image data.

Users may interact with the devices disclosed herein in a variety of ways. For example, as shown in FIGS. 23A and 23B, a user 2308 may interact with an AR system 2300 by donning a VR headset 2350 while holding HIPD 2306 and wearing wrist-wearable device 2302. In this example, AR system 2300 may enable a user to interact with a game 2310 by swiping their arm. One or more of VR headset 2350, HIPD 2306, and wrist-wearable device 2302 may detect this gesture and, in response, may display a sword strike in game 2310. Similarly, in FIGS. 24A and 24B, a user 2408 may interact with an AR system 2400 by donning a VR headset 2420 while wearing haptic device 2460 and wrist-wearable device 2430. In this example, AR system 2400 may enable a user to interact with a game 2410 by swiping their arm. One or more of VR headset 2420, haptic device 2460, and wrist-wearable device 2430 may detect this gesture and, in response, may display a spell being cast in game 2310.

Having discussed example AR systems, devices for interacting with such AR systems and other computing systems more generally will now be discussed in greater detail. Some explanations of devices and components that can be included in some or all of the example devices discussed below are explained herein for ease of reference. Certain types of the components described below may be more suitable for a particular set of devices, and less suitable for a different set of devices. But subsequent reference to the components explained here should be considered to be encompassed by the descriptions provided.

In some embodiments discussed below, example devices and systems, including electronic devices and systems, will be addressed. Such example devices and systems are not intended to be limiting, and one of skill in the art will understand that alternative devices and systems to the example devices and systems described herein may be used to perform the operations and construct the systems and devices that are described herein.

An electronic device may be a device that uses electrical energy to perform a specific function. An electronic device can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device may be a device that sits between two other electronic devices and/or a subset of components of one or more electronic devices and facilitates communication, data processing, and/or data transfer between the respective electronic devices and/or electronic components.

An integrated circuit may be an electronic device made up of multiple interconnected electronic components such as transistors, resistors, and capacitors. These components may be etched onto a small piece of semiconductor material, such as silicon. Integrated circuits may include analog integrated circuits, digital integrated circuits, mixed signal integrated circuits, and/or any other suitable type or form of integrated circuit. Examples of integrated circuits include application-specific integrated circuits (ASICs), processing units, central processing units (CPUs), co-processors, and accelerators.

Analog integrated circuits, such as sensors, power management circuits, and operational amplifiers, may process continuous signals and perform analog functions such as amplification, active filtering, demodulation, and mixing. Examples of analog integrated circuits include linear integrated circuits and radio frequency circuits.

Digital integrated circuits, which may be referred to as logic integrated circuits, may include microprocessors, microcontrollers, memory chips, interfaces, power management circuits, programmable devices, and/or any other suitable type or form of integrated circuit. In some embodiments, examples of integrated circuits include central processing units (CPUs),

Processing units, such as CPUs, may be electronic components that are responsible for executing instructions and controlling the operation of an electronic device (e.g., a computer). There are various types of processors that may be used interchangeably, or may be specifically required, by embodiments described herein. For example, a processor may be: (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) an accelerator, such as a graphics processing unit (GPU), designed to accelerate the creation and rendering of images, videos, and animations (e.g., virtual-reality animations, such as three-dimensional modeling); (iv) a field-programmable gate array (FPGA) that can be programmed and reconfigured after manufacturing and/or can be customized to perform specific tasks, such as signal processing, cryptography, and machine learning; and/or (v) a digital signal processor (DSP) designed to perform mathematical operations on signals such as audio, video, and radio waves. One or more processors of one or more electronic devices may be used in various embodiments described herein.

Memory generally refers to electronic components in a computer or electronic device that store data and instructions for the processor to access and manipulate. Examples of memory can include: (i) random access memory (RAM) configured to store data and instructions temporarily; (ii) read-only memory (ROM) configured to store data and instructions permanently (e.g., one or more portions of system firmware, and/or boot loaders) and/or semi-permanently; (iii) flash memory, which can be configured to store data in electronic devices (e.g., USB drives, memory cards, and/or solid-state drives (SSDs)); and/or (iv) cache memory configured to temporarily store frequently accessed data and instructions. Memory, as described herein, can store structured data (e.g., SQL databases, MongoDB databases, GraphQL data, JSON data, etc.). Other examples of data stored in memory can include (i) profile data, including user account data, user settings, and/or other user data stored by the user, (ii) sensor data detected and/or otherwise obtained by one or more sensors, (iii) media content data including stored image data, audio data, documents, and the like, (iv) application data, which can include data collected and/or otherwise obtained and stored during use of an application, and/or any other types of data described herein.

Controllers may be electronic components that manage and coordinate the operation of other components within an electronic device (e.g., controlling inputs, processing data, and/or generating outputs). Examples of controllers can include: (i) microcontrollers, including small, low-power controllers that are commonly used in embedded systems and Internet of Things (IOT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs.

A power system of an electronic device may be configured to convert incoming electrical power into a form that can be used to operate the device. A power system can include various components, such as (i) a power source, which can be an alternating current (AC) adapter or a direct current (DC) adapter power supply, (ii) a charger input, which can be configured to use a wired and/or wireless connection (which may be part of a peripheral interface, such as a USB, micro-USB interface, near-field magnetic coupling, magnetic inductive and magnetic resonance charging, and/or radio frequency (RF) charging), (iii) a power-management integrated circuit, configured to distribute power to various components of the device and to ensure that the device operates within safe limits (e.g., regulating voltage, controlling current flow, and/or managing heat dissipation), and/or (iv) a battery configured to store power to provide usable power to components of one or more electronic devices.

Peripheral interfaces may be electronic components (e.g., of electronic devices) that allow electronic devices to communicate with other devices or peripherals and can provide the ability to input and output data and signals. Examples of peripheral interfaces can include (i) universal serial bus (USB) and/or micro-USB interfaces configured for connecting devices to an electronic device, (ii) Bluetooth interfaces configured to allow devices to communicate with each other, including Bluetooth low energy (BLE), (iii) near field communication (NFC) interfaces configured to be short-range wireless interfaces for operations such as access control, (iv) POGO pins, which may be small, spring-loaded pins configured to provide a charging interface, (v) wireless charging interfaces, (vi) GPS interfaces, (vii) Wi-Fi interfaces for providing a connection between a device and a wireless network, and/or (viii) sensor interfaces.

Sensors may be electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device), (ii) biopotential-signal sensors, (iii) inertial measurement units (e.g., IMUs) for detecting, for example, angular rate, force, magnetic field, and/or changes in acceleration, (iv) heart rate sensors for measuring a user's heart rate, (v) SpO2 sensors for measuring blood oxygen saturation and/or other biometric data of a user, (vi) capacitive sensors for detecting changes in potential at a portion of a user's body (e.g., a sensor-skin interface), and/or (vii) light sensors (e.g., time-of-flight sensors, infrared light sensors, visible light sensors, etc.).

Biopotential-signal-sensing components may be devices used to measure electrical activity within the body (e.g., biopotential-signal sensors). Some types of biopotential-signal sensors include (i) electroencephalography (EEG) sensors configured to measure electrical activity in the brain to diagnose neurological disorders, (ii) electrocardiography (ECG or EKG) sensors configured to measure electrical activity of the heart to diagnose heart problems, (iii) electromyography (EMG) sensors configured to measure the electrical activity of muscles and to diagnose neuromuscular disorders, and (iv) electrooculography (EOG) sensors configure to measure the electrical activity of eye muscles to detect eye movement and diagnose eye disorders.

An application stored in memory of an electronic device (e.g., software) may include instructions stored in the memory. Examples of such applications include (i) games, (ii) word processors, (iii) messaging applications, (iv) media-streaming applications, (v) financial applications, (vi) calendars. (vii) clocks, and (viii) communication interface modules for enabling wired and/or wireless connections between different respective electronic devices (e.g., IEEE 2702.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocols).

A communication interface may be a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, Bluetooth). In some embodiments, a communication interface can refer to a software layer that enables different software programs to communicate with each other (e.g., application programming interfaces (APIs), protocols like HTTP and TCP/IP, etc.).

A graphics module may be a component or software module that is designed to handle graphical operations and/or processes and can include a hardware module and/or a software module.

Non-transitory computer-readable storage media may be physical devices or storage media that can be used to store electronic data in a non-transitory form (e.g., such that the data is stored permanently until it is intentionally deleted or modified).

FIGS. 25 and 26 illustrate an example wrist-wearable device 2500 and an example computer system 2600, in accordance with some embodiments. Wrist-wearable device 2500 is an instance of wearable device 2102 described in FIG. 21 herein, such that the wearable device 2102 should be understood to have the features of the wrist-wearable device 2500 and vice versa. FIG. 26 illustrates components of the wrist-wearable device 2500, which can be used individually or in combination, including combinations that include other electronic devices and/or electronic components.

FIG. 25 shows a wearable band 2510 and a watch body 2520 (or capsule) being coupled, as discussed below, to form wrist-wearable device 2500. Wrist-wearable device 2500 can perform various functions and/or operations associated with navigating through user interfaces and selectively opening applications as well as the functions and/or operations described above with reference to FIGS. 21-24B.

As will be described in more detail below, operations executed by wrist-wearable device 2500 can include (i) presenting content to a user (e.g., displaying visual content via a display 2505), (ii) detecting (e.g., sensing) user input (e.g., sensing a touch on peripheral button 2523 and/or at a touch screen of the display 2505, a hand gesture detected by sensors (e.g., biopotential sensors)), (iii) sensing biometric data (e.g., neuromuscular signals, heart rate, temperature, sleep, etc.) via one or more sensors 2513, messaging (e.g., text, speech, video, etc.); image capture via one or more imaging devices or cameras 2525, wireless communications (e.g., cellular, near field, Wi-Fi, personal area network, etc.), location determination, financial transactions, providing haptic feedback, providing alarms, providing notifications, providing biometric authentication, providing health monitoring, providing sleep monitoring, etc.

The above-example functions can be executed independently in watch body 2520, independently in wearable band 2510, and/or via an electronic communication between watch body 2520 and wearable band 2510. In some embodiments, functions can be executed on wrist-wearable device 2500 while an AR environment is being presented (e.g., via one of AR systems 2100 to 2400). The wearable devices described herein can also be used with other types of AR environments.

Wearable band 2510 can be configured to be worn by a user such that an inner surface of a wearable structure 2511 of wearable band 2510 is in contact with the user's skin. In this example, when worn by a user, sensors 2513 may contact the user's skin. In some examples, one or more of sensors 2513 can sense biometric data such as a user's heart rate, a saturated oxygen level, temperature, sweat level, neuromuscular signals, or a combination thereof. One or more of sensors 2513 can also sense data about a user's environment including a user's motion, altitude, location, orientation, gait, acceleration, position, or a combination thereof. In some embodiment, one or more of sensors 2513 can be configured to track a position and/or motion of wearable band 2510. One or more of sensors 2513 can include any of the sensors defined above and/or discussed below with respect to FIG. 25.

One or more of sensors 2513 can be distributed on an inside and/or an outside surface of wearable band 2510. In some embodiments, one or more of sensors 2513 are uniformly spaced along wearable band 2510. Alternatively, in some embodiments, one or more of sensors 2513 are positioned at distinct points along wearable band 2510. As shown in FIG. 25, one or more of sensors 2513 can be the same or distinct. For example, in some embodiments, one or more of sensors 2513 can be shaped as a pill (e.g., sensor 2513a), an oval, a circle a square, an oblong (e.g., sensor 2513c) and/or any other shape that maintains contact with the user's skin (e.g., such that neuromuscular signal and/or other biometric data can be accurately measured at the user's skin). In some embodiments, one or more sensors of 2513 are aligned to form pairs of sensors (e.g., for sensing neuromuscular signals based on differential sensing within each respective sensor). For example, sensor 2513b may be aligned with an adjacent sensor to form sensor pair 2514a and sensor 2513d may be aligned with an adjacent sensor to form sensor pair 2514b. In some embodiments, wearable band 2510 does not have a sensor pair. Alternatively, in some embodiments, wearable band 2510 has a predetermined number of sensor pairs (one pair of sensors, three pairs of sensors, four pairs of sensors, six pairs of sensors, sixteen pairs of sensors, etc.).

Wearable band 2510 can include any suitable number of sensors 2513. In some embodiments, the number and arrangement of sensors 2513 depends on the particular application for which wearable band 2510 is used. For instance, wearable band 2510 can be configured as an armband, wristband, or chest-band that include a plurality of sensors 2513 with different number of sensors 2513, a variety of types of individual sensors with the plurality of sensors 2513, and different arrangements for each use case, such as medical use cases as compared to gaming or general day-to-day use cases.

In accordance with some embodiments, wearable band 2510 further includes an electrical ground electrode and a shielding electrode. The electrical ground and shielding electrodes, like the sensors 2513, can be distributed on the inside surface of the wearable band 2510 such that they contact a portion of the user's skin. For example, the electrical ground and shielding electrodes can be at an inside surface of a coupling mechanism 2516 or an inside surface of a wearable structure 2511. The electrical ground and shielding electrodes can be formed and/or use the same components as sensors 2513. In some embodiments, wearable band 2510 includes more than one electrical ground electrode and more than one shielding electrode.

Sensors 2513 can be formed as part of wearable structure 2511 of wearable band 2510. In some embodiments, sensors 2513 are flush or substantially flush with wearable structure 2511 such that they do not extend beyond the surface of wearable structure 2511. While flush with wearable structure 2511, sensors 2513 are still configured to contact the user's skin (e.g., via a skin-contacting surface). Alternatively, in some embodiments, sensors 2513 extend beyond wearable structure 2511 a predetermined distance (e.g., 0.1-2 mm) to make contact and depress into the user's skin. In some embodiment, sensors 2513 are coupled to an actuator (not shown) configured to adjust an extension height (e.g., a distance from the surface of wearable structure 2511) of sensors 2513 such that sensors 2513 make contact and depress into the user's skin. In some embodiments, the actuators adjust the extension height between 0.01 mm-1.2 mm. This may allow a the user to customize the positioning of sensors 2513 to improve the overall comfort of the wearable band 2510 when worn while still allowing sensors 2513 to contact the user's skin. In some embodiments, sensors 2513 are indistinguishable from wearable structure 2511 when worn by the user.

Wearable structure 2511 can be formed of an elastic material, elastomers, etc., configured to be stretched and fitted to be worn by the user. In some embodiments, wearable structure 2511 is a textile or woven fabric. As described above, sensors 2513 can be formed as part of a wearable structure 2511. For example, sensors 2513 can be molded into the wearable structure 2511, be integrated into a woven fabric (e.g., sensors 2513 can be sewn into the fabric and mimic the pliability of fabric and can and/or be constructed from a series woven strands of fabric).

Wearable structure 2511 can include flexible electronic connectors that interconnect sensors 2513, the electronic circuitry, and/or other electronic components (described below in reference to FIG. 26) that are enclosed in wearable band 2510. In some embodiments, the flexible electronic connectors are configured to interconnect sensors 2513, the electronic circuitry, and/or other electronic components of wearable band 2510 with respective sensors and/or other electronic components of another electronic device (e.g., watch body 2520). The flexible electronic connectors are configured to move with wearable structure 2511 such that the user adjustment to wearable structure 2511 (e.g., resizing, pulling, folding, etc.) does not stress or strain the electrical coupling of components of wearable band 2510.

As described above, wearable band 2510 is configured to be worn by a user. In particular, wearable band 2510 can be shaped or otherwise manipulated to be worn by a user. For example, wearable band 2510 can be shaped to have a substantially circular shape such that it can be configured to be worn on the user's lower arm or wrist. Alternatively, wearable band 2510 can be shaped to be worn on another body part of the user, such as the user's upper arm (e.g., around a bicep), forearm, chest, legs, etc. Wearable band 2510 can include a retaining mechanism 2512 (e.g., a buckle, a hook and loop fastener, etc.) for securing wearable band 2510 to the user's wrist or other body part. While wearable band 2510 is worn by the user, sensors 2513 sense data (referred to as sensor data) from the user's skin. In some examples, sensors 2513 of wearable band 2510 obtain (e.g., sense and record) neuromuscular signals.

The sensed data (e.g., sensed neuromuscular signals) can be used to detect and/or determine the user's intention to perform certain motor actions. In some examples, sensors 2513 may sense and record neuromuscular signals from the user as the user performs muscular activations (e.g., movements, gestures, etc.). The detected and/or determined motor actions (e.g., phalange (or digit) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on display 2505 of wrist-wearable device 2500 and/or can be transmitted to a device responsible for rendering an artificial-reality environment (e.g., a head-mounted display) to perform an action in an associated artificial-reality environment, such as to control the motion of a virtual device displayed to the user. The muscular activations performed by the user can include static gestures, such as placing the user's hand palm down on a table, dynamic gestures, such as grasping a physical or virtual object, and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by sensors 2513 can be used to provide a user with an enhanced interaction with a physical object (e.g., devices communicatively coupled with wearable band 2510) and/or a virtual object in an artificial-reality application generated by an artificial-reality system (e.g., user interface objects presented on the display 2505, or another computing device (e.g., a smartphone)).

In some embodiments, wearable band 2510 includes one or more haptic devices 2646 (e.g., a vibratory haptic actuator) that are configured to provide haptic feedback (e.g., a cutaneous and/or kinesthetic sensation, etc.) to the user's skin. Sensors 2513 and/or haptic devices 2646 (shown in FIG. 26) can be configured to operate in conjunction with multiple applications including, without limitation, health monitoring, social media, games, and artificial reality (e.g., the applications associated with artificial reality).

Wearable band 2510 can also include coupling mechanism 2516 for detachably coupling a capsule (e.g., a computing unit) or watch body 2520 (via a coupling surface of the watch body 2520) to wearable band 2510. For example, a cradle or a shape of coupling mechanism 2516 can correspond to shape of watch body 2520 of wrist-wearable device 2500. In particular, coupling mechanism 2516 can be configured to receive a coupling surface proximate to the bottom side of watch body 2520 (e.g., a side opposite to a front side of watch body 2520 where display 2505 is located), such that a user can push watch body 2520 downward into coupling mechanism 2516 to attach watch body 2520 to coupling mechanism 2516. In some embodiments, coupling mechanism 2516 can be configured to receive a top side of the watch body 2520 (e.g., a side proximate to the front side of watch body 2520 where display 2505 is located) that is pushed upward into the cradle, as opposed to being pushed downward into coupling mechanism 2516. In some embodiments, coupling mechanism 2516 is an integrated component of wearable band 2510 such that wearable band 2510 and coupling mechanism 2516 are a single unitary structure. In some embodiments, coupling mechanism 2516 is a type of frame or shell that allows watch body 2520 coupling surface to be retained within or on wearable band 2510 coupling mechanism 2516 (e.g., a cradle, a tracker band, a support base, a clasp, etc.).

Coupling mechanism 2516 can allow for watch body 2520 to be detachably coupled to the wearable band 2510 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 2520 to wearable band 2510 and to decouple the watch body 2520 from the wearable band 2510. For example, a user can twist, slide, turn, push, pull, or rotate watch body 2520 relative to wearable band 2510, or a combination thereof, to attach watch body 2520 to wearable band 2510 and to detach watch body 2520 from wearable band 2510. Alternatively, as discussed below, in some embodiments, the watch body 2520 can be decoupled from the wearable band 2510 by actuation of a release mechanism 2529.

Wearable band 2510 can be coupled with watch body 2520 to increase the functionality of wearable band 2510 (e.g., converting wearable band 2510 into wrist-wearable device 2500, adding an additional computing unit and/or battery to increase computational resources and/or a battery life of wearable band 2510, adding additional sensors to improve sensed data, etc.). As described above, wearable band 2510 and coupling mechanism 2516 are configured to operate independently (e.g., execute functions independently) from watch body 2520. For example, coupling mechanism 2516 can include one or more sensors 2513 that contact a user's skin when wearable band 2510 is worn by the user, with or without watch body 2520 and can provide sensor data for determining control commands.

A user can detach watch body 2520 from wearable band 2510 to reduce the encumbrance of wrist-wearable device 2500 to the user. For embodiments in which watch body 2520 is removable, watch body 2520 can be referred to as a removable structure, such that in these embodiments wrist-wearable device 2500 includes a wearable portion (e.g., wearable band 2510) and a removable structure (e.g., watch body 2520).

Turning to watch body 2520, in some examples watch body 2520 can have a substantially rectangular or circular shape. Watch body 2520 is configured to be worn by the user on their wrist or on another body part. More specifically, watch body 2520 is sized to be easily carried by the user, attached on a portion of the user's clothing, and/or coupled to wearable band 2510 (forming the wrist-wearable device 2500). As described above, watch body 2520 can have a shape corresponding to coupling mechanism 2516 of wearable band 2510. In some embodiments, watch body 2520 includes a single release mechanism 2529 or multiple release mechanisms (e.g., two release mechanisms 2529 positioned on opposing sides of watch body 2520, such as spring-loaded buttons) for decoupling watch body 2520 from wearable band 2510. Release mechanism 2529 can include, without limitation, a button, a knob, a plunger, a handle, a lever, a fastener, a clasp, a dial, a latch, or a combination thereof.

A user can actuate release mechanism 2529 by pushing, turning, lifting, depressing, shifting, or performing other actions on release mechanism 2529. Actuation of release mechanism 2529 can release (e.g., decouple) watch body 2520 from coupling mechanism 2516 of wearable band 2510, allowing the user to use watch body 2520 independently from wearable band 2510 and vice versa. For example, decoupling watch body 2520 from wearable band 2510 can allow a user to capture images using rear-facing camera 2525b. Although release mechanism 2529 is shown positioned at a corner of watch body 2520, release mechanism 2529 can be positioned anywhere on watch body 2520 that is convenient for the user to actuate. In addition, in some embodiments, wearable band 2510 can also include a respective release mechanism for decoupling watch body 2520 from coupling mechanism 2516. In some embodiments, release mechanism 2529 is optional and watch body 2520 can be decoupled from coupling mechanism 2516 as described above (e.g., via twisting, rotating, etc.).

Watch body 2520 can include one or more peripheral buttons 2523 and 2527 for performing various operations at watch body 2520. For example, peripheral buttons 2523 and 2527 can be used to turn on or wake (e.g., transition from a sleep state to an active state) display 2505, unlock watch body 2520, increase or decrease a volume, increase or decrease a brightness, interact with one or more applications, interact with one or more user interfaces, etc. Additionally or alternatively, in some embodiments, display 2505 operates as a touch screen and allows the user to provide one or more inputs for interacting with watch body 2520.

In some embodiments, watch body 2520 includes one or more sensors 2521. Sensors 2521 of watch body 2520 can be the same or distinct from sensors 2513 of wearable band 2510. Sensors 2521 of watch body 2520 can be distributed on an inside and/or an outside surface of watch body 2520. In some embodiments, sensors 2521 are configured to contact a user's skin when watch body 2520 is worn by the user. For example, sensors 2521 can be placed on the bottom side of watch body 2520 and coupling mechanism 2516 can be a cradle with an opening that allows the bottom side of watch body 2520 to directly contact the user's skin. Alternatively, in some embodiments, watch body 2520 does not include sensors that are configured to contact the user's skin (e.g., including sensors internal and/or external to the watch body 2520 that are configured to sense data of watch body 2520 and the surrounding environment). In some embodiments, sensors 2521 are configured to track a position and/or motion of watch body 2520.

Watch body 2520 and wearable band 2510 can share data using a wired communication method (e.g., a Universal Asynchronous Receiver/Transmitter (UART), a USB transceiver, etc.) and/or a wireless communication method (e.g., near field communication, Bluetooth, etc.). For example, watch body 2520 and wearable band 2510 can share data sensed by sensors 2513 and 2521, as well as application and device specific information (e.g., active and/or available applications, output devices (e.g., displays, speakers, etc.), input devices (e.g., touch screens, microphones, imaging sensors, etc.).

In some embodiments, watch body 2520 can include, without limitation, a front-facing camera 2525a and/or a rear-facing camera 2525b, sensors 2521 (e.g., a biometric sensor, an IMU, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 2663), a touch sensor, a sweat sensor, etc.). In some embodiments, watch body 2520 can include one or more haptic devices 2676 (e.g., a vibratory haptic actuator) that is configured to provide haptic feedback (e.g., a cutaneous and/or kinesthetic sensation, etc.) to the user. Sensors 2621 and/or haptic device 2676 can also be configured to operate in conjunction with multiple applications including, without limitation, health monitoring applications, social media applications, game applications, and artificial reality applications (e.g., the applications associated with artificial reality).

As described above, watch body 2520 and wearable band 2510, when coupled, can form wrist-wearable device 2500. When coupled, watch body 2520 and wearable band 2510 may operate as a single device to execute functions (operations, detections, communications, etc.) described herein. In some embodiments, each device may be provided with particular instructions for performing the one or more operations of wrist-wearable device 2500. For example, in accordance with a determination that watch body 2520 does not include neuromuscular signal sensors, wearable band 2510 can include alternative instructions for performing associated instructions (e.g., providing sensed neuromuscular signal data to watch body 2520 via a different electronic device). Operations of wrist-wearable device 2500 can be performed by watch body 2520 alone or in conjunction with wearable band 2510 (e.g., via respective processors and/or hardware components) and vice versa. In some embodiments, operations of wrist-wearable device 2500, watch body 2520, and/or wearable band 2510 can be performed in conjunction with one or more processors and/or hardware components.

As described below with reference to the block diagram of FIG. 26, wearable band 2510 and/or watch body 2520 can each include independent resources required to independently execute functions. For example, wearable band 2510 and/or watch body 2520 can each include a power source (e.g., a battery), a memory, data storage, a processor (e.g., a central processing unit (CPU)), communications, a light source, and/or input/output devices.

FIG. 26 shows block diagrams of a computing system 2630 corresponding to wearable band 2510 and a computing system 2660 corresponding to watch body 2520 according to some embodiments. Computing system 2600 of wrist-wearable device 2500 may include a combination of components of wearable band computing system 2630 and watch body computing system 2660, in accordance with some embodiments.

Watch body 2520 and/or wearable band 2510 can include one or more components shown in watch body computing system 2660. In some embodiments, a single integrated circuit may include all or a substantial portion of the components of watch body computing system 2660 included in a single integrated circuit. Alternatively, in some embodiments, components of the watch body computing system 2660 may be included in a plurality of integrated circuits that are communicatively coupled. In some embodiments, watch body computing system 2660 may be configured to couple (e.g., via a wired or wireless connection) with wearable band computing system 2630, which may allow the computing systems to share components, distribute tasks, and/or perform other operations described herein (individually or as a single device).

Watch body computing system 2660 can include one or more processors 2679, a controller 2647, a peripherals interface 2661, a power system, and memory (e.g., a memory 2680).

Power system can include a charger input 2696, a power-management integrated circuit (PMIC) 2697, and a battery 2698. In some embodiments, a watch body 2520 and a wearable band 2510 can have respective batteries (e.g., battery 2698 and 2659) and can share power with each other. Watch body 2520 and wearable band 2510 can receive a charge using a variety of techniques. In some embodiments, watch body 2520 and wearable band 2510 can use a wired charging assembly (e.g., power cords) to receive the charge. Alternatively, or in addition, watch body 2520 and/or wearable band 2510 can be configured for wireless charging. For example, a portable charging device can be designed to mate with a portion of watch body 2520 and/or wearable band 2510 and wirelessly deliver usable power to battery 2698 of watch body 2520 and/or battery 2659 of wearable band 2510. Watch body 2520 and wearable band 2510 can have independent power systems (e.g., power system) to enable each to operate independently. Watch body 2520 and wearable band 2510 can also share power (e.g., one can charge the other) via respective PMICs (e.g., PMICs 2697 and 2658) and charger inputs (e.g., 2657 and 2696) that can share power over power and ground conductors and/or over wireless charging antennas.

In some embodiments, peripherals interface 2661 can include one or more sensors 2621. Sensors 2621 can include one or more coupling sensors 2662 for detecting when watch body 2520 is coupled with another electronic device (e.g., a wearable band 2510). Sensors 2621 can include one or more imaging sensors 2663 (e.g., one or more of cameras 2625, and/or separate imaging sensors 2663 (e.g., thermal-imaging sensors)). In some embodiments, sensors 2621 can include one or more SpO2 sensors 2664. In some embodiments, sensors 2621 can include one or more biopotential-signal sensors (e.g., EMG sensors 2665, which may be disposed on an interior, user-facing portion of watch body 2520 and/or wearable band 2510). In some embodiments, sensors 2621 may include one or more capacitive sensors 2666. In some embodiments, sensors 2621 may include one or more heart rate sensors 2667. In some embodiments, sensors 2621 may include one or more IMU sensors 2668. In some embodiments, one or more IMU sensors 2668 can be configured to detect movement of a user's hand or other location where watch body 2520 is placed or held.

In some embodiments, one or more of sensors 2621 may provide an example human-machine interface. For example, a set of neuromuscular sensors, such as EMG sensors 2665, may be arranged circumferentially around wearable band 2510 with an interior surface of EMG sensors 2665 being configured to contact a user's skin. Any suitable number of neuromuscular sensors may be used (e.g., between 2 and 20 sensors). The number and arrangement of neuromuscular sensors may depend on the particular application for which the wearable device is used. For example, wearable band 2510 can be used to generate control information for controlling an augmented reality system, a robot, controlling a vehicle, scrolling through text, controlling a virtual avatar, or any other suitable control task.

In some embodiments, neuromuscular sensors may be coupled together using flexible electronics incorporated into the wireless device, and the output of one or more of the sensing components can be optionally processed using hardware signal processing circuitry (e.g., to perform amplification, filtering, and/or rectification). In other embodiments, at least some signal processing of the output of the sensing components can be performed in software such as processors 2679. Thus, signal processing of signals sampled by the sensors can be performed in hardware, software, or by any suitable combination of hardware and software, as aspects of the technology described herein are not limited in this respect.

Neuromuscular signals may be processed in a variety of ways. For example, the output of EMG sensors 2665 may be provided to an analog front end, which may be configured to perform analog processing (e.g., amplification, noise reduction, filtering, etc.) on the recorded signals. The processed analog signals may then be provided to an analog-to-digital converter, which may convert the analog signals to digital signals that can be processed by one or more computer processors. Furthermore, although this example is as discussed in the context of interfaces with EMG sensors, the embodiments described herein can also be implemented in wearable interfaces with other types of sensors including, but not limited to, mechanomyography (MMG) sensors, sonomyography (SMG) sensors, and electrical impedance tomography (EIT) sensors.

In some embodiments, peripherals interface 2661 includes a near-field communication (NFC) component 2669, a global-position system (GPS) component 2670, a long-term evolution (LTE) component 2671, and/or a Wi-Fi and/or Bluetooth communication component 2672. In some embodiments, peripherals interface 2661 includes one or more buttons 2673 (e.g., peripheral buttons 2523 and 2527 in FIG. 25), which, when selected by a user, cause operation to be performed at watch body 2520. In some embodiments, the peripherals interface 2661 includes one or more indicators, such as a light emitting diode (LED), to provide a user with visual indicators (e.g., message received, low battery, active microphone and/or camera, etc.).

Watch body 2520 can include at least one display 2505 for displaying visual representations of information or data to a user, including user-interface elements and/or three-dimensional virtual objects. The display can also include a touch screen for inputting user inputs, such as touch gestures, swipe gestures, and the like. Watch body 2520 can include at least one speaker 2674 and at least one microphone 2675 for providing audio signals to the user and receiving audio input from the user. The user can provide user inputs through microphone 2675 and can also receive audio output from speaker 2674 as part of a haptic event provided by haptic controller 2678. Watch body 2520 can include at least one camera 2625, including a front camera 2625a and a rear camera 2625b. Cameras 2625 can include ultra-wide-angle cameras, wide angle cameras, fish-eye cameras, spherical cameras, telephoto cameras, depth-sensing cameras, or other types of cameras.

Watch body computing system 2660 can include one or more haptic controllers 2678 and associated componentry (e.g., haptic devices 2676) for providing haptic events at watch body 2520 (e.g., a vibrating sensation or audio output in response to an event at the watch body 2520). Haptic controllers 2678 can communicate with one or more haptic devices 2676, such as electroacoustic devices, including a speaker of the one or more speakers 2674 and/or other audio components and/or electromechanical devices that convert energy into linear motion such as a motor, solenoid, electroactive polymer, piezoelectric actuator, electrostatic actuator, or other tactile output generating components (e.g., a component that converts electrical signals into tactile outputs on the device). Haptic controller 2678 can provide haptic events to that are capable of being sensed by a user of watch body 2520. In some embodiments, one or more haptic controllers 2678 can receive input signals from an application of applications 2682.

In some embodiments, wearable band computing system 2630 and/or watch body computing system 2660 can include memory 2680, which can be controlled by one or more memory controllers of controllers 2647. In some embodiments, software components stored in memory 2680 include one or more applications 2682 configured to perform operations at the watch body 2520. In some embodiments, one or more applications 2682 may include games, word processors, messaging applications, calling applications, web browsers, social media applications, media streaming applications, financial applications, calendars, clocks, etc. In some embodiments, software components stored in memory 2680 include one or more communication interface modules 2683 as defined above. In some embodiments, software components stored in memory 2680 include one or more graphics modules 2684 for rendering, encoding, and/or decoding audio and/or visual data and one or more data management modules 2685 for collecting, organizing, and/or providing access to data 2687 stored in memory 2680. In some embodiments, one or more of applications 2682 and/or one or more modules can work in conjunction with one another to perform various tasks at the watch body 2520.

In some embodiments, software components stored in memory 2680 can include one or more operating systems 2681 (e.g., a Linux-based operating system, an Android operating system, etc.). Memory 2680 can also include data 2687. Data 2687 can include profile data 2688A, sensor data 2689A, media content data 2690, and application data 2691.

It should be appreciated that watch body computing system 2660 is an example of a computing system within watch body 2520, and that watch body 2520 can have more or fewer components than shown in watch body computing system 2660, can combine two or more components, and/or can have a different configuration and/or arrangement of the components. The various components shown in watch body computing system 2660 are implemented in hardware, software, firmware, or a combination thereof, including one or more signal processing and/or application-specific integrated circuits.

Turning to the wearable band computing system 2630, one or more components that can be included in wearable band 2510 are shown. Wearable band computing system 2630 can include more or fewer components than shown in watch body computing system 2660, can combine two or more components, and/or can have a different configuration and/or arrangement of some or all of the components. In some embodiments, all, or a substantial portion of the components of wearable band computing system 2630 are included in a single integrated circuit. Alternatively, in some embodiments, components of wearable band computing system 2630 are included in a plurality of integrated circuits that are communicatively coupled. As described above, in some embodiments, wearable band computing system 2630 is configured to couple (e.g., via a wired or wireless connection) with watch body computing system 2660, which allows the computing systems to share components, distribute tasks, and/or perform other operations described herein (individually or as a single device).

Wearable band computing system 2630, similar to watch body computing system 2660, can include one or more processors 2649, one or more controllers 2647 (including one or more haptics controllers 2648), a peripherals interface 2631 that can includes one or more sensors 2613 and other peripheral devices, a power source (e.g., a power system), and memory (e.g., a memory 2650) that includes an operating system (e.g., an operating system 2651), data (e.g., data 2654 including profile data 2688B, sensor data 2689B, etc.), and one or more modules (e.g., a communications interface module 2652, a data management module 2653, etc.).

One or more of sensors 2613 can be analogous to sensors 2621 of watch body computing system 2660. For example, sensors 2613 can include one or more coupling sensors 2632, one or more SpO2 sensors 2634, one or more EMG sensors 2635, one or more capacitive sensors 2636, one or more heart rate sensors 2637, and one or more IMU sensors 2638.

Peripherals interface 2631 can also include other components analogous to those included in peripherals interface 2661 of watch body computing system 2660, including an NFC component 2639, a GPS component 2640, an LTE component 2641, a Wi-Fi and/or Bluetooth communication component 2642, and/or one or more haptic devices 2646 as described above in reference to peripherals interface 2661. In some embodiments, peripherals interface 2631 includes one or more buttons 2643, a display 2633, a speaker 2644, a microphone 2645, and a camera 2655. In some embodiments, peripherals interface 2631 includes one or more indicators, such as an LED.

It should be appreciated that wearable band computing system 2630 is an example of a computing system within wearable band 2510, and that wearable band 2510 can have more or fewer components than shown in wearable band computing system 2630, combine two or more components, and/or have a different configuration and/or arrangement of the components. The various components shown in wearable band computing system 2630 can be implemented in one or more of a combination of hardware, software, or firmware, including one or more signal processing and/or application-specific integrated circuits.

Wrist-wearable device 2500 with respect to FIG. 25 is an example of wearable band 2510 and watch body 2520 coupled together, so wrist-wearable device 2500 will be understood to include the components shown and described for wearable band computing system 2630 and watch body computing system 2660. In some embodiments, wrist-wearable device 2500 has a split architecture (e.g., a split mechanical architecture, a split electrical architecture, etc.) between watch body 2520 and wearable band 2510. In other words, all of the components shown in wearable band computing system 2630 and watch body computing system 2660 can be housed or otherwise disposed in a combined wrist-wearable device 2500 or within individual components of watch body 2520, wearable band 2510, and/or portions thereof (e.g., a coupling mechanism 2516 of wearable band 2510).

The techniques described above can be used with any device for sensing neuromuscular signals but could also be used with other types of wearable devices for sensing neuromuscular signals (such as body-wearable or head-wearable devices that might have neuromuscular sensors closer to the brain or spinal column).

In some embodiments, wrist-wearable device 2500 can be used in conjunction with a head-wearable device (e.g., AR glasses 2700 and VR system 2800) and/or an HIPD 3000 described below, and wrist-wearable device 2500 can also be configured to be used to allow a user to control any aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable devices, attention will now be turned to example head-wearable devices, such AR glasses 2700 and VR headset 2800.

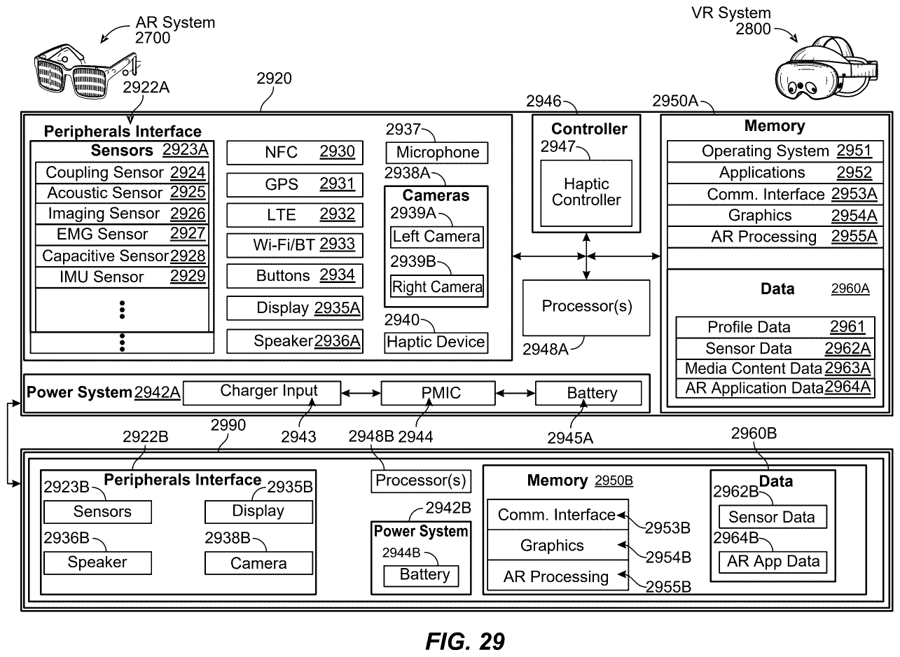

FIGS. 27 to 29 show example artificial-reality systems, which can be used as or in connection with wrist-wearable device 2500. In some embodiments, AR system 2700 includes an eyewear device 2702, as shown in FIG. 27. In some embodiments, VR system 2800 includes a head-mounted display (HMD) 2812, as shown in FIGS. 28A and 28B. In some embodiments, AR system 2700 and VR system 2800 can include one or more analogous components (e.g., components for presenting interactive artificial-reality environments, such as processors, memory, and/or presentation devices, including one or more displays and/or one or more waveguides), some of which are described in more detail with respect to FIG. 29. As described herein, a head-wearable device can include components of eyewear device 2702 and/or head-mounted display 2812. Some embodiments of head-wearable devices do not include any displays, including any of the displays described with respect to AR system 2700 and/or VR system 2800. While the example artificial-reality systems are respectively described herein as AR system 2700 and VR system 2800, either or both of the example AR systems described herein can be configured to present fully-immersive virtual-reality scenes presented in substantially all of a user's field of view or subtler augmented-reality scenes that are presented within a portion, less than all, of the user's field of view.

FIG. 27 show an example visual depiction of AR system 2700, including an eyewear device 2702 (which may also be described herein as augmented-reality glasses, and/or smart glasses). AR system 2700 can include additional electronic components that are not shown in FIG. 27, such as a wearable accessory device and/or an intermediary processing device, in electronic communication or otherwise configured to be used in conjunction with the eyewear device 2702. In some embodiments, the wearable accessory device and/or the intermediary processing device may be configured to couple with eyewear device 2702 via a coupling mechanism in electronic communication with a coupling sensor 2924 (FIG. 29), where coupling sensor 2924 can detect when an electronic device becomes physically or electronically coupled with eyewear device 2702. In some embodiments, eyewear device 2702 can be configured to couple to a housing 2990 (FIG. 29), which may include one or more additional coupling mechanisms configured to couple with additional accessory devices. The components shown in FIG. 27 can be implemented in hardware, software, firmware, or a combination thereof, including one or more signal-processing components and/or application-specific integrated circuits (ASICs).

Eyewear device 2702 includes mechanical glasses components, including a frame 2704 configured to hold one or more lenses (e.g., one or both lenses 2706-1 and 2706-2). One of ordinary skill in the art will appreciate that eyewear device 2702 can include additional mechanical components, such as hinges configured to allow portions of frame 2704 of eyewear device 2702 to be folded and unfolded, a bridge configured to span the gap between lenses 2706-1 and 2706-2 and rest on the user's nose, nose pads configured to rest on the bridge of the nose and provide support for eyewear device 2702, earpieces configured to rest on the user's ears and provide additional support for eyewear device 2702, temple arms configured to extend from the hinges to the earpieces of eyewear device 2702, and the like. One of ordinary skill in the art will further appreciate that some examples of AR system 2700 can include none of the mechanical components described herein. For example, smart contact lenses configured to present artificial reality to users may not include any components of eyewear device 2702.

Eyewear device 2702 includes electronic components, many of which will be described in more detail below with respect to FIG. 10. Some example electronic components are illustrated in FIG. 27, including acoustic sensors 2725-1, 2725-2, 2725-3, 2725-4, 2725-5, and 2725-6, which can be distributed along a substantial portion of the frame 2704 of eyewear device 2702. Eyewear device 2702 also includes a left camera 2739A and a right camera 2739B, which are located on different sides of the frame 2704. Eyewear device 2702 also includes a processor 2748 (or any other suitable type or form of integrated circuit) that is embedded into a portion of the frame 2704.

FIGS. 28A and 28B show a VR system 2800 that includes a head-mounted display (HMD) 2812 (e.g., also referred to herein as an artificial-reality headset, a head-wearable device, a VR headset, etc.), in accordance with some embodiments. As noted, some artificial-reality systems (e.g., AR system 2700) may, instead of blending an artificial reality with actual reality, substantially replace one or more of a user's visual and/or other sensory perceptions of the real world with a virtual experience (e.g., AR systems 2300 and 2400).

HMD 2812 includes a front body 2814 and a frame 2816 (e.g., a strap or band) shaped to fit around a user's head. In some embodiments, front body 2814 and/or frame 2816 include one or more electronic elements for facilitating presentation of and/or interactions with an AR and/or VR system (e.g., displays, IMUs, tracking emitter or detectors). In some embodiments, HMD 2812 includes output audio transducers (e.g., an audio transducer 2818), as shown in FIG. 28B. In some embodiments, one or more components, such as the output audio transducer(s) 2818 and frame 2816, can be configured to attach and detach (e.g., are detachably attachable) to HMD 2812 (e.g., a portion or all of frame 2816, and/or audio transducer 2818), as shown in FIG. 28B. In some embodiments, coupling a detachable component to HMD 2812 causes the detachable component to come into electronic communication with HMD 2812.

FIGS. 28A and 28B also show that VR system 2800 includes one or more cameras, such as left camera 2839A and right camera 2839B, which can be analogous to left and right cameras 2739A and 2739B on frame 2704 of eyewear device 2702. In some embodiments, VR system 2800 includes one or more additional cameras (e.g., cameras 2839C and 2839D), which can be configured to augment image data obtained by left and right cameras 2839A and 2839B by providing more information. For example, camera 2839C can be used to supply color information that is not discerned by cameras 2839A and 2839B. In some embodiments, one or more of cameras 2839A to 2839D can include an optional IR cut filter configured to remove IR light from being received at the respective camera sensors.

FIG. 29 illustrates a computing system 2920 and an optional housing 2990, each of which show components that can be included in AR system 2700 and/or VR system 2800. In some embodiments, more or fewer components can be included in optional housing 2990 depending on practical restraints of the respective AR system being described.

In some embodiments, computing system 2920 can include one or more peripherals interfaces 2922A and/or optional housing 2990 can include one or more peripherals interfaces 2922B. Each of computing system 2920 and optional housing 2990 can also include one or more power systems 2942A and 2942B, one or more controllers 2946 (including one or more haptic controllers 2947), one or more processors 2948A and 2948B (as defined above, including any of the examples provided), and memory 2950A and 2950B, which can all be in electronic communication with each other. For example, the one or more processors 2948A and 2948B can be configured to execute instructions stored in memory 2950A and 2950B, which can cause a controller of one or more of controllers 2946 to cause operations to be performed at one or more peripheral devices connected to peripherals interface 2922A and/or 2922B. In some embodiments, each operation described can be powered by electrical power provided by power system 2942A and/or 2942B.

In some embodiments, peripherals interface 2922A can include one or more devices configured to be part of computing system 2920, some of which have been defined above and/or described with respect to the wrist-wearable devices shown in FIGS. 25 and 26. For example, peripherals interface 2922A can include one or more sensors 2923A. Some example sensors 2923A include one or more coupling sensors 2924, one or more acoustic sensors 2925, one or more imaging sensors 2926, one or more EMG sensors 2927, one or more capacitive sensors 2928, one or more IMU sensors 2929, and/or any other types of sensors explained above or described with respect to any other embodiments discussed herein.

In some embodiments, peripherals interfaces 2922A and 2922B can include one or more additional peripheral devices, including one or more NFC devices 2930, one or more GPS devices 2931, one or more LTE devices 2932, one or more Wi-Fi and/or Bluetooth devices 2933, one or more buttons 2934 (e.g., including buttons that are slidable or otherwise adjustable), one or more displays 2935A and 2935B, one or more speakers 2936A and 2936B, one or more microphones 2937, one or more cameras 2938A and 2938B (e.g., including the left camera 2939A and/or a right camera 2939B), one or more haptic devices 2940, and/or any other types of peripheral devices defined above or described with respect to any other embodiments discussed herein.

AR systems can include a variety of types of visual feedback mechanisms (e.g., presentation devices). For example, display devices in AR system 2700 and/or VR system 2800 can include one or more liquid-crystal displays (LCDs), light emitting diode (LED) displays, organic LED (OLED) displays, and/or any other suitable types of display screens. Artificial-reality systems can include a single display screen (e.g., configured to be seen by both eyes), and/or can provide separate display screens for each eye, which can allow for additional flexibility for varifocal adjustments and/or for correcting a refractive error associated with a user's vision. Some embodiments of AR systems also include optical subsystems having one or more lenses (e.g., conventional concave or convex lenses, Fresnel lenses, or adjustable liquid lenses) through which a user can view a display screen.

For example, respective displays 2935A and 2935B can be coupled to each of the lenses 2706-1 and 2706-2 of AR system 2700. Displays 2935A and 2935B may be coupled to each of lenses 2706-1 and 2706-2, which can act together or independently to present an image or series of images to a user. In some embodiments, AR system 2700 includes a single display 2935A or 2935B (e.g., a near-eye display) or more than two displays 2935A and 2935B. In some embodiments, a first set of one or more displays 2935A and 2935B can be used to present an augmented-reality environment, and a second set of one or more display devices 2935A and 2935B can be used to present a virtual-reality environment. In some embodiments, one or more waveguides are used in conjunction with presenting artificial-reality content to the user of AR system 2700 (e.g., as a means of delivering light from one or more displays 2935A and 2935B to the user's eyes). In some embodiments, one or more waveguides are fully or partially integrated into the eyewear device 2702. Additionally, or alternatively to display screens, some artificial-reality systems include one or more projection systems. For example, display devices in AR system 2700 and/or VR system 2800 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. Artificial-reality systems can also be configured with any other suitable type or form of image projection system. In some embodiments, one or more waveguides are provided additionally or alternatively to the one or more display(s) 2935A and 2935B.

Computing system 2920 and/or optional housing 2990 of AR system 2700 or VR system 2800 can include some or all of the components of a power system 2942A and 2942B. Power systems 2942A and 2942B can include one or more charger inputs 2943, one or more PMICs 2944, and/or one or more batteries 2945A and 2944B.

Memory 2950A and 2950B may include instructions and data, some or all of which may be stored as non-transitory computer-readable storage media within the memories 2950A and 2950B. For example, memory 2950A and 2950B can include one or more operating systems 2951, one or more applications 2952, one or more communication interface applications 2953A and 2953B, one or more graphics applications 2954A and 2954B, one or more AR processing applications 2955A and 2955B, and/or any other types of data defined above or described with respect to any other embodiments discussed herein.

Memory 2950A and 2950B also include data 2960A and 2960B, which can be used in conjunction with one or more of the applications discussed above. Data 2960A and 2960B can include profile data 2961, sensor data 2962A and 2962B, media content data 2963A, AR application data 2964A and 2964B, and/or any other types of data defined above or described with respect to any other embodiments discussed herein.

In some embodiments, controller 2946 of eyewear device 2702 may process information generated by sensors 2923A and/or 2923B on eyewear device 2702 and/or another electronic device within AR system 2700. For example, controller 2946 can process information from acoustic sensors 2725-1 and 2725-2. For each detected sound, controller 2946 can perform a direction of arrival (DOA) estimation to estimate a direction from which the detected sound arrived at eyewear device 2702 of AR system 2700. As one or more of acoustic sensors 2925 (e.g., the acoustic sensors 2725-1, 2725-2) detects sounds, controller 2946 can populate an audio data set with the information (e.g., represented in FIG. 10 as sensor data 2962A and 2962B).

In some embodiments, a physical electronic connector can convey information between eyewear device 2702 and another electronic device and/or between one or more processors 2748, 2948A, 2948B of AR system 2700 or VR system 2800 and controller 2946. The information can be in the form of optical data, electrical data, wireless data, or any other transmittable data form. Moving the processing of information generated by eyewear device 2702 to an intermediary processing device can reduce weight and heat in the eyewear device, making it more comfortable and safer for a user. In some embodiments, an optional wearable accessory device (e.g., an electronic neckband) is coupled to eyewear device 2702 via one or more connectors. The connectors can be wired or wireless connectors and can include electrical and/or non-electrical (e.g., structural) components. In some embodiments, eyewear device 2702 and the wearable accessory device can operate independently without any wired or wireless connection between them.

In some situations, pairing external devices, such as an intermediary processing device (e.g., HIPD 2106, 2206, 2306) with eyewear device 2702 (e.g., as part of AR system 2700) enables eyewear device 2702 to achieve a similar form factor of a pair of glasses while still providing sufficient battery and computation power for expanded capabilities. Some, or all, of the battery power, computational resources, and/or additional features of AR system 2700 can be provided by a paired device or shared between a paired device and eyewear device 2702, thus reducing the weight, heat profile, and form factor of eyewear device 2702 overall while allowing eyewear device 2702 to retain its desired functionality. For example, the wearable accessory device can allow components that would otherwise be included on eyewear device 2702 to be included in the wearable accessory device and/or intermediary processing device, thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on eyewear device 2702 standing alone. Because weight carried in the wearable accessory device can be less invasive to a user than weight carried in the eyewear device 2702, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user's day-to-day activities.

AR systems can include various types of computer vision components and subsystems. For example, AR system 2700 and/or VR system 2800 can include one or more optical sensors such as two-dimensional (2D) or three-dimensional (3D) cameras, time-of-flight depth sensors, structured light transmitters and detectors, single-beam or sweeping laser rangefinders, 3D LiDAR sensors, and/or any other suitable type or form of optical sensor. An AR system can process data from one or more of these sensors to identify a location of a user and/or aspects of the use's real-world physical surroundings, including the locations of real-world objects within the real-world physical surroundings. In some embodiments, the methods described herein are used to map the real world, to provide a user with context about real-world surroundings, and/or to generate digital twins (e.g., interactable virtual objects), among a variety of other functions. For example, FIGS. 28A and 28B show VR system 2800 having cameras 2839A to 2839D, which can be used to provide depth information for creating a voxel field and a two-dimensional mesh to provide object information to the user to avoid collisions.

In some embodiments, AR system 2700 and/or VR system 2800 can include haptic (tactile) feedback systems, which may be incorporated into headwear, gloves, body suits, handheld controllers, environmental devices (e.g., chairs or floormats), and/or any other type of device or system, such as the wearable devices discussed herein. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback may be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices.

In some embodiments of an artificial reality system, such as AR system 2700 and/or VR system 2800, ambient light (e.g., a live feed of the surrounding environment that a user would normally see) can be passed through a display element of a respective head-wearable device presenting aspects of the AR system. In some embodiments, ambient light can be passed through a portion less that is less than all of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable device, and an amount of ambient light (e.g., 15-50% of the ambient light) can be passed through the user interface element such that the user can distinguish at least a portion of the physical environment over which the user interface element is being displayed.

FIGS. 30A and 30B illustrate an example handheld intermediary processing device (HIPD) 3000 in accordance with some embodiments. HIPD 3000 is an instance of the intermediary device described herein, such that HIPD 3000 should be understood to have the features described with respect to any intermediary device defined above or otherwise described herein and vice versa. FIG. 30A shows a top view and FIG. 30B shows a side view of the HIPD 3000. HIPD 3000 is configured to communicatively couple with one or more wearable devices (or other electronic devices) associated with a user. For example, HIPD 3000 is configured to communicatively couple with a user's wrist-wearable device 2102, 2202 (or components thereof, such as watch body 2520 and wearable band 2510), AR glasses 2700, and/or VR headset 2350 and 2800. HIPD 3000 can be configured to be held by a user (e.g., as a handheld controller), carried on the user's person (e.g., in their pocket, in their bag, etc.), placed in proximity of the user (e.g., placed on their desk while seated at their desk, on a charging dock, etc.), and/or placed at or within a predetermined distance from a wearable device or other electronic device (e.g., where, in some embodiments, the predetermined distance is the maximum distance (e.g., 10 meters) at which HIPD 3000 can successfully be communicatively coupled with an electronic device, such as a wearable device).

HIPD 3000 can perform various functions independently and/or in conjunction with one or more wearable devices (e.g., wrist-wearable device 2102, AR glasses 2700, VR system 2800, etc.). HIPD 3000 can be configured to increase and/or improve the functionality of communicatively coupled devices, such as the wearable devices. HIPD 3000 can be configured to perform one or more functions or operations associated with interacting with user interfaces and applications of communicatively coupled devices, interacting with an AR environment, interacting with VR environment, and/or operating as a human-machine interface controller, as well as functions and/or operations described above with reference to FIGS. 21-23B. Additionally, as will be described in more detail below, functionality and/or operations of HIPD 3000 can include, without limitation, task offloading and/or handoffs; thermals offloading and/or handoffs; six degrees of freedom (6DoF) raycasting and/or gaming (e.g., using imaging devices or cameras 3014A, 3014B, which can be used for simultaneous localization and mapping (SLAM) and/or with other image processing techniques), portable charging, messaging, image capturing via one or more imaging devices or cameras 3022A and 3022B, sensing user input (e.g., sensing a touch on a touch input surface 3002), wireless communications and/or interlining (e.g., cellular, near field, Wi-Fi, personal area network, etc.), location determination, financial transactions, providing haptic feedback, alarms, notifications, biometric authentication, health monitoring, sleep monitoring, etc. The above-described example functions can be executed independently in HIPD 3000 and/or in communication between HIPD 3000 and another wearable device described herein. In some embodiments, functions can be executed on HIPD 3000 in conjunction with an AR environment. As the skilled artisan will appreciate upon reading the descriptions provided herein that HIPD 3000 can be used with any type of suitable AR environment.

While HIPD 3000 is communicatively coupled with a wearable device and/or other electronic device, HIPD 3000 is configured to perform one or more operations initiated at the wearable device and/or the other electronic device. In particular, one or more operations of the wearable device and/or the other electronic device can be offloaded to HIPD 3000 to be performed. HIPD 3000 performs the one or more operations of the wearable device and/or the other electronic device and provides to data corresponded to the completed operations to the wearable device and/or the other electronic device. For example, a user can initiate a video stream using AR glasses 2700 and back-end tasks associated with performing the video stream (e.g., video rendering) can be offloaded to HIPD 3000, which HIPD 3000 performs and provides corresponding data to AR glasses 2700 to perform remaining front-end tasks associated with the video stream (e.g., presenting the rendered video data via a display of AR glasses 2700). In this way, HIPD 3000, which has more computational resources and greater thermal headroom than a wearable device, can perform computationally intensive tasks for the wearable device, thereby improving performance of an operation performed by the wearable device.

HIPD 3000 includes a multi-touch input surface 3002 on a first side (e.g., a front surface) that is configured to detect one or more user inputs. In particular, multi-touch input surface 3002 can detect single tap inputs, multi-tap inputs, swipe gestures and/or inputs, force-based and/or pressure-based touch inputs, held taps, and the like. Multi-touch input surface 3002 is configured to detect capacitive touch inputs and/or force (and/or pressure) touch inputs. Multi-touch input surface 3002 includes a first touch-input surface 3004 defined by a surface depression and a second touch-input surface 3006 defined by a substantially planar portion. First touch-input surface 3004 can be disposed adjacent to second touch-input surface 3006. In some embodiments, first touch-input surface 3004 and second touch-input surface 3006 can be different dimensions and/or shapes. For example, first touch-input surface 3004 can be substantially circular and second touch-input surface 3006 can be substantially rectangular. In some embodiments, the surface depression of multi-touch input surface 3002 is configured to guide user handling of HIPD 3000. In particular, the surface depression can be configured such that the user holds HIPD 3000 upright when held in a single hand (e.g., such that the using imaging devices or cameras 3014A and 3014B are pointed toward a ceiling or the sky). Additionally, the surface depression is configured such that the user's thumb rests within first touch-input surface 3004.

In some embodiments, the different touch-input surfaces include a plurality of touch-input zones. For example, second touch-input surface 3006 includes at least a second touch-input zone 3008 within a first touch-input zone 3007 and a third touch-input zone 3010 within second touch-input zone 3008. In some embodiments, one or more of touch-input zones 3008 and 3010 are optional and/or user defined (e.g., a user can specific a touch-input zone based on their preferences). In some embodiments, each touch-input surface 3004 and 3006 and/or touch-input zone 3008 and 3010 are associated with a predetermined set of commands. For example, a user input detected within first touch-input zone 3008 may cause HIPD 3000 to perform a first command and a user input detected within second touch-input surface 3006 may cause HIPD 3000 to perform a second command, distinct from the first. In some embodiments, different touch-input surfaces and/or touch-input zones are configured to detect one or more types of user inputs. The different touch-input surfaces and/or touch-input zones can be configured to detect the same or distinct types of user inputs. For example, first touch-input zone 3008 can be configured to detect force touch inputs (e.g., a magnitude at which the user presses down) and capacitive touch inputs, and second touch-input zone 3010 can be configured to detect capacitive touch inputs.

As shown in FIG. 31, HIPD 3000 includes one or more sensors 3151 for sensing data used in the performance of one or more operations and/or functions. For example, HIPD 3000 can include an IMU sensor that is used in conjunction with cameras 3014A, 3014B (FIGS. 30A-30B) for 3-dimensional object manipulation (e.g., enlarging, moving, destroying, etc., an object) in an AR or VR environment. Non-limiting examples of sensors 3151 included in HIPD 3000 include a light sensor, a magnetometer, a depth sensor, a pressure sensor, and a force sensor.

HIPD 3000 can include one or more light indicators 3012 to provide one or more notifications to the user. In some embodiments, light indicators 3012 are LEDs or other types of illumination devices. Light indicators 3012 can operate as a privacy light to notify the user and/or others near the user that an imaging device and/or microphone are active. In some embodiments, a light indicator is positioned adjacent to one or more touch-input surfaces. For example, a light indicator can be positioned around first touch-input surface 3004. Light indicators 3012 can be illuminated in different colors and/or patterns to provide the user with one or more notifications and/or information about the device. For example, a light indicator positioned around first touch-input surface 3004 may flash when the user receives a notification (e.g., a message), change red when HIPD 3000 is out of power, operate as a progress bar (e.g., a light ring that is closed when a task is completed (e.g., 0% to 100%)), operate as a volume indicator, etc.

In some embodiments, HIPD 3000 includes one or more additional sensors on another surface. For example, as shown FIG. 30A, HIPD 3000 includes a set of one or more sensors (e.g., sensor set 3020) on an edge of HIPD 3000. Sensor set 3020, when positioned on an edge of the of HIPD 3000, can be pe positioned at a predetermined tilt angle (e.g., 26 degrees), which allows sensor set 3020 to be angled toward the user when placed on a desk or other flat surface. Alternatively, in some embodiments, sensor set 3020 is positioned on a surface opposite the multi-touch input surface 3002 (e.g., a back surface). The one or more sensors of sensor set 3020 are discussed in further detail below.

The side view of the of HIPD 3000 in FIG. 30B shows sensor set 3020 and camera 3014B. Sensor set 3020 can include one or more cameras 3022A and 3022B, a depth projector 3024, an ambient light sensor 3028, and a depth receiver 3030. In some embodiments, sensor set 3020 includes a light indicator 3026. Light indicator 3026 can operate as a privacy indicator to let the user and/or those around them know that a camera and/or microphone is active. Sensor set 3020 is configured to capture a user's facial expression such that the user can puppet a custom avatar (e.g., showing emotions, such as smiles, laughter, etc., on the avatar or a digital representation of the user). Sensor set 3020 can be configured as a side stereo RGB system, a rear indirect Time-of-Flight (iToF) system, or a rear stereo RGB system. As the skilled artisan will appreciate upon reading the descriptions provided herein, HIPD 3000 described herein can use different sensor set 3020 configurations and/or sensor set 3020 placement.

Turning to FIG. 31, in some embodiments, a computing system 3140 of HIPD 3000 can include one or more haptic devices 3171 (e.g., a vibratory haptic actuator) that are configured to provide haptic feedback (e.g., kinesthetic sensation). Sensors 3151 and/or the haptic devices 3171 can be configured to operate in conjunction with multiple applications and/or communicatively coupled devices including, without limitation, a wearable devices, health monitoring applications, social media applications, game applications, and artificial reality applications (e.g., the applications associated with artificial reality).

In some embodiments, HIPD 3000 is configured to operate without a display. However, optionally, computing system 3140 of the HIPD 3000 can include a display 3168. HIPD 3000 can also include one or more optional peripheral buttons 3167. For example, peripheral buttons 3167 can be used to turn on or turn off HIPD 3000. Further, HIPD 3000 housing can be formed of polymers and/or elastomers. In other words, HIPD 3000 may be designed such that it would not easily slide off a surface. In some embodiments, HIPD 3000 includes one or magnets to couple HIPD 3000 to another surface. This allows the user to mount HIPD 3000 to different surfaces and provide the user with greater flexibility in use of HIPD 3000.

As described above, HIPD 3000 can distribute and/or provide instructions for performing the one or more tasks at HIPD 3000 and/or a communicatively coupled device. For example, HIPD 3000 can identify one or more back-end tasks to be performed by HIPD 3000 and one or more front-end tasks to be performed by a communicatively coupled device. While HIPD 3000 is configured to offload and/or handoff tasks of a communicatively coupled device, HIPD 3000 can perform both back-end and front-end tasks (e.g., via one or more processors, such as CPU 3177). HIPD 3000 can, without limitation, can be used to perform augmented calling (e.g., receiving and/or sending 3D or 2.5D live volumetric calls, live digital human representation calls, and/or avatar calls), discreet messaging, 6DoF portrait/landscape gaming, AR/VR object manipulation, AR/VR content display (e.g., presenting content via a virtual display), and/or other AR/VR interactions. HIPD 3000 can perform the above operations alone or in conjunction with a wearable device (or other communicatively coupled electronic device).

FIG. 31 shows a block diagram of a computing system 3140 of HIPD 3000 in accordance with some embodiments. HIPD 3000, described in detail above, can include one or more components shown in HIPD computing system 3140. HIPD 3000 will be understood to include the components shown and described below for HIPD computing system 3140. In some embodiments, all, or a substantial portion of the components of HIPD computing system 3140 are included in a single integrated circuit. Alternatively, in some embodiments, components of HIPD computing system 3140 are included in a plurality of integrated circuits that are communicatively coupled.

HIPD computing system 3140 can include a processor (e.g., a CPU 3177, a GPU, and/or a CPU with integrated graphics), a controller 3175, a peripherals interface 3150 that includes one or more sensors 3151 and other peripheral devices, a power source (e.g., a power system 3195), and memory (e.g., a memory 3178) that includes an operating system (e.g., an operating system 3179), data (e.g., data 3188), one or more applications (e.g., applications 3180), and one or more modules (e.g., a communications interface module 3181, a graphics module 3182, a task and processing management module 3183, an interoperability module 3184, an AR processing module 3185, a data management module 3186, etc.). HIPD computing system 3140 further includes a power system 3195 that includes a charger input and output 3196, a PMIC 3197, and a battery 3198, all of which are defined above.

In some embodiments, peripherals interface 3150 can include one or more sensors 3151. Sensors 3151 can include analogous sensors to those described above in reference to FIG. 25. For example, sensors 3151 can include imaging sensors 3154, (optional) EMG sensors 3156, IMU sensors 3158, and capacitive sensors 3160. In some embodiments, sensors 3151 can include one or more pressure sensors 3152 for sensing pressure data, an altimeter 3153 for sensing an altitude of the HIPD 3000, a magnetometer 3155 for sensing a magnetic field, a depth sensor 3157 (or a time-of flight sensor) for determining a difference between the camera and the subject of an image, a position sensor 3159 (e.g., a flexible position sensor) for sensing a relative displacement or position change of a portion of the HIPD 3000, a force sensor 3161 for sensing a force applied to a portion of the HIPD 3000, and a light sensor 3162 (e.g., an ambient light sensor) for detecting an amount of lighting. Sensors 3151 can include one or more sensors not shown in FIG. 31.

Analogous to the peripherals described above in reference to FIG. 25, peripherals interface 3150 can also include an NFC component 3163, a GPS component 3164, an LTE component 3165, a Wi-Fi and/or Bluetooth communication component 3166, a speaker 3169, a haptic device 3171, and a microphone 3173. As noted above, HIPD 3000 can optionally include a display 3168 and/or one or more peripheral buttons 3167. Peripherals interface 3150 can further include one or more cameras 3170, touch surfaces 3172, and/or one or more light emitters 3174. Multi-touch input surface 3002 described above in reference to FIGS. 30A and 30B is an example of touch surface 3172. Light emitters 3174 can be one or more LEDs, lasers, etc. and can be used to project or present information to a user. For example, light emitters 3174 can include light indicators 3012 and 3026 described above in reference to FIGS. 30A and 30B. Cameras 3170 (e.g., cameras 3014A, 3014B, 3022A, and 3022B described above in reference to FIGS. 30A and 30B) can include one or more wide angle cameras, fish-eye cameras, spherical cameras, compound eye cameras (e.g., stereo and multi cameras), depth cameras, RGB cameras, ToF cameras, RGB-D cameras (depth and ToF cameras), and/or other suitable cameras. Cameras 3170 can be used for SLAM, 6DoF ray casting, gaming, object manipulation and/or other rendering, facial recognition and facial expression recognition, etc.

Similar to watch body computing system 2660 and watch band computing system 2630 described above in reference to FIG. 26, HIPD computing system 3140 can include one or more haptic controllers 3176 and associated componentry (e.g., haptic devices 3171) for providing haptic events at HIPD 3000.

Memory 3178 can include high-speed random-access memory and/or non-volatile memory, such as one or more magnetic disk storage devices, flash memory devices, or other non-volatile solid-state memory devices. Access to memory 3178 by other components of HIPD 3000, such as the one or more processors and peripherals interface 3150, can be controlled by a memory controller of controllers 3175.

In some embodiments, software components stored in memory 3178 include one or more operating systems 3179, one or more applications 3180, one or more communication interface modules 3181, one or more graphics modules 3182, and/or one or more data management modules 3186, which are analogous to the software components described above in reference to FIG. 25.

In some embodiments, software components stored in memory 3178 include a task and processing management module 3183 for identifying one or more front-end and back-end tasks associated with an operation performed by the user, performing one or more front-end and/or back-end tasks, and/or providing instructions to one or more communicatively coupled devices that cause performance of the one or more front-end and/or back-end tasks. In some embodiments, task and processing management module 3183 uses data 3188 (e.g., device data 3190) to distribute the one or more front-end and/or back-end tasks based on communicatively coupled devices' computing resources, available power, thermal headroom, ongoing operations, and/or other factors. For example, task and processing management module 3183 can cause the performance of one or more back-end tasks (of an operation performed at communicatively coupled AR system 2700) at HIPD 3000 in accordance with a determination that the operation is utilizing a predetermined amount (e.g., at least 70%) of computing resources available at AR system 2700.

In some embodiments, software components stored in memory 3178 include an interoperability module 3184 for exchanging and utilizing information received and/or provided to distinct communicatively coupled devices. Interoperability module 3184 allows for different systems, devices, and/or applications to connect and communicate in a coordinated way without user input. In some embodiments, software components stored in memory 3178 include an AR processing module 3185 that is configured to process signals based at least on sensor data for use in an AR and/or VR environment. For example, AR processing module 3185 can be used for 3D object manipulation, gesture recognition, facial and facial expression recognition, etc.

Memory 3178 can also include data 3188. In some embodiments, data 3188 can include profile data 3189, device data 3190 (including device data of one or more devices communicatively coupled with HIPD 3000, such as device type, hardware, software, configurations, etc.), sensor data 3191, media content data 3192, and application data 3193.

It should be appreciated that HIPD computing system 3140 is an example of a computing system within HIPD 3000, and that HIPD 3000 can have more or fewer components than shown in HIPD computing system 3140, combine two or more components, and/or have a different configuration and/or arrangement of the components. The various components shown HIPD computing system 3140 are implemented in hardware, software, firmware, or a combination thereof, including one or more signal processing and/or application-specific integrated circuits.

The techniques described above in FIGS. 30A, 30B, and 31 can be used with any device used as a human-machine interface controller. In some embodiments, an HIPD 3000 can be used in conjunction with one or more wearable device such as a head-wearable device (e.g., AR system 2700 and VR system 2800) and/or a wrist-wearable device 2500 (or components thereof).

In some embodiments, the artificial reality devices and/or accessory devices disclosed herein may include haptic interfaces with transducers that provide haptic feedback and/or that collect haptic information about a user's interaction with an environment. The artificial-reality systems disclosed herein may include various types of haptic interfaces that detect or convey various types of haptic information, including tactile feedback (e.g., feedback that a user detects via nerves in the skin, which may also be referred to as cutaneous feedback) and/or kinesthetic feedback (e.g., feedback that a user detects via receptors located in muscles, joints, and/or tendons). In some examples, cutaneous feedback may include vibration, force, traction, texture, and/or temperature. Similarly, kinesthetic feedback, may include motion and compliance. Cutaneous and/or kinesthetic feedback may be provided using motors, piezoelectric actuators, fluidic systems, and/or a variety of other types of feedback mechanisms. Furthermore, haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The haptics assemblies disclosed herein may enable or enhance a user's artificial-reality experience in one or more of these contexts and environments and/or in other contexts and environments.

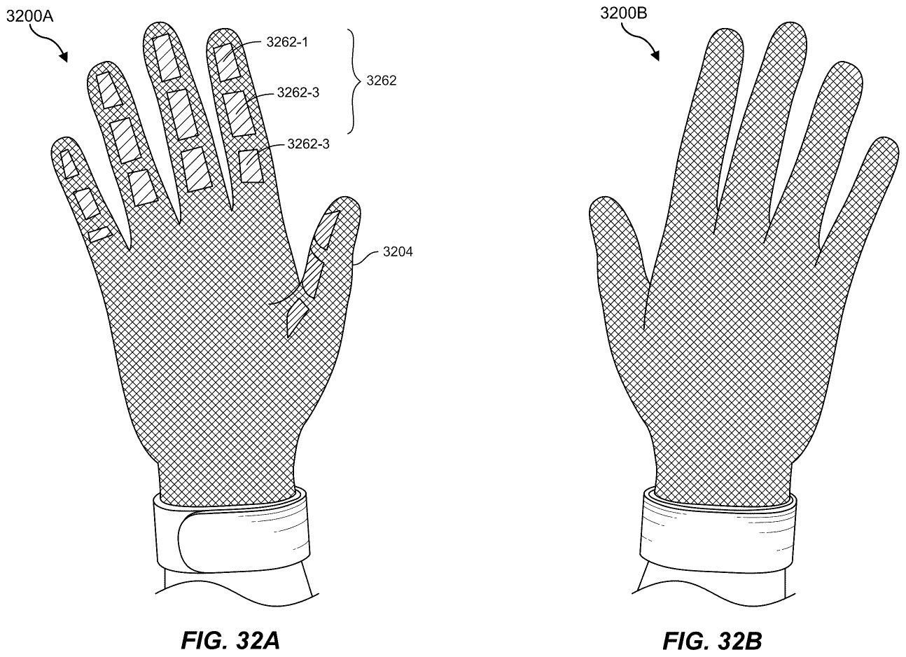

FIGS. 32A and 32B show example haptic feedback systems (e.g., hand-wearable devices) for providing feedback to a user regarding the user's interactions with a computing system (e.g., an artificial-reality environment presented by the AR system 2700 or the VR system 2800). In some embodiments, a computing system (e.g., the AR systems 2300 and/or 2400) may also provide feedback to one or more users based on an action that was performed within the computing system and/or an interaction provided by the AR system (e.g., which may be based on instructions that are executed in conjunction with performing operations of an application of the computing system). Such feedback may include visual and/or audio feedback and may also include haptic feedback provided by a haptic assembly, such as one or more haptic assemblies 3262 of haptic device 3200 (e.g., haptic assemblies 3262-1, 3262-2, 3262-3, etc.). For example, the haptic feedback may prevent (or, at a minimum, hinder/resist movement of) one or more fingers of a user from bending past a certain point to simulate the sensation of touching a solid coffee mug. In actuating such haptic effects, haptic device 3200 can change (either directly or indirectly) a pressurized state of one or more of haptic assemblies 3262.

Vibrotactile system 3200 may optionally include other subsystems and components, such as touch-sensitive pads, pressure sensors, motion sensors, position sensors, lighting elements, and/or user interface elements (e.g., an on/off button, a vibration control element, etc.). During use, haptic assemblies 3262 may be configured to be activated for a variety of different reasons, such as in response to the user's interaction with user interface elements, a signal from the motion or position sensors, a signal from the touch-sensitive pads, a signal from the pressure sensors, a signal from the other device or system, etc.

In FIGS. 32A and 32B, each of haptic assemblies 3262 may include a mechanism that, at a minimum, provides resistance when the respective haptic assembly 3262 is transitioned from a first pressurized state (e.g., atmospheric pressure or deflated) to a second pressurized state (e.g., inflated to a threshold pressure). Structures of haptic assemblies 3262 can be integrated into various devices configured to be in contact or proximity to a user's skin, including, but not limited to devices such as glove worn devices, body worn clothing device, headset devices.

As noted above, haptic assemblies 3262 described herein can be configured to transition between a first pressurized state and a second pressurized state to provide haptic feedback to the user. Due to the ever-changing nature of artificial-reality, haptic assemblies 3262 may be required to transition between the two states hundreds, or perhaps thousands of times, during a single use. Thus, haptic assemblies 3262 described herein are durable and designed to quickly transition from state to state. To provide some context, in the first pressurized state, haptic assemblies 3262 do not impede free movement of a portion of the wearer's body. For example, one or more haptic assemblies 3262 incorporated into a glove are made from flexible materials that do not impede free movement of the wearer's hand and fingers (e.g., an electrostatic-zipping actuator). Haptic assemblies 3262 may be configured to conform to a shape of the portion of the wearer's body when in the first pressurized state. However, once in the second pressurized state, haptic assemblies 3262 can be configured to restrict and/or impede free movement of the portion of the wearer's body (e.g., appendages of the user's hand). For example, the respective haptic assembly 3262 (or multiple respective haptic assemblies) can restrict movement of a wearer's finger (e.g., prevent the finger from curling or extending) when haptic assembly 3262 is in the second pressurized state. Moreover, once in the second pressurized state, haptic assemblies 3262 may take different shapes, with some haptic assemblies 3262 configured to take a planar, rigid shape (e.g., flat and rigid), while some other haptic assemblies 3262 are configured to curve or bend, at least partially.

As a non-limiting example, haptic device 3200 includes a plurality of haptic devices (e.g., a pair of haptic gloves, a haptics component of a wrist-wearable device (e.g., any of the wrist-wearable devices described with respect to FIGS. 21-25), etc.), each of which can include a garment component (e.g., a garment 3204) and one or more haptic assemblies coupled (e.g., physically coupled) to the garment component. For example, each of the haptic assemblies 3262-1, 3262-2, 3262-3, . . . 3262-N are physically coupled to the garment 3204 and are configured to contact respective phalanges of a user's thumb and fingers. As explained above, haptic assemblies 3262 are configured to provide haptic simulations to a wearer of device 3200. Garment 3204 of each device 3200 can be one of various articles of clothing (e.g., gloves, socks, shirts, pants, etc.). Thus, a user may wear multiple haptic devices 3200 that are each configured to provide haptic stimulations to respective parts of the body where haptic devices 3200 are being worn.

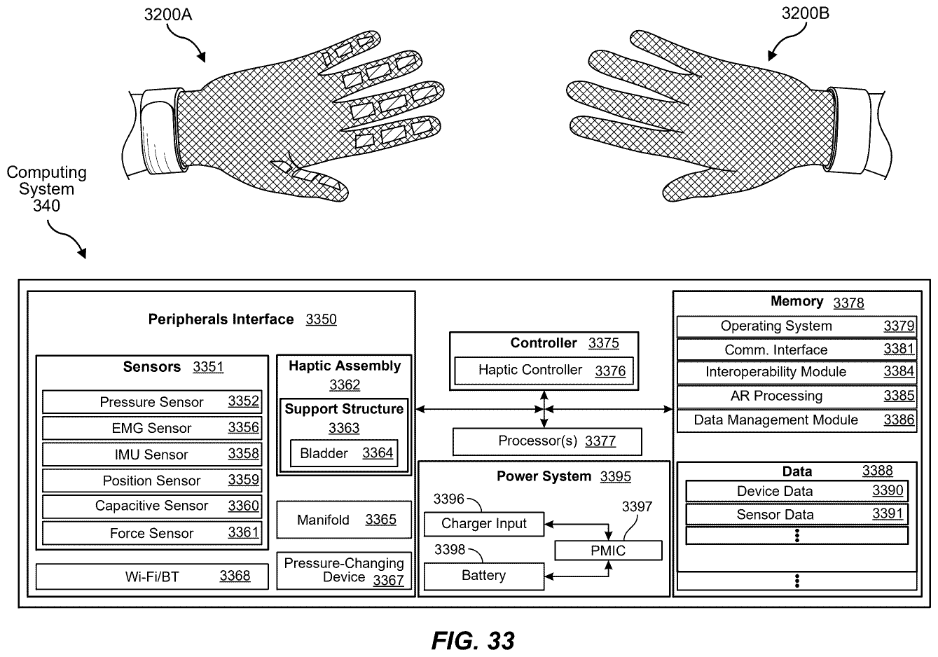

FIG. 33 shows block diagrams of a computing system 3340 of haptic device 3200, in accordance with some embodiments. Computing system 3340 can include one or more peripherals interfaces 3350, one or more power systems 3395, one or more controllers 3375 (including one or more haptic controllers 3376), one or more processors 3377 (as defined above, including any of the examples provided), and memory 3378, which can all be in electronic communication with each other. For example, one or more processors 3377 can be configured to execute instructions stored in the memory 3378, which can cause a controller of the one or more controllers 3375 to cause operations to be performed at one or more peripheral devices of peripherals interface 3350. In some embodiments, each operation described can occur based on electrical power provided by the power system 3395. The power system 3395 can include a charger input 3396, a PMIC 3397, and a battery 3398.

In some embodiments, peripherals interface 3350 can include one or more devices configured to be part of computing system 3340, many of which have been defined above and/or described with respect to wrist-wearable devices shown in FIGS. 25 and 26. For example, peripherals interface 3350 can include one or more sensors 3351. Some example sensors include: one or more pressure sensors 3352, one or more EMG sensors 3356, one or more IMU sensors 3358, one or more position sensors 3359, one or more capacitive sensors 3360, one or more force sensors 3361; and/or any other types of sensors defined above or described with respect to any other embodiments discussed herein.

In some embodiments, the peripherals interface can include one or more additional peripheral devices, including one or more Wi-Fi and/or Bluetooth devices 3368; one or more haptic assemblies 3362; one or more support structures 3363 (which can include one or more bladders 3364; one or more manifolds 3365; one or more pressure-changing devices 3367; and/or any other types of peripheral devices defined above or described with respect to any other embodiments discussed herein.

In some embodiments, each haptic assembly 3362 includes a support structure 3363 and at least one bladder 3364. Bladder 3364 (e.g., a membrane) may be a sealed, inflatable pocket made from a durable and puncture-resistant material, such as thermoplastic polyurethane (TPU), a flexible polymer, or the like. Bladder 3364 contains a medium (e.g., a fluid such as air, inert gas, or even a liquid) that can be added to or removed from bladder 3364 to change a pressure (e.g., fluid pressure) inside the bladder 3364. Support structure 3363 is made from a material that is stronger and stiffer than the material of bladder 3364. A respective support structure 3363 coupled to a respective bladder 3364 is configured to reinforce the respective bladder 3364 as the respective bladder 3364 changes shape and size due to changes in pressure (e.g., fluid pressure) inside the bladder.

The system 3340 also includes a haptic controller 3376 and a pressure-changing device 3367. In some embodiments, haptic controller 3376 is part of the computer system 3340 (e.g., in electronic communication with one or more processors 3377 of the computer system 3340). Haptic controller 3376 is configured to control operation of pressure-changing device 3367, and in turn operation of haptic device 3200. For example, haptic controller 3376 sends one or more signals to pressure-changing device 3367 to activate pressure-changing device 3367 (e.g., turn it on and off). The one or more signals may specify a desired pressure (e.g., pounds-per-square inch) to be output by pressure-changing device 3367. Generation of the one or more signals, and in turn the pressure output by pressure-changing device 3367, may be based on information collected by sensors 3351. For example, the one or more signals may cause pressure-changing device 3367 to increase the pressure (e.g., fluid pressure) inside a first haptic assembly 3362 at a first time, based on the information collected by sensors 3351 (e.g., the user makes contact with an artificial coffee mug or other artificial object). Then, the controller may send one or more additional signals to pressure-changing device 3367 that cause pressure-changing device 3367 to further increase the pressure inside first haptic assembly 3362 at a second time after the first time, based on additional information collected by sensors 3351. Further, the one or more signals may cause pressure-changing device 3367 to inflate one or more bladders 3364 in a first device 3200A, while one or more bladders 3364 in a second device 3200B remain unchanged. Additionally, the one or more signals may cause pressure-changing device 3367 to inflate one or more bladders 3364 in a first device 3200A to a first pressure and inflate one or more other bladders 3364 in first device 3200A to a second pressure different from the first pressure. Depending on number of devices 3200 serviced by pressure-changing device 3367, and the number of bladders therein, many different inflation configurations can be achieved through the one or more signals and the examples above are not meant to be limiting.

The system 3340 may include an optional manifold 3365 between pressure-changing device 3367 and haptic devices 3200. Manifold 3365 may include one or more valves (not shown) that pneumatically couple each of haptic assemblies 3362 with pressure-changing device 3367 via tubing. In some embodiments, manifold 3365 is in communication with controller 3375, and controller 3375 controls the one or more valves of manifold 3365 (e.g., the controller generates one or more control signals). Manifold 3365 is configured to switchably couple pressure-changing device 3367 with one or more haptic assemblies 3362 of the same or different haptic devices 3200 based on one or more control signals from controller 3375. In some embodiments, instead of using manifold 3365 to pneumatically couple pressure-changing device 3367 with haptic assemblies 3362, system 3340 may include multiple pressure-changing devices 3367, where each pressure-changing device 3367 is pneumatically coupled directly with a single haptic assembly 3362 or multiple haptic assemblies 3362. In some embodiments, pressure-changing device 3367 and optional manifold 3365 can be configured as part of one or more of the haptic devices 3200 while, in other embodiments, pressure-changing device 3367 and optional manifold 3365 can be configured as external to haptic device 3200. A single pressure-changing device 3367 may be shared by multiple haptic devices 3200.

In some embodiments, pressure-changing device 3367 is a pneumatic device, hydraulic device, a pneudraulic device, or some other device capable of adding and removing a medium (e.g., fluid, liquid, gas) from the one or more haptic assemblies 3362.

The devices shown in FIGS. 32A-33 may be coupled via a wired connection (e.g., via busing). Alternatively, one or more of the devices shown in FIGS. 32A-33 may be wirelessly connected (e.g., via short-range communication signals).

Memory 3378 includes instructions and data, some or all of which may be stored as non-transitory computer-readable storage media within memory 3378. For example, memory 3378 can include one or more operating systems 3379; one or more communication interface applications 3381; one or more interoperability modules 3384; one or more AR processing applications 3385; one or more data management modules 3386; and/or any other types of applications or modules defined above or described with respect to any other embodiments discussed herein.

Memory 3378 also includes data 3388 which can be used in conjunction with one or more of the applications discussed above. Data 3388 can include: device data 3390; sensor data 3391; and/or any other types of data defined above or described with respect to any other embodiments discussed herein.

In some examples, the augmented reality systems described herein may also include a microphone array with a plurality of acoustic transducers. Acoustic transducers may represent transducers that detect air pressure variations induced by sound waves. Each acoustic transducer may be configured to detect sound and convert the detected sound into an electronic format (e.g., an analog or digital format). A microphone array may include, for example, ten acoustic transducers that may be designed to be placed inside a corresponding ear of the user, acoustic transducers that may be positioned at various locations on an HMD frame a watch band, etc.

In some embodiments, one or more of acoustic transducers may be used as output transducers (e.g., speakers). For example, the artificial reality systems described herein may include acoustic transducers that are earbuds or any other suitable type of headphone or speaker.

The configuration of acoustic transducers of a microphone array may vary and may include any suitable number of transducers. In some embodiments, using higher numbers of acoustic transducers may increase the amount of audio information collected and/or the sensitivity and accuracy of the audio information. In contrast, using a lower number of acoustic transducers may decrease the computing power required by an associated controller to process the collected audio information. In addition, the position of each acoustic transducer of the microphone array may vary. For example, the position of an acoustic transducer may include a defined position on the user, a defined coordinate on a frame of an HMD, an orientation associated with each acoustic transducer, or some combination thereof.

Acoustic transducers and may be positioned on different parts of the user's ear, such as behind the pinna, behind the tragus, and/or within the auricle or fossa. Or, there may be additional acoustic transducers on or surrounding the ear in addition to acoustic transducers inside the ear canal. Having an acoustic transducer positioned next to an ear canal of a user may enable the microphone array to collect information on how sounds arrive at the ear canal. By positioning at least two of acoustic transducers on either side of a user's head (e.g., as binaural microphones), an artificial-reality device may simulate binaural hearing and capture a 3D stereo sound field around about a user's head. In some embodiments, acoustic transducers may be connected to artificial reality systems via a wired connection, and in other embodiments acoustic transducers may be connected to artificial-reality systems via a wireless connection (e.g., a BLUETOOTH connection).

Acoustic transducers may be positioned on HMDs frames in a variety of different ways, including along the length of the temples, across the bridge, above or below display devices, or some combination thereof. Acoustic transducers may also be oriented such that the microphone array is able to detect sounds in a wide range of directions surrounding the user wearing the augmented-reality system. In some embodiments, an optimization process may be performed during manufacturing of augmented-reality system to determine relative positioning of each acoustic transducer in the microphone array.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

Some augmented-reality systems may map a user's and/or device's environment using techniques referred to as “simultaneous location and mapping” (SLAM). SLAM mapping and location identifying techniques may involve a variety of hardware and software tools that can create or update a map of an environment while simultaneously keeping track of a user's location within the mapped environment. SLAM may use many different types of sensors to create a map and determine a user's position within the map.

SLAM techniques may, for example, implement optical sensors to determine a user's location. Radios including WiFi, BLUETOOTH, global positioning system (GPS), cellular or other communication devices may be also used to determine a user's location relative to a radio transceiver or group of transceivers (e.g., a WiFi router or group of GPS satellites). Acoustic sensors such as microphone arrays or 2D or 3D sonar sensors may also be used to determine a user's location within an environment. Augmented-reality and virtual-reality devices may incorporate any or all of these types of sensors to perform SLAM operations such as creating and continually updating maps of the user's current environment. In at least some of the embodiments described herein, SLAM data generated by these sensors may be referred to as “environmental data” and may indicate a user's current environment. This data may be stored in a local or remote data store (e.g., a cloud data store) and may be provided to a user's AR/VR device on demand.

When the user is wearing an augmented-reality headset or virtual-reality headset in a given environment, the user may be interacting with other users or other electronic devices that serve as audio sources. In some cases, it may be desirable to determine where the audio sources are located relative to the user and then present the audio sources to the user as if they were coming from the location of the audio source. The process of determining where the audio sources are located relative to the user may be referred to as “localization,” and the process of rendering playback of the audio source signal to appear as if it is coming from a specific direction may be referred to as “spatialization.”

Localizing an audio source may be performed in a variety of different ways. In some cases, an augmented-reality or virtual-reality headset may initiate a DOA analysis to determine the location of a sound source. The DOA analysis may include analyzing the intensity, spectra, and/or arrival time of each sound at the artificial-reality device to determine the direction from which the sounds originated. The DOA analysis may include any suitable algorithm for analyzing the surrounding acoustic environment in which the artificial reality device is located.

For example, the DOA analysis may be designed to receive input signals from a microphone and apply digital signal processing algorithms to the input signals to estimate the direction of arrival. These algorithms may include, for example, delay and sum algorithms where the input signal is sampled, and the resulting weighted and delayed versions of the sampled signal are averaged together to determine a direction of arrival. A least mean squared (LMS) algorithm may also be implemented to create an adaptive filter. This adaptive filter may then be used to identify differences in signal intensity, for example, or differences in time of arrival. These differences may then be used to estimate the direction of arrival. In another embodiment, the DOA may be determined by converting the input signals into the frequency domain and selecting specific bins within the time-frequency (TF) domain to process. Each selected TF bin may be processed to determine whether that bin includes a portion of the audio spectrum with a direct-path audio signal. Those bins having a portion of the direct-path signal may then be analyzed to identify the angle at which a microphone array received the direct-path audio signal. The determined angle may then be used to identify the direction of arrival for the received input signal. Other algorithms not listed above may also be used alone or in combination with the above algorithms to determine DOA.

In some embodiments, different users may perceive the source of a sound as coming from slightly different locations. This may be the result of each user having a unique head-related transfer function (HRTF), which may be dictated by a user's anatomy including ear canal length and the positioning of the ear drum. The artificial-reality device may provide an alignment and orientation guide, which the user may follow to customize the sound signal presented to the user based on their unique HRTF. In some embodiments, an artificial reality device may implement one or more microphones to listen to sounds within the user's environment. The augmented reality or virtual reality headset may use a variety of different array transfer functions (e.g., any of the DOA algorithms identified above) to estimate the direction of arrival for the sounds. Once the direction of arrival has been determined, the artificial-reality device may play back sounds to the user according to the user's unique HRTF. Accordingly, the DOA estimation generated using the array transfer function (ATF) may be used to determine the direction from which the sounds are to be played from. The playback sounds may be further refined based on how that specific user hears sounds according to the HRTF.

In addition to or as an alternative to performing a DOA estimation, an artificial-reality device may perform localization based on information received from other types of sensors. These sensors may include cameras, IR sensors, heat sensors, motion sensors, GPS receivers, or in some cases, sensors that detect a user's eye movements. For example, as noted above, an artificial-reality device may include an eye tracker or gaze detector that determines where the user is looking. Often, the user's eyes will look at the source of the sound, if only briefly. Such clues provided by the user's eyes may further aid in determining the location of a sound source. Other sensors such as cameras, heat sensors, and IR sensors may also indicate the location of a user, the location of an electronic device, or the location of another sound source. Any or all of the above methods may be used individually or in combination to determine the location of a sound source and may further be used to update the location of a sound source over time.

Some embodiments may implement the determined DOA to generate a more customized output audio signal for the user. For instance, an “acoustic transfer function” may characterize or define how a sound is received from a given location. More specifically, an acoustic transfer function may define the relationship between parameters of a sound at its source location and the parameters by which the sound signal is detected (e.g., detected by a microphone array or detected by a user's ear). An artificial-reality device may include one or more acoustic sensors that detect sounds within range of the device. A controller of the artificial-reality device may estimate a DOA for the detected sounds (using, e.g., any of the methods identified above) and, based on the parameters of the detected sounds, may generate an acoustic transfer function that is specific to the location of the device. This customized acoustic transfer function may thus be used to generate a spatialized output audio signal where the sound is perceived as coming from a specific location.

Indeed, once the location of the sound source or sources is known, the artificial-reality device may re-render (i.e., spatialize) the sound signals to sound as if coming from the direction of that sound source. The artificial-reality device may apply filters or other digital signal processing that alter the intensity, spectra, or arrival time of the sound signal. The digital signal processing may be applied in such a way that the sound signal is perceived as originating from the determined location. The artificial-reality device may amplify or subdue certain frequencies or change the time that the signal arrives at each ear. In some cases, the artificial-reality device may create an acoustic transfer function that is specific to the location of the device and the detected direction of arrival of the sound signal. In some embodiments, the artificial-reality device may re-render the source signal in a stereo device or multi-speaker device (e.g., a surround sound device). In such cases, separate and distinct audio signals may be sent to each speaker. Each of these audio signals may be altered according to the user's HRTF and according to measurements of the user's location and the location of the sound source to sound as if they are coming from the determined location of the sound source. Accordingly, in this manner, the artificial-reality device (or speakers associated with the device) may re-render an audio signal to sound as if originating from a specific location.

In some embodiments, the systems described herein may also include an eye-tracking subsystem designed to identify and track various characteristics of a user's eye(s), such as the user's gaze direction. The phrase “eye tracking” may, in some examples, refer to a process by which the position, orientation, and/or motion of an eye is measured, detected, sensed, determined, and/or monitored. The disclosed systems may measure the position, orientation, and/or motion of an eye in a variety of different ways, including through the use of various optical-based eye-tracking techniques, ultrasound-based eye-tracking techniques, etc. An eye-tracking subsystem may be configured in a number of different ways and may include a variety of different eye-tracking hardware components or other computer-vision components. For example, an eye-tracking subsystem may include a variety of different optical sensors, such as two-dimensional (2D) or 3D cameras, time-of-flight depth sensors, single-beam or sweeping laser rangefinders, 3D LiDAR sensors, and/or any other suitable type or form of optical sensor. In this example, a processing subsystem may process data from one or more of these sensors to measure, detect, determine, and/or otherwise monitor the position, orientation, and/or motion of the user's eye(s).

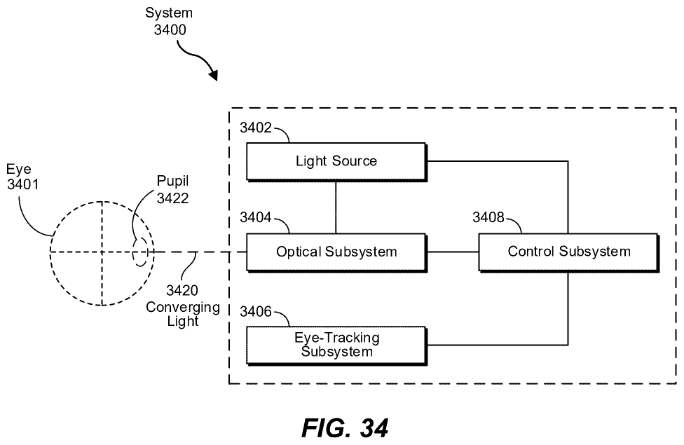

FIG. 34 is an illustration of an example system 3400 that incorporates an eye-tracking subsystem capable of tracking a user's eye(s). As depicted in FIG. 34, system 3400 may include a light source 3402, an optical subsystem 3404, an eye-tracking subsystem 3406, and/or a control subsystem 3408. In some examples, light source 3402 may generate light for an image (e.g., to be presented to an eye 3401 of the viewer). Light source 3402 may represent any of a variety of suitable devices. For example, light source 3402 can include a two-dimensional projector (e.g., a LCOS display), a scanning source (e.g., a scanning laser), or other device (e.g., an LCD, an LED display, an OLED display, an active-matrix OLED display (AMOLED), a transparent OLED display (TOLED), a waveguide, or some other display capable of generating light for presenting an image to the viewer). In some examples, the image may represent a virtual image, which may refer to an optical image formed from the apparent divergence of light rays from a point in space, as opposed to an image formed from the light ray's actual divergence.

In some embodiments, optical subsystem 3404 may receive the light generated by light source 3402 and generate, based on the received light, converging light 3420 that includes the image. In some examples, optical subsystem 3404 may include any number of lenses (e.g., Fresnel lenses, convex lenses, concave lenses), apertures, filters, mirrors, prisms, and/or other optical components, possibly in combination with actuators and/or other devices. In particular, the actuators and/or other devices may translate and/or rotate one or more of the optical components to alter one or more aspects of converging light 3420. Further, various mechanical couplings may serve to maintain the relative spacing and/or the orientation of the optical components in any suitable combination.

In one embodiment, eye-tracking subsystem 3406 may generate tracking information indicating a gaze angle of an eye 3401 of the viewer. In this embodiment, control subsystem 3408 may control aspects of optical subsystem 3404 (e.g., the angle of incidence of converging light 3420) based at least in part on this tracking information. Additionally, in some examples, control subsystem 3408 may store and utilize historical tracking information (e.g., a history of the tracking information over a given duration, such as the previous second or fraction thereof) to anticipate the gaze angle of eye 3401 (e.g., an angle between the visual axis and the anatomical axis of eye 3401). In some embodiments, eye-tracking subsystem 3406 may detect radiation emanating from some portion of eye 3401 (e.g., the cornea, the iris, the pupil, or the like) to determine the current gaze angle of eye 3401. In other examples, eye-tracking subsystem 3406 may employ a wavefront sensor to track the current location of the pupil.

Any number of techniques can be used to track eye 3401. Some techniques may involve illuminating eye 3401 with infrared light and measuring reflections with at least one optical sensor that is tuned to be sensitive to the infrared light. Information about how the infrared light is reflected from eye 3401 may be analyzed to determine the position(s), orientation(s), and/or motion(s) of one or more eye feature(s), such as the cornea, pupil, iris, and/or retinal blood vessels.

In some examples, the radiation captured by a sensor of eye-tracking subsystem 3406 may be digitized (i.e., converted to an electronic signal). Further, the sensor may transmit a digital representation of this electronic signal to one or more processors (for example, processors associated with a device including eye-tracking subsystem 3406). Eye-tracking subsystem 3406 may include any of a variety of sensors in a variety of different configurations. For example, eye-tracking subsystem 3406 may include an infrared detector that reacts to infrared radiation. The infrared detector may be a thermal detector, a photonic detector, and/or any other suitable type of detector. Thermal detectors may include detectors that react to thermal effects of the incident infrared radiation.

In some examples, one or more processors may process the digital representation generated by the sensor(s) of eye-tracking subsystem 3406 to track the movement of eye 3401. In another example, these processors may track the movements of eye 3401 by executing algorithms represented by computer-executable instructions stored on non-transitory memory. In some examples, on-chip logic (e.g., an application-specific integrated circuit or ASIC) may be used to perform at least portions of such algorithms. As noted, eye-tracking subsystem 3406 may be programmed to use an output of the sensor(s) to track movement of eye 3401. In some embodiments, eye-tracking subsystem 3406 may analyze the digital representation generated by the sensors to extract eye rotation information from changes in reflections. In one embodiment, eye-tracking subsystem 3406 may use corneal reflections or glints (also known as Purkinje images) and/or the center of the eye's pupil 3422 as features to track over time.

In some embodiments, eye-tracking subsystem 3406 may use the center of the eye's pupil 3422 and infrared or near-infrared, non-collimated light to create corneal reflections. In these embodiments, eye-tracking subsystem 3406 may use the vector between the center of the eye's pupil 3422 and the corneal reflections to compute the gaze direction of eye 3401. In some embodiments, the disclosed systems may perform a calibration procedure for an individual (using, e.g., supervised or unsupervised techniques) before tracking the user's eyes. For example, the calibration procedure may include directing users to look at one or more points displayed on a display while the eye-tracking system records the values that correspond to each gaze position associated with each point.

In some embodiments, eye-tracking subsystem 3406 may use two types of infrared and/or near-infrared (also known as active light) eye-tracking techniques: bright-pupil and dark-pupil eye tracking, which may be differentiated based on the location of an illumination source with respect to the optical elements used. If the illumination is coaxial with the optical path, then eye 3401 may act as a retroreflector as the light reflects off the retina, thereby creating a bright pupil effect similar to a red-eye effect in photography. If the illumination source is offset from the optical path, then the eye's pupil 3422 may appear dark because the retroreflection from the retina is directed away from the sensor. In some embodiments, bright-pupil tracking may create greater iris/pupil contrast, allowing more robust eye tracking with iris pigmentation, and may feature reduced interference (e.g., interference caused by eyelashes and other obscuring features). Bright-pupil tracking may also allow tracking in lighting conditions ranging from total darkness to a very bright environment.

In some embodiments, control subsystem 3408 may control light source 3402 and/or optical subsystem 3404 to reduce optical aberrations (e.g., chromatic aberrations and/or monochromatic aberrations) of the image that may be caused by or influenced by eye 3401. In some examples, as mentioned above, control subsystem 3408 may use the tracking information from eye-tracking subsystem 3406 to perform such control. For example, in controlling light source 3402, control subsystem 3408 may alter the light generated by light source 3402 (e.g., by way of image rendering) to modify (e.g., pre-distort) the image so that the aberration of the image caused by eye 3401 is reduced.

The disclosed systems may track both the position and relative size of the pupil (since, e.g., the pupil dilates and/or contracts). In some examples, the eye-tracking devices and components (e.g., sensors and/or sources) used for detecting and/or tracking the pupil may be different (or calibrated differently) for different types of eyes. For example, the frequency range of the sensors may be different (or separately calibrated) for eyes of different colors and/or different pupil types, sizes, and/or the like. As such, the various eye-tracking components (e.g., infrared sources and/or sensors) described herein may need to be calibrated for each individual user and/or eye.

The disclosed systems may track both eyes with and without ophthalmic correction, such as that provided by contact lenses worn by the user. In some embodiments, ophthalmic correction elements (e.g., adjustable lenses) may be directly incorporated into the artificial reality systems described herein. In some examples, the color of the user's eye may necessitate modification of a corresponding eye-tracking algorithm. For example, eye-tracking algorithms may need to be modified based at least in part on the differing color contrast between a brown eye and, for example, a blue eye.

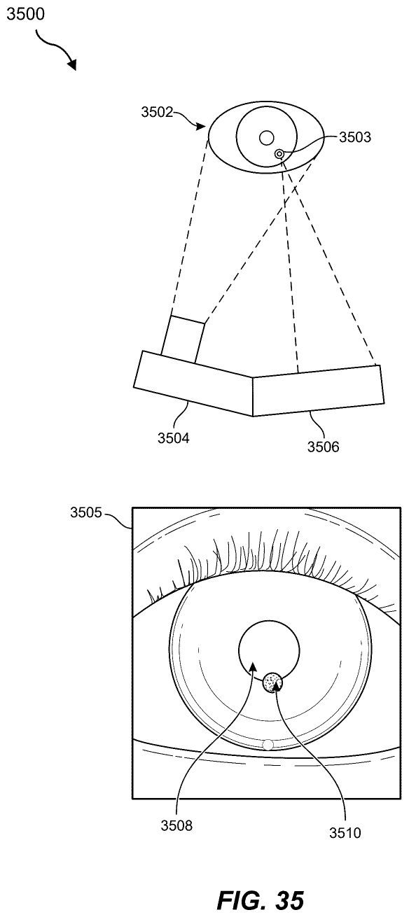

FIG. 35 is a more detailed illustration of various aspects of the eye-tracking subsystem illustrated in FIG. 34. As shown in this figure, an eye-tracking subsystem 3500 may include at least one source 3504 and at least one sensor 3506. Source 3504 generally represents any type or form of element capable of emitting radiation. In one example, source 3504 may generate visible, infrared, and/or near-infrared radiation. In some examples, source 3504 may radiate non-collimated infrared and/or near-infrared portions of the electromagnetic spectrum towards an eye 3502 of a user. Source 3504 may utilize a variety of sampling rates and speeds. For example, the disclosed systems may use sources with higher sampling rates in order to capture fixational eye movements of a user's eye 3502 and/or to correctly measure saccade dynamics of the user's eye 3502. As noted above, any type or form of eye-tracking technique may be used to track the user's eye 3502, including optical-based eye-tracking techniques, ultrasound-based eye-tracking techniques, etc.

Sensor 3506 generally represents any type or form of element capable of detecting radiation, such as radiation reflected off the user's eye 3502. Examples of sensor 3506 include, without limitation, a charge coupled device (CCD), a photodiode array, a complementary metal-oxide-semiconductor (CMOS) based sensor device, and/or the like. In one example, sensor 3506 may represent a sensor having predetermined parameters, including, but not limited to, a dynamic resolution range, linearity, and/or other characteristic selected and/or designed specifically for eye tracking.

As detailed above, eye-tracking subsystem 3500 may generate one or more glints. As detailed above, a glint 3503 may represent reflections of radiation (e.g., infrared radiation from an infrared source, such as source 3504) from the structure of the user's eye. In various embodiments, glint 3503 and/or the user's pupil may be tracked using an eye-tracking algorithm executed by a processor (either within or external to an artificial reality device). For example, an artificial reality device may include a processor and/or a memory device in order to perform eye tracking locally and/or a transceiver to send and receive the data necessary to perform eye tracking on an external device (e.g., a mobile phone, cloud server, or other computing device).

FIG. 35 shows an example image 3505 captured by an eye-tracking subsystem, such as eye-tracking subsystem 3500. In this example, image 3505 may include both the user's pupil 3508 and a glint 3510 near the same. In some examples, pupil 3508 and/or glint 3510 may be identified using an artificial-intelligence-based algorithm, such as a computer-vision-based algorithm. In one embodiment, image 3505 may represent a single frame in a series of frames that may be analyzed continuously in order to track the eye 3502 of the user. Further, pupil 3508 and/or glint 3510 may be tracked over a period of time to determine a user's gaze.

In one example, eye-tracking subsystem 3500 may be configured to identify and measure the inter-pupillary distance (IPD) of a user. In some embodiments, eye-tracking subsystem 3500 may measure and/or calculate the IPD of the user while the user is wearing the artificial reality system. In these embodiments, eye-tracking subsystem 3500 may detect the positions of a user's eyes and may use this information to calculate the user's IPD.

As noted, the eye-tracking systems or subsystems disclosed herein may track a user's eye position and/or eye movement in a variety of ways. In one example, one or more light sources and/or optical sensors may capture an image of the user's eyes. The eye-tracking subsystem may then use the captured information to determine the user's inter-pupillary distance, interocular distance, and/or a 3D position of each eye (e.g., for distortion adjustment purposes), including a magnitude of torsion and rotation (i.e., roll, pitch, and yaw) and/or gaze directions for each eye. In one example, infrared light may be emitted by the eye-tracking subsystem and reflected from each eye. The reflected light may be received or detected by an optical sensor and analyzed to extract eye rotation data from changes in the infrared light reflected by each eye.

The eye-tracking subsystem may use any of a variety of different methods to track the eyes of a user. For example, a light source (e.g., infrared light-emitting diodes) may emit a dot pattern onto each eye of the user. The eye-tracking subsystem may then detect (e.g., via an optical sensor coupled to the artificial reality system) and analyze a reflection of the dot pattern from each eye of the user to identify a location of each pupil of the user. Accordingly, the eye-tracking subsystem may track up to six degrees of freedom of each eye (i.e., 3D position, roll, pitch, and yaw) and at least a subset of the tracked quantities may be combined from two eyes of a user to estimate a gaze point (i.e., a 3D location or position in a virtual scene where the user is looking) and/or an IPD.

In some cases, the distance between a user's pupil and a display may change as the user's eye moves to look in different directions. The varying distance between a pupil and a display as viewing direction changes may be referred to as “pupil swim” and may contribute to distortion perceived by the user as a result of light focusing in different locations as the distance between the pupil and the display changes. Accordingly, measuring distortion at different eye positions and pupil distances relative to displays and generating distortion corrections for different positions and distances may allow mitigation of distortion caused by pupil swim by tracking the 3D position of a user's eyes and applying a distortion correction corresponding to the 3D position of each of the user's eyes at a given point in time. Thus, knowing the 3D position of each of a user's eyes may allow for the mitigation of distortion caused by changes in the distance between the pupil of the eye and the display by applying a distortion correction for each 3D eye position. Furthermore, as noted above, knowing the position of each of the user's eyes may also enable the eye-tracking subsystem to make automated adjustments for a user's IPD.

In some embodiments, a display subsystem may include a variety of additional subsystems that may work in conjunction with the eye-tracking subsystems described herein. For example, a display subsystem may include a varifocal subsystem, a scene-rendering module, and/or a vergence-processing module. The varifocal subsystem may cause left and right display elements to vary the focal distance of the display device. In one embodiment, the varifocal subsystem may physically change the distance between a display and the optics through which it is viewed by moving the display, the optics, or both. Additionally, moving or translating two lenses relative to each other may also be used to change the focal distance of the display. Thus, the varifocal subsystem may include actuators or motors that move displays and/or optics to change the distance between them. This varifocal subsystem may be separate from or integrated into the display subsystem. The varifocal subsystem may also be integrated into or separate from its actuation subsystem and/or the eye-tracking subsystems described herein.

In one example, the display subsystem may include a vergence-processing module configured to determine a vergence depth of a user's gaze based on a gaze point and/or an estimated intersection of the gaze lines determined by the eye-tracking subsystem. Vergence may refer to the simultaneous movement or rotation of both eyes in opposite directions to maintain single binocular vision, which may be naturally and automatically performed by the human eye. Thus, a location where a user's eyes are verged is where the user is looking and is also typically the location where the user's eyes are focused. For example, the vergence-processing module may triangulate gaze lines to estimate a distance or depth from the user associated with intersection of the gaze lines. The depth associated with intersection of the gaze lines may then be used as an approximation for the accommodation distance, which may identify a distance from the user where the user's eyes are directed. Thus, the vergence distance may allow for the determination of a location where the user's eyes should be focused and a depth from the user's eyes at which the eyes are focused, thereby providing information (such as an object or plane of focus) for rendering adjustments to the virtual scene.

The vergence-processing module may coordinate with the eye-tracking subsystems described herein to make adjustments to the display subsystem to account for a user's vergence depth. When the user is focused on something at a distance, the user's pupils may be slightly farther apart than when the user is focused on something close. The eye-tracking subsystem may obtain information about the user's vergence or focus depth and may adjust the display subsystem to be closer together when the user's eyes focus or verge on something close and to be farther apart when the user's eyes focus or verge on something at a distance.

The eye-tracking information generated by the above-described eye-tracking subsystems may also be used, for example, to modify various aspect of how different computer-generated images are presented. For example, a display subsystem may be configured to modify, based on information generated by an eye-tracking subsystem, at least one aspect of how the computer-generated images are presented. For instance, the computer-generated images may be modified based on the user's eye movement, such that if a user is looking up, the computer-generated images may be moved upward on the screen. Similarly, if the user is looking to the side or down, the computer-generated images may be moved to the side or downward on the screen. If the user's eyes are closed, the computer-generated images may be paused or removed from the display and resumed once the user's eyes are back open.

The above-described eye-tracking subsystems can be incorporated into one or more of the various artificial reality systems described herein in a variety of ways. For example, one or more of the various components of system 3400 and/or eye-tracking subsystem 3500 may be incorporated into any of the augmented-reality systems in and/or virtual-reality systems described herein in to enable these systems to perform various eye-tracking tasks (including one or more of the eye-tracking operations described herein).

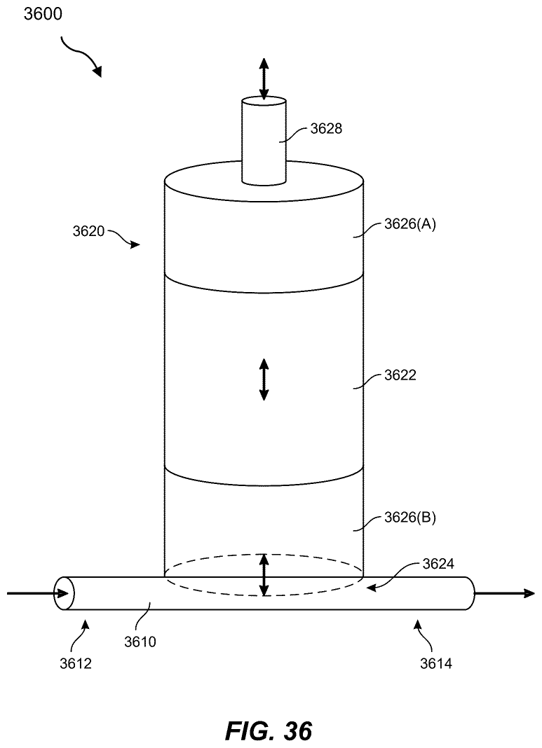

As noted above, the present disclosure may also include haptic fluidic systems that involve the control (e.g., stopping, starting, restricting, increasing, etc.) of fluid flow through a fluid channel. The control of fluid flow may be accomplished with a fluidic valve. FIG. 36 shows a schematic diagram of a fluidic valve 3600 for controlling flow through a fluid channel 3610, according to at least one embodiment of the present disclosure. Fluid from a fluid source (e.g., a pressurized fluid source, a fluid pump, etc.) may flow through the fluid channel 3610 from an inlet port 3612 to an outlet port 3614, which may be operably coupled to, for example, a fluid-driven mechanism, another fluid channel, or a fluid reservoir.

Fluidic valve 3600 may include a gate 3620 for controlling the fluid flow through fluid channel 3610. Gate 3620 may include a gate transmission element 3622, which may be a movable component that is configured to transmit an input force, pressure, or displacement to a restricting region 3624 to restrict or stop flow through the fluid channel 3610. Conversely, in some examples, application of a force, pressure, or displacement to gate transmission element 3622 may result in opening restricting region 3624 to allow or increase flow through the fluid channel 3610. The force, pressure, or displacement applied to gate transmission element 3622 may be referred to as a gate force, gate pressure, or gate displacement. Gate transmission element 3622 may be a flexible element (e.g., an elastomeric membrane, a diaphragm, etc.), a rigid element (e.g., a movable piston, a lever, etc.), or a combination thereof (e.g., a movable piston or a lever coupled to an elastomeric membrane or diaphragm).

As illustrated in FIG. 36, gate 3620 of fluidic valve 3600 may include one or more gate terminals, such as an input gate terminal 3626(A) and an output gate terminal 3626(B) (collectively referred to herein as “gate terminals 3626”) on opposing sides of gate transmission element 3622. Gate terminals 3626 may be elements for applying a force (e.g., pressure) to gate transmission element 3622. By way of example, gate terminals 3626 may each be or include a fluid chamber adjacent to gate transmission element 3622. Alternatively or additionally, one or more of gate terminals 3626 may include a solid component, such as a lever, screw, or piston, that is configured to apply a force to gate transmission element 3622.

In some examples, a gate port 3628 may be in fluid communication with input gate terminal 3626(A) for applying a positive or negative fluid pressure within the input gate terminal 3626(A). A control fluid source (e.g., a pressurized fluid source, a fluid pump, etc.) may be in fluid communication with gate port 3628 to selectively pressurize and/or depressurize input gate terminal 3626(A). In additional embodiments, a force or pressure may be applied at the input gate terminal 3626(A) in other ways, such as with a piezoelectric element or an electromechanical actuator, etc.

In the embodiment illustrated in FIG. 36, pressurization of the input gate terminal 3626(A) may cause the gate transmission element 3622 to be displaced toward restricting region 3624, resulting in a corresponding pressurization of output gate terminal 3626(B). Pressurization of output gate terminal 3626(B) may, in turn, cause restricting region 3624 to partially or fully restrict to reduce or stop fluid flow through the fluid channel 3610. Depressurization of input gate terminal 3626(A) may cause gate transmission element 3622 to be displaced away from restricting region 3624, resulting in a corresponding depressurization of the output gate terminal 3626(B). Depressurization of output gate terminal 3626(B) may, in turn, cause restricting region 3624 to partially or fully expand to allow or increase fluid flow through fluid channel 3610. Thus, gate 3620 of fluidic valve 3600 may be used to control fluid flow from inlet port 3612 to outlet port 3614 of fluid channel 3610.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method for simulating light propagation in waveguides, comprising:
simulating rays deterministically;
monitoring an intensity of the rays as they undergo ray splitting;
dynamically switching from deterministic simulation to stochastic simulation when the ray intensity declines to a specified threshold;
continuing the stochastic simulation to model interference effects up to the specified threshold; and
outputting a simulation result that provides an enhanced representation of light propagation within the waveguide that is based on both the deterministic simulation and the stochastic simulation.

2. The method of claim 1, wherein the deterministic simulation employs adaptive algorithms that adjust based on initial ray energy levels.

3. The method of claim 2, further comprising a use of real-time data analytics to monitor ray intensity and predict switching points between deterministic and stochastic simulations.

4. The method of claim 3, wherein a transition from deterministic simulation to stochastic simulation includes a gradual phase to smooth out the switch, based on a hybrid threshold comprising both ray intensity and angle of incidence.

5. The method of claim 4, wherein the stochastic simulation comprises a variance reduction technique.

6. An eyewear device comprising:
a display assembly that:
is configured to generate graphical imagery for viewing by a user; and
includes a waveguide fabricated into a wafer;
an eye-tracking device at least partially fabricated into the waveguide of the display assembly; and
circuitry communicatively coupled to the eye-tracking device and configured to track an eye of the user based at least in part on light detected by the eye-tracking device.

7. The eyewear device of claim 6, further comprising at least one optical element configured to selectively direct light within the waveguide, the optical element being adjustable between at least a first state and a second state.

8. The eyewear device of claim 6, wherein the display assembly further comprises a quantum dot film, wherein the quantum dot film comprises a plurality of embedded particles configured to scatter light in a range of wavelengths.

9. The eyewear device of claim 8, wherein the embedded particles are comprised of one or more of silicon or TiO2.

10. The eyewear device of claim 8, wherein the embedded particles range in size from 0.3 to 2.0 micrometers.

11. The eyewear device of claim 8, wherein the embedded particles range in size from 0.3 to 0.8 micrometers.

12. The eyewear device of claim 6, wherein the display assembly further comprises a light source, an input coupling structure, an output coupling structure, and a reflectance layer.

13. The eyewear device of claim 12, wherein the input coupling structure comprises a 2D binary surface relief grating.

14. The eyewear device of claim 12, wherein the output coupling structure comprises a 2D binary surface relief grating.

15. The eyewear device of claim 12, wherein the reflectance layer is disposed over a second surface of the waveguide opposite to a first surface of the waveguide.

16. The eyewear device of claim 15, wherein the reflectance layer comprises a notch reflector.

17. The eyewear device of claim 15, wherein the reflectance layer comprises a plurality of narrow-band absorptive particles.

18. A method for manufacturing a high-PPI LCD display, comprising:
opening a contact hole in a planarization layer;
providing a contact electrode within the contact hole;
filling the contact hole with a contact hole filler material; and
providing a photo spacer above the contact hole, upon a flat surface formed by the contact hole filler material.

19. The method of claim 18, wherein the photo spacer is comprised of a negative photoresist material.

20. The method of claim 18, wherein the planarization material is comprised of a positive photoresist material.
